(19) United States
(12) Patent Application Publication
(10) Pub. No.: US 2006/0113885 A1
(43) Pub. Date: Jun. 1, 2006

(54) Discharge fluorescen apparatus including fluorescent fibers

(76) Inventor: Keiji Iimura, Tokyo (JP)

Correspondence Address: KEIJI IIMURA, 10-8, AKATSUKA 3-CHOME, ITABASHI-KU, TOKYO, 175-0092, JP

(21) Appl. No.: 11/045,859

(22) Filed: Jan. 31, 2005

(30) Foreign Application Priority Data
Nov. 29, 2004 (JP) 2004-343240

(51) Int. Cl. H01J 1/62

(52) U.S. Cl. 313/485

(57) ABSTRACT

A discharge fluorescent apparatus is composed of an air-tight envelope having a discharge-space containing a dischargeable gas therein and plural fluorescent fibers having a phosphor, preferably fluorescent optical fibers, positioned in/on the envelope. Further, at least one protrusion or barrier wall preferably having the phosphor may be positioned in/on the envelope. The fluorescent fibers are positioned on the envelope and/or on the protrusion or barrier wall. The fluorescent fibers emit visible light when excited by ultraviolet rays generated from the gas. The fluorescent optical fibers each may be composed of a light-conductive core or the core and a clad, in which the core and/or the clad contain the phosphor or plural phosphor particles therein. The fluorescent fibers may be positioned on the envelope and/or on the protrusion or barrier wall by an electrostatic process. The discharge fluorescent apparatus may apply to a tubular fluorescent lamp, a flat fluorescent lamp and a plasma display panel. Therefore, the discharge fluorescent apparatus exhibits a remarkably enhanced luminance, because it has a massive surface area in/on the fluorescent fibers, the protrusion and/or the barrier wall that may contain the phosphor.

### CROSS-REFERENCE TO RELATED APPLICATIONS

This application claims the benefit of the prior foreign application: Japanese Patent Application No. 2004-343240, filed on Nov. 29, 2004 in the Japan Patent Office and the entire disclosure of which is incorporated herein by reference in this application.

### BACKGROUND OF THE INVENTION

1. Field of the Invention

The present invention relates to a discharge fluorescent apparatus such as a fluorescent lamp and a plasma display.

The present invention further relates to a method for manufacturing the discharge fluorescent apparatus.

2. Description of Related Art

As known, fluorescent lamps are widely used in such as lighting or a backlight or front light of liquid crystal displays (LCDs).

The fluorescent lamp is generally composed of an air tight transparent envelope e.g. a tubular glass, a discharge space for containing dischargeable gas sealed therein, a pair of electrodes and a fluorescent (phosphor) film coated on an inner surface of the envelope. The dischargeable gas generates vacuum ultraviolet rays (V-UV) when an AC voltage is applied to the electrodes and the fluorescent film emits visible light when the fluorescent film is exited by radiation of the V-UV.

It is desirable to get the fluorescent lamps having brighter luminance than conventional fluorescent lamps. One of known technologies for getting the brighter fluorescent lamps is to improve fluorescent materials for use in the fluorescent film having brighter luminance than conventional fluorescent materials.

Another known technology for getting the brighter fluorescent lamps is to use a power supply with a high frequency more than a commercial power supply with the frequency of 50 Hz/60 HZ as AC voltage applied to the electrodes of the fluorescent lamps. Therefore, in many cases, the fluorescent lamps are lit by the AC voltage with the high frequency up to about 50 KHz generated by inverters. However, a use of the high frequency more than about 50 KHz is not desirable, since electromagnetic waves induced by such high frequency gives an undesirable influence to electronic devices e.g. computers, and a volume and a strength of the electromagnetic waves increase according to the magnitude of the frequency.

Other known technology for getting the brighter fluorescent lamps is to increase a size of area of the fluorescent film coated on the inner surface of the fluorescent lamps.

In the tubular fluorescent lamps with a predetermined diameter, one known method for increasing the size of area of the fluorescent film is to increase the length of a glass tube so as to lengthen a passageway of the dischargeable gas, so that the wider fluorescent film can be coated on the increased inner surface of the glass tube.

Another known method for increasing the size of area of the fluorescent film in the fluorescent lamps to bend one straight glass tube one or more times to form a continuous bent tube with shapes such as alphabetical characters “U”, “O”, “W”, “L” and “C”, helical/spiral form and zigzag form, so that the length of a glass tube can be substantially lengthen.

These fluorescent lamps with straight, bent or other deformed glass tube are typically used as lighting or illumination in indoors or outdoors and backlight of liquid crystal displays.

Some technologies other than that of the aforementioned conventional fluorescent lamps are disclosed in the following patent documents that disclose the fluorescent lamps with the higher brightness than the conventional fluorescent lamps capable of emitting visible light from a predetermined limited light emitting surface area.

Japanese patent publication of application (i.e. Japanese Laid-Open patent publication), publication No. 11-219685, entitled “Double tube type fluorescent lamp” is disclosed that the double tube type fluorescent lamp enhances the total flux to a great extent by allowing an inner tube and an outer tube to make light emission individually. The double tube type fluorescent lamp is structured so that a fluorescent or phosphor film is formed on the inside surface so as to make light emission with current feeding, a pair of internal electrodes are installed and sealed, and an outer tube is provided on the outside of an inner tube with a gap reserved in between, wherein a phosphor film is formed on the inside surface so that the outer tube also makes light emission with current feeding, and a pair of electrodes are installed and sealed on the insides of the two ends of the outer tube.

Japanese patent publication of application, publication No. 2001-052651, entitled “Double tube type fluorescent lamp” is disclosed that a dual tube type fluorescent lamp is compact size, excellent in the strength against an external force such as vibration, and capable of generating high-brightness light emission effectively. The dual tube type fluorescent lamp is composed of an inner tube of glass coated with a phosphor film on the inner wall, encapsulating mercury and a rare gas and furnished at the two ends with discharge electrodes connected with leads inserted air-tightly, an outer tube of transparent glass in which the inner tube is set air-tightly while a gap is reserved relative to the outer surface of the inner tube, and a pair of discharge electrodes connected with leads inserted in the gap between the inner and outer tubes. The rare gas encapsulated in the gap emits light with electric discharge.

U.S. Pat. No. 5,804,914, entitled “Fluorescent lamp having additional and interior fluorescent surfaces to increase luminosity” is disclosed that a fluorescent lamp with multiple fluorescent surfaces including a hollow outer tube of any desirable shape, and at least one transparent inner tube or plate-like structure of any shape disposed inside the outer tube. The filaments are mounted at each end of the outer tube. The outer tube is filled with mercury vapor when it is in a vacuum state. The inner and outer wall surfaces of the inner tube or plate-like structure and the inner wall surface of the outer tube are all coated with fluorescent materials. When the filaments are supplied with electric currents to release electrons which collide with the mercury molecules to generate ultra-violet rays, much more fluorescent materials will be reached by the ultra-violet rays to generate visible light, thus increasing the luminosity of the fluorescent lamp.

The patent documents mentioned above disclose the fluorescent lamps having more brightness or luminance than the conventional fluorescent lamps, however, the fluorescent lamps disclosed in the patent documents are yet insufficient in the brightness or luminance. Therefore, a fluorescent discharge apparatus for emitting a brighter luminance than the related arts is recently required in the markets related to lighting, illumination, a backlight or front light for a liquid crystal display (LCD) and a plasma display panel (PDP).

### BRIEF SUMMARY OF THE INVENTION

It is an object of the present invention is to improve the conventional discharge fluorescent apparatus such as a fluorescent lamp and a plasma display panel having a low brightness or luminance from a light emitting surface having the predetermined limited area size.

It is another object of the present invention is to propose a novel discharge fluorescent apparatus such as the fluorescent lamp and a plasma display panel having an enhanced brightness or luminance capable of exiting from a light emitting surface thereof having the predetermined limited area size.

In a first aspect of the present invention, a discharge fluorescent apparatus comprises: an air-tight envelope having a discharge space to fill a dischargeable gas therein; a plurality of fluorescent fibers each containing a phosphor therein/thereon; and wherein the fluorescent fibers are disposed in/on the envelope.

In a second aspect of the present invention, the discharge fluorescent apparatus comprises a fluorescent lamp further comprising: an air-tight envelope having a discharge space to fill a dischargeable gas therein; at least one protrusion and/or at least one barrier wall disposed in/on the envelope, and wherein the protrusion and/or the barrier wall contain a phosphor disposed therein/thereon.

In the first and/or the second aspects of the present invention, the fluorescent fibers may be disposed on the envelope, the protrusion and/or the barrier wall. Each of the fluorescent fibers may comprise a single core structure or a core-clad structure; and wherein each of the fluorescent fibers having the single core structure is composed of a core and the phosphor contained in the core and each of the fluorescent fibers having the core-clad structure is composed of a core, a clad partially or entirely disposed on the core and the phosphor contained in the core and/or the clad.

Each of the fluorescent fibers may comprise a fluorescent optical fiber having a light-conductive core or the light-conductive core and a light-conductive clad partially or entirely to cover the light-conductive core and the phosphor having a plurality of phosphor particles dispersed in the light-conductive core and/or the light-conductive clad. The fluorescent optical fiber may further comprise a light-conductive core having a first refractive index, a light-conductive clad having a second refractive index partially or entirely to cover the core and the phosphor having a plurality of phosphor particles dispersed in the core and/or the clad; and wherein the first refractive index differ from the second refractive index. For the fluorescent optical fiber, a stepped index fluorescent optical fiber or a leaky fluorescent optical fiber may be used, in which the stepped index fluorescent optical fiber is composed of the core with the first refractive index and the clad with the second refractive index lower than the first refractive index, while the leaky fluorescent optical fiber is composed of the core with the first refractive index and the clad with the second refractive index higher than the first refractive index.

The discharge fluorescent apparatus may be a tubular fluorescent lamp or a substantially flat fluorescent lamp; and wherein the tubular fluorescent lamp is composed of the envelope having at least one tubular member with the discharge space therein and the substantially flat fluorescent lamp is composed of the envelope having at least dual substrates with the discharge space therebetween.

The tubular fluorescent lamp may be selected from a single tubular fluorescent lamp having one glass tube, wherein the fluorescent fibers are disposed on the glass tube and a dual tubular fluorescent lamp having an outer glass tube and an inner glass tube disposed within the outer glass tube, wherein the fluorescent fibers are disposed on the first envelope and on the second envelope.

The flat fluorescent lamp may be selected from the flat fluorescent lamp including the envelope having a first glass substrate, a second grass substrate with the discharge space therebetween and a substantially flame-like or ring-like sealant to seal the discharge space, and the flat fluorescent lamp including the envelope having the first glass substrate, the second grass substrate with the discharge space therebetween and an elongated continuous barrier wall for producing the discharge space having an elongated continuous discharge space to form a meandering or zigzag gas-passageway (gas-channel).

The discharge fluorescent apparatus may further comprise: at least one glass film or at least one fluorescent glass film to contain a phosphor therein, disposed on the envelope; and wherein the glass film or the fluorescent glass film is interposed between the fluorescent fibers and the envelope.

At least one electro-conductive film may be disposed on the envelope; and wherein the fluorescent fibers are disposed on the electro-conductive film. Plural dot-like electro-conductive films or plural dot-like non-electro-conductive films may be disposed on the envelope; and wherein at least one of the fluorescent fibers is disposed on each of the dot-like electro-conductive films or the dot-like non-electro-conductive films. As the electro-conductive films or the dot-like electro-conductive films, a light-reflective metallic film or a light-conductive metal oxide film may be used.

The envelope may comprise dual envelopes having a first envelope and a second envelope enclosed within the first envelope, the first envelope with at least one gas-permeable through-hole to connect the first discharge space and the second discharge space or without the gas-permeable through-hole; wherein a plurality of the fluorescent fibers is disposed on the first envelope and/or the second envelope.

The discharge fluorescent apparatus may be selected from an internal electrode discharge fluorescent apparatus, an external electrode discharge fluorescent apparatus and an electrode-less discharge fluorescent apparatus.

The internal or external electrode discharge fluorescent apparatus has at least dual electrodes disposed in an interior or exterior of the envelope for generating or inducing an electric discharge or a plasma from the dischargeable gas in the discharge space by applying a voltage to the electrodes, in stead of the electrode discharge fluorescent apparatus the discharge fluorescent apparatus may be an electrode-less discharge fluorescent apparatus that has no electrode and the discharge or the plasma is induced by applying a voltage having a radio frequency (RF) of microwave frequency (MF) to the dischargeable gas in the envelope from an exterior of the envelope.

The fluorescent fibers each may elongate from the envelope to the discharge space. The fluorescent fibers emit visible light when the phosphor disposed therein/thereon is excited by ultraviolet rays generated from the dischargeable gas.

In the second aspect of the present invention, the protrusion and/or the barrier wall may comprise a light-conductive member and the phosphor composed of a plurality of phosphor particles dispersed in the light-conductive member.

In the second aspect of the present invention, the protrusion and/or the barrier wall excluding or containing the phosphor; and wherein the fluorescent fibers may be disposed on the protrusion and/or the barrier wall. In the second aspect of the present invention, the protrusion and/or the barrier wall may have a fluorescent film disposed thereon; and wherein the fluorescent film comprises a phosphor containing film composed of a light-conductive film to contain a plurality of phosphor particles dispersed therein or a phosphor film.

In the first aspect of the present invention, the discharge fluorescent may comprise a plasma display panel further comprising; the envelope composed of a first substrate and a second substrate opposed to the first substrate, having the discharge space therebetween, the discharge space having a plurality of discharge cells; a plurality of barrier walls disposed between the first substrate and the second substrate; a plurality of electrodes disposed on the first substrate and the second substrate; and wherein the fluorescent fibers are disposed on the envelope and/or on the barrier walls. The first electrodes may be composed of first stripe-shaped electrodes parallel to one another and the second electrodes may be composed of second stripe-shaped electrodes parallel to one another, wherein the first stripe-shaped electrodes and the second stripe-shaped electrodes may be arranged orthogonally to one another.

The protrusions and/or the barrier wall may be formed by sintering or fusing a glass paste composed of a plurality of glass powders and a liquid mixed together or a fluorescent glass paste composed of the glass powders, a plurality of phosphor particles and the liquid mixed together. The glass paste or the fluorescent glass paste is selectively disposed on the envelope to form a predetermined pattern corresponding to the pattern of the protrusions and/or the barrier wall, next the glass paste or the fluorescent glass paste is sintered by applying a sufficient heat to melt or fuse the glass powders and after cooling the protrusions and/or the barrier wall are formed on the envelope.

In a third aspect of the present invention, a method for manufacturing a discharge fluorescent apparatus, comprises the steps of: a first step of preparing a plurality of the fluorescent fibers containing the phosphor therein/thereon and a component member of the envelope composed of a glass tube or a pair of glass substrates; a second step of giving an electrostatic charge to the fluorescent fibers and/or the component member; a third step of temporarily attaching the fluorescent fibers electrostatically on/in the component member by an electrostatic attraction; and a fourth step of fixing the fluorescent fibers at least on/in the component member. The fluorescent fibers may be adhered on the envelope such as the glass tube or the glass substrate by the electrostatic process disclosed above such as an electrostatic flocking process so that the fluorescent fibers can be electrostatically adhered or flocked on a surface of the envelope and also on a surface of the at least one protrusion and/or barrier walls.

In the third aspect of the present invention, the method for manufacturing the tubular fluorescent lamp may be composed of: the steps of inserting the pipe into a glass tube and move the pipe to an axial direction of the glass tube; throwing the fluorescent fibers charged at the electrostatic spray nozzle to an inner surface of the glass tube; and attaching the fluorescent fibers on the inner surface, in which an electrostatic means is used for charging an electrostatic charge to the fluorescent fibers supplied within the glass tube of a tubular fluorescent lamp may be composed of a pipe having a first end having an electrostatic spray nozzle and a second end for supplying the fluorescent fibers therefrom.

In the third aspect of the present invention, the method for manufacturing the flat fluorescent lamp may be composed of: the steps of: disposing an electrically conductive member having a plurality of through holes and the front or rear substrate opposed to each other; applying a high DC voltage between the electronically conductive member and the front or rear substrate; charging the fluorescent fibers by passing the through holes of the electronically conductive member; and thereby attaching the fluorescent fibers on the front or rear substrate by an electrostatic attraction force.

In the third aspect of the present invention, the method for manufacturing the plasma display panel may be composed of: the steps of: disposing an electrically conductive member having a plurality of through holes and the rear substrate with stripe shaped electrodes opposed to each other; applying a high DC voltage between the electronically conductive member and the rear substrate; charging the fluorescent fibers by passing the through holes of the electronically conductive member; and thereby attaching the fluorescent fibers on the rear substrate by an electrostatic attraction force.

The term “fiber” throughout this specification is defined as a fiber-like member, a filament-like member, a needle-like member and whisker-like member. The term “fluorescent fiber” throughout this specification is defined as the fluorescent fiber composed of the “fiber” mentioned above to include a fluorescent or phosphor material disposed therein/thereon, the fluorescent fiber composed of the “fiber” mentioned above and the fluorescent or phosphor material dispersed therein or the fluorescent fiber composed of the “fiber” mentioned above and the fluorescent or phosphor material covered thereon.

The discharge fluorescent apparatus of the present invention may be an analogy of a small intestine in a human body. The small intestine has a plurality of tiny protrusions (projections) or finger-like protrusions on an inner wall thereof that is called villi. Further each of the protrusions or the villi has a plurality of fiber-like or brush-like members on a surface thereof that is called micro-villi. The villi and the micro-villi give a massive or huge surface area for absorbing nutrients in the foods passed through the small intestine.

The discharge fluorescent apparatus of the present invention has fluorescent fibers or protrusions (projections) on a wall of an envelope in order to give a massive or huge surface area for emitting visible light therefrom, in which the discharge fluorescent apparatus is similar to the small intestine in the point to get the massive or huge surface area by applying the fibers, protrusions (projections). Therefore, the discharge fluorescent apparatus of the present invention may be a kind of bionics or a creative imitation of the small intestine in the human body.

### BRIEF DESCRIPTION OF THE SEVERAL VIEWS OF THE DRAWING

### Brief Description of the Drawings

For a more complete understanding of the present invention and the advantage thereof, reference is now made to the following descriptions taken in conjunction with the accompanying drawings, in which:

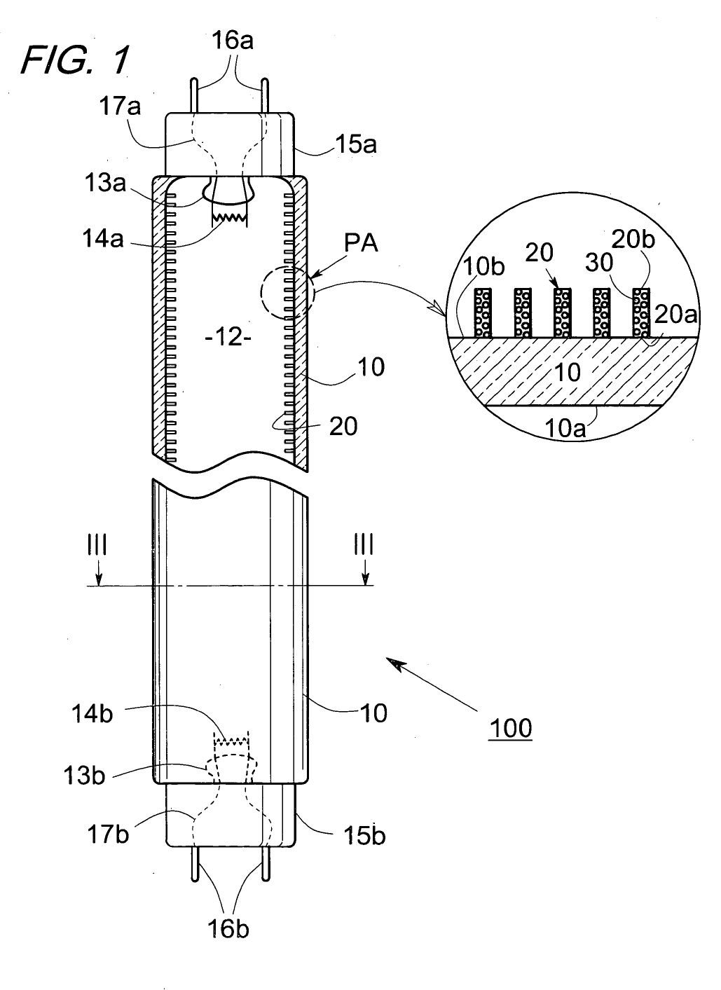

FIG. 1 is a schematic partial cross sectional view showing a tubular fluorescent lamp 100 that is an example of a discharge fluorescent apparatus according to a first embodiment of the present invention;

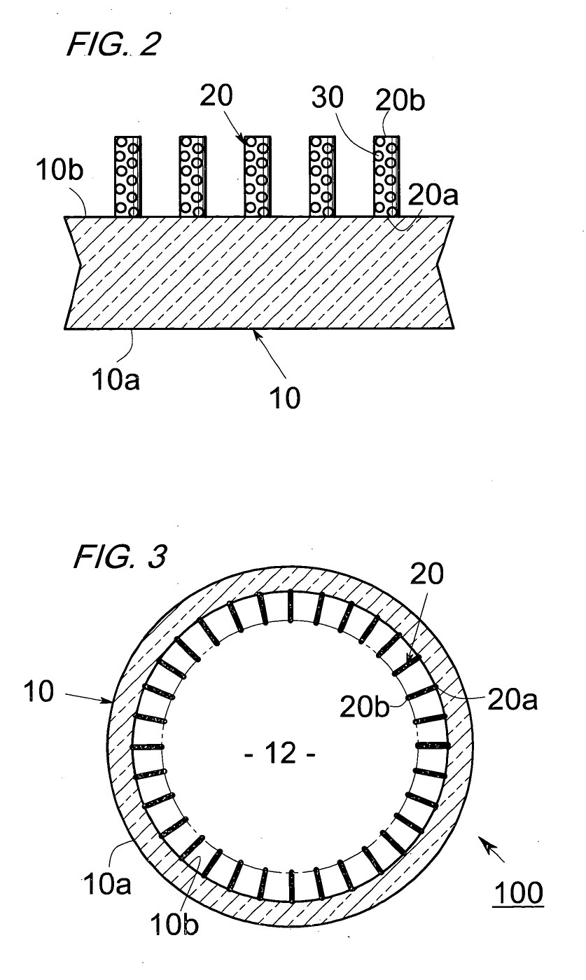

FIG. 2 is a schematic enlarged cross sectional view showing a portion surrounded with a circle “PA” of FIG. 1;

FIG. 3 is a schematic enlarged cross sectional view along the line III-III (the line 3-3) of FIG. 1;

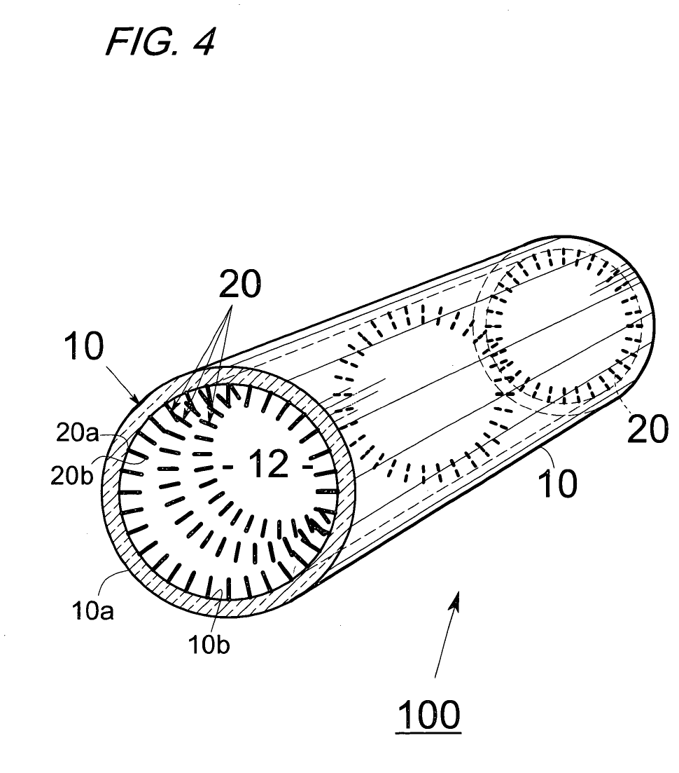

FIG. 4 is a schematic perspective view showing a major portion of the tubular fluorescent lamp 100 according to the first embodiment;

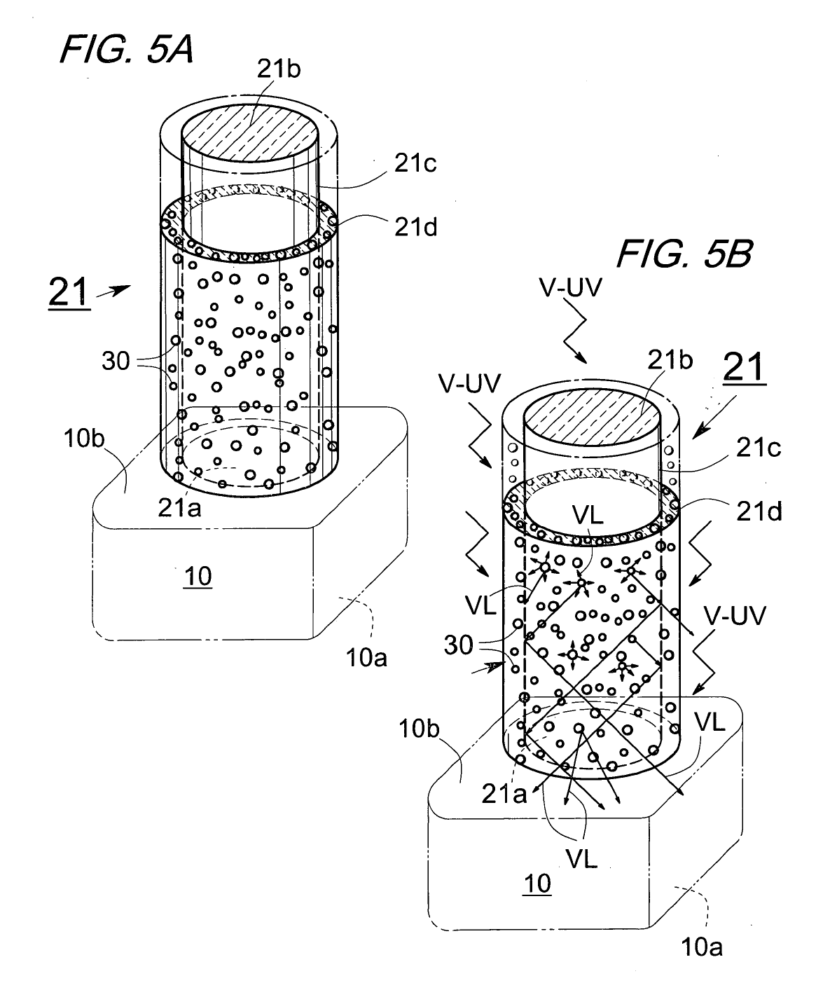

FIG. 5A is a partially omitted enlarged schematic perspective view showing a tubular fluorescent optical fiber 21 with a core-clad structure;

FIG. 5B is a partially omitted enlarged schematic perspective view showing the principle of the fluorescent optical fiber 21 of FIG. 5A;

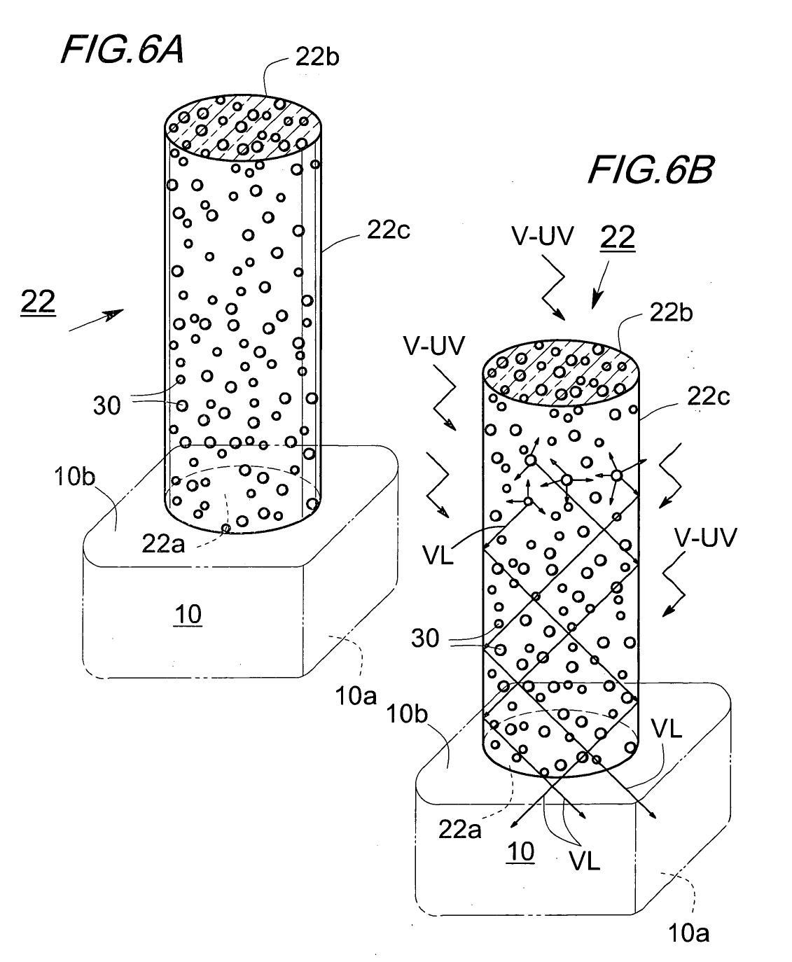

FIG. 6A is a partially omitted enlarged schematic perspective view showing a fluorescent optical fiber 22 with a single core structure according to the first embodiment;

FIG. 6B is a partially omitted enlarged schematic perspective view showing the principle of the fluorescent optical fiber 22 of FIG. 6A;

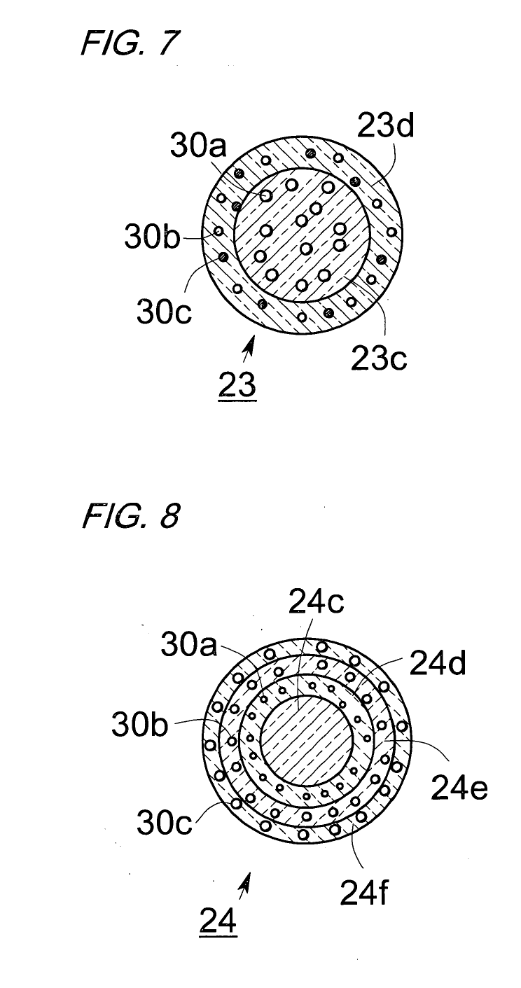

FIG. 7 is a schematic enlarged cross sectional view showing another fluorescent optical fiber 23;

FIG. 8 is a schematic enlarged cross sectional view showing still another fluorescent optical fiber 24;

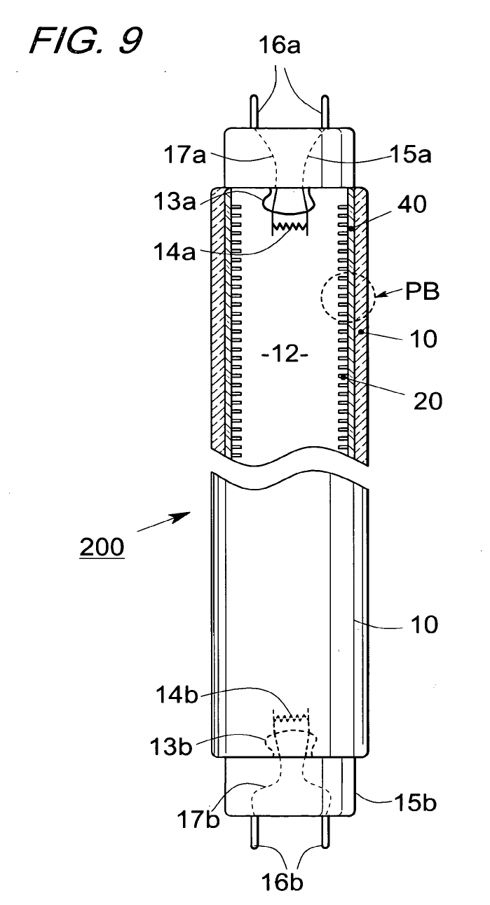

FIG. 9 is a schematic cross sectional view showing a tubular fluorescent lamp 200 according to a second embodiment of the present invention;

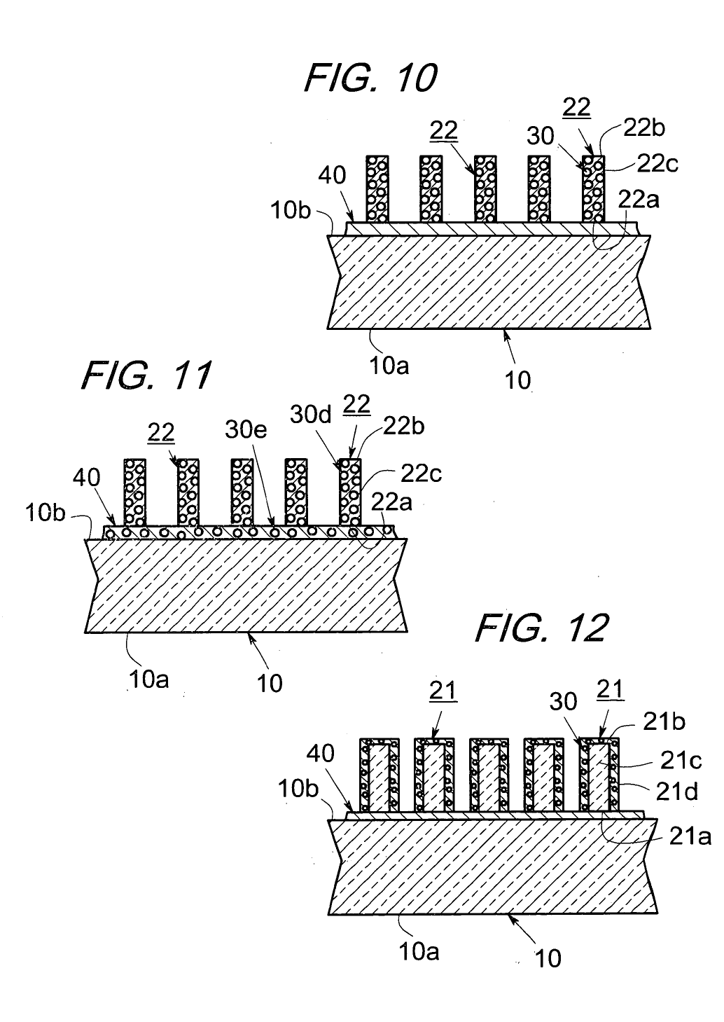

FIG. 10 is a partial enlarged cross sectional view of a portion surrounded with a circle “PB” of FIG. 9;

FIG. 11 is a partial enlarged cross sectional view of a portion surrounded with a circle “PB” of FIG. 9;

FIG. 12 is a partial enlarged cross sectional view of a portion surrounded with a circle “PB” of FIG. 9;

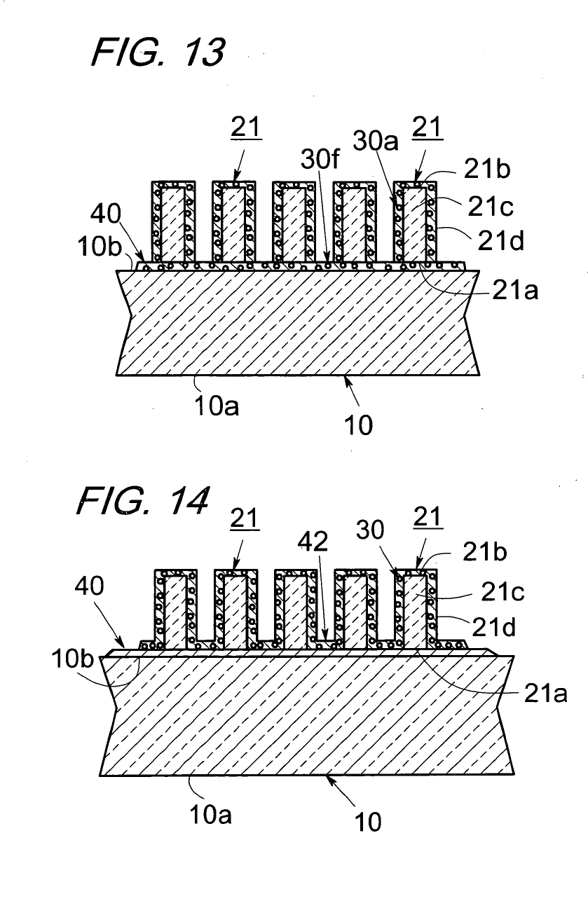

FIG. 13 is a partial enlarged cross sectional view of a portion surrounded with a circle “PB” of FIG. 9;

FIG. 14 is a partial enlarged cross sectional view of a portion surrounded with a circle “PB” of FIG. 9;

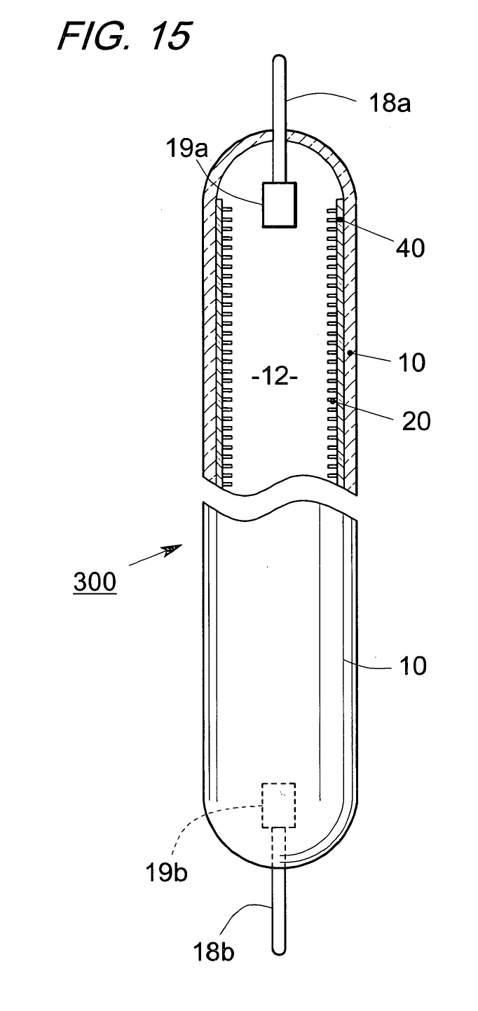

FIG. 15 is a schematic cross sectional view showing a cold cathode fluorescent lamp 300 according to a seventh embodiment;

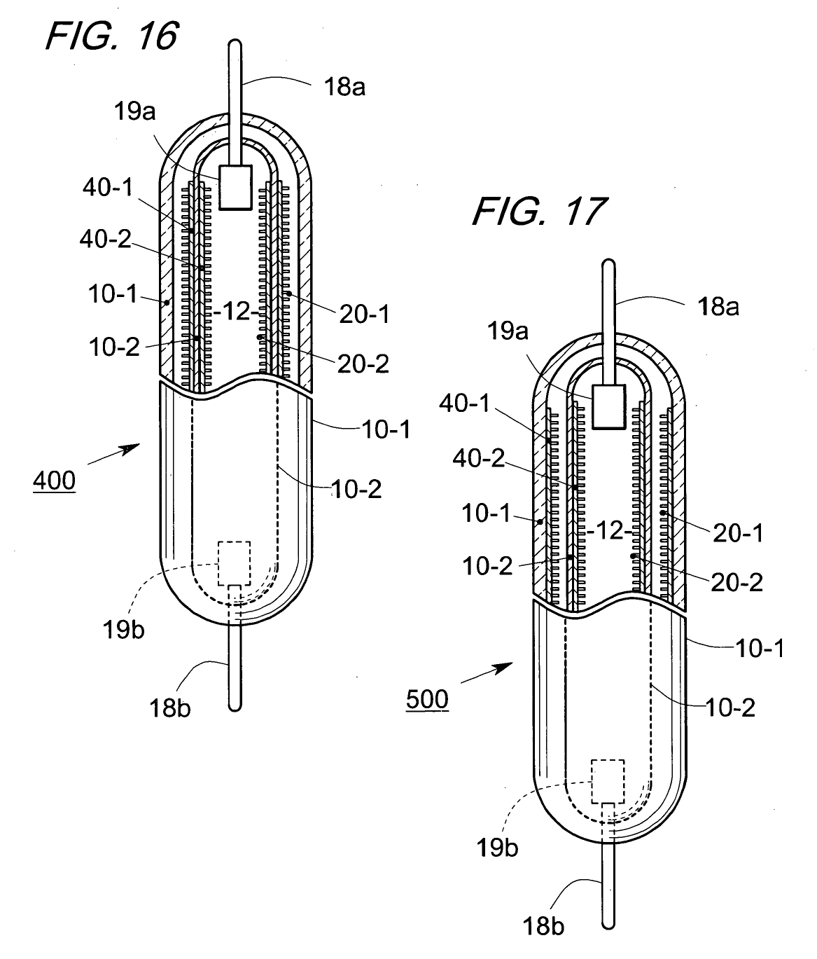

FIG. 16 is a schematic cross sectional view showing a dual tube fluorescent lamp 400 with cold cathodes according to an eight embodiment;

FIG. 17 is a schematic cross sectional view showing a dual tube fluorescent lamp 500 according to a ninth embodiment;

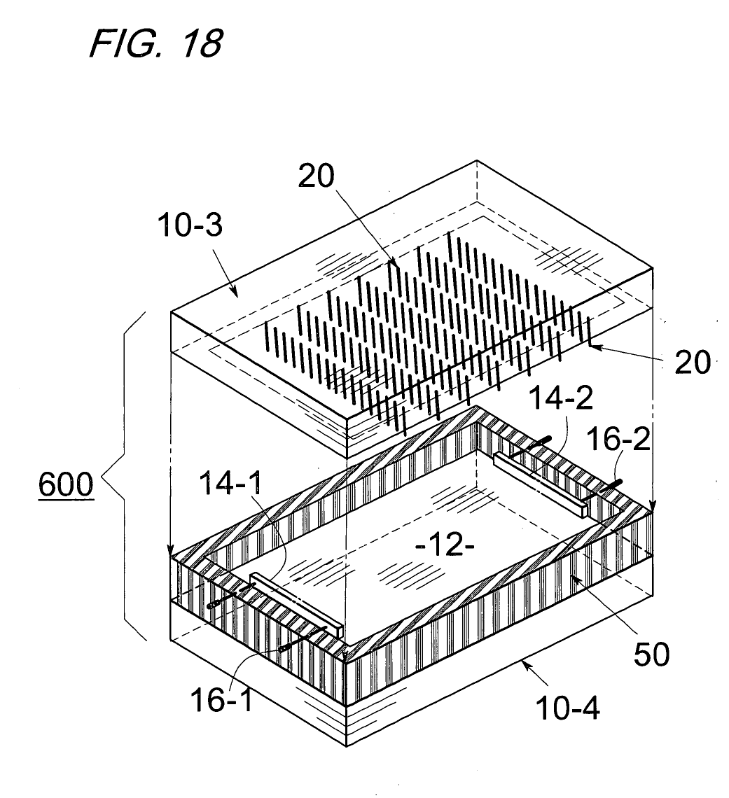

FIG. 18 is a schematic exploded perspective view showing a flat fluorescent lamp 600 according to a tenth embodiment;

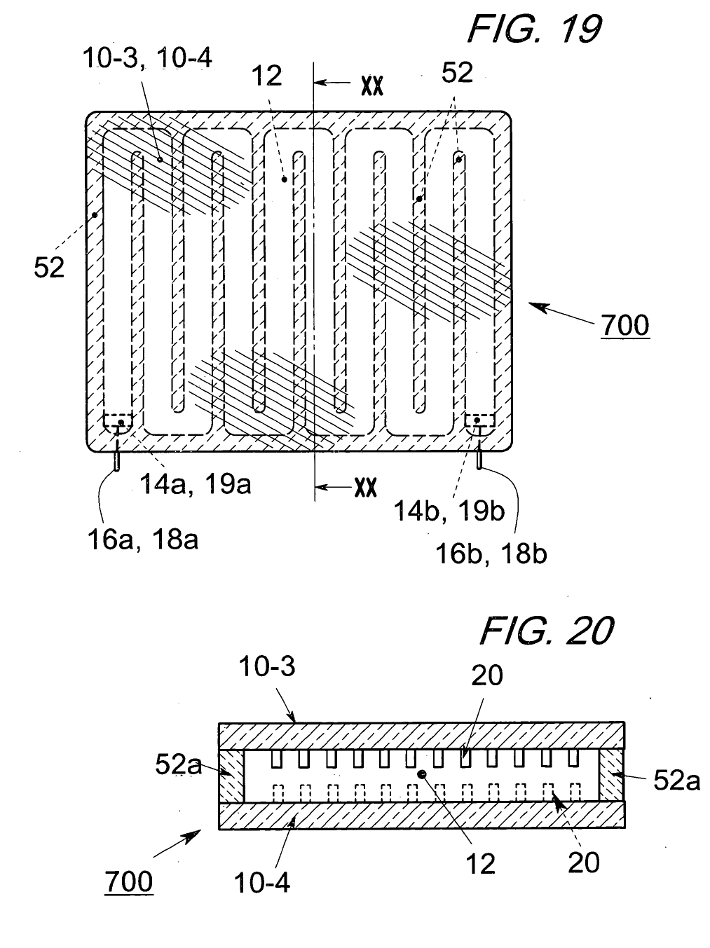

FIG. 19 is a schematic top view showing a flat fluorescent lamp 700 according to an eleventh embodiment;

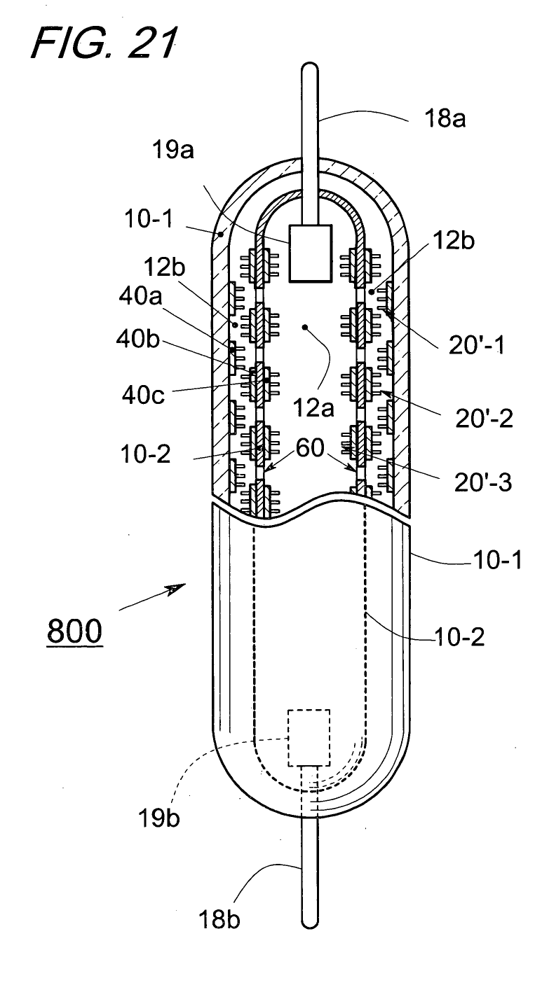

FIG. 20 is a schematic cross sectional view taken along the line XX-XX (the line 20-20) of FIG. 19;

FIG. 21 is a schematic cross sectional view showing a cold cathode dual tubes fluorescent lamp 800 according to a twelfth embodiment;

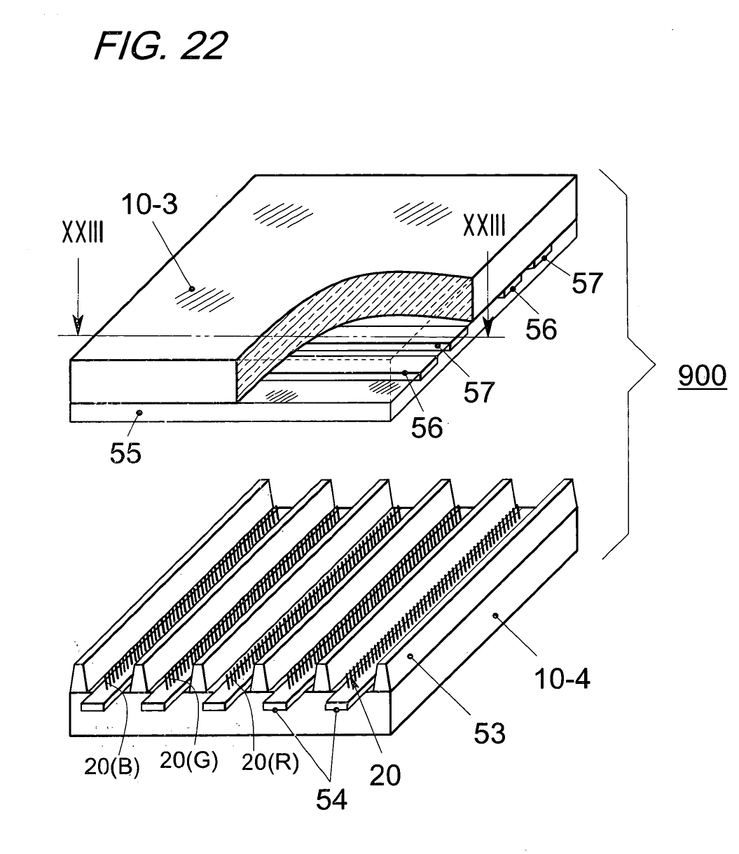

FIG. 22 is a schematic exploded perspective view showing the surface discharge AC activated plasma display panel 900 according to a thirteenth embodiment;

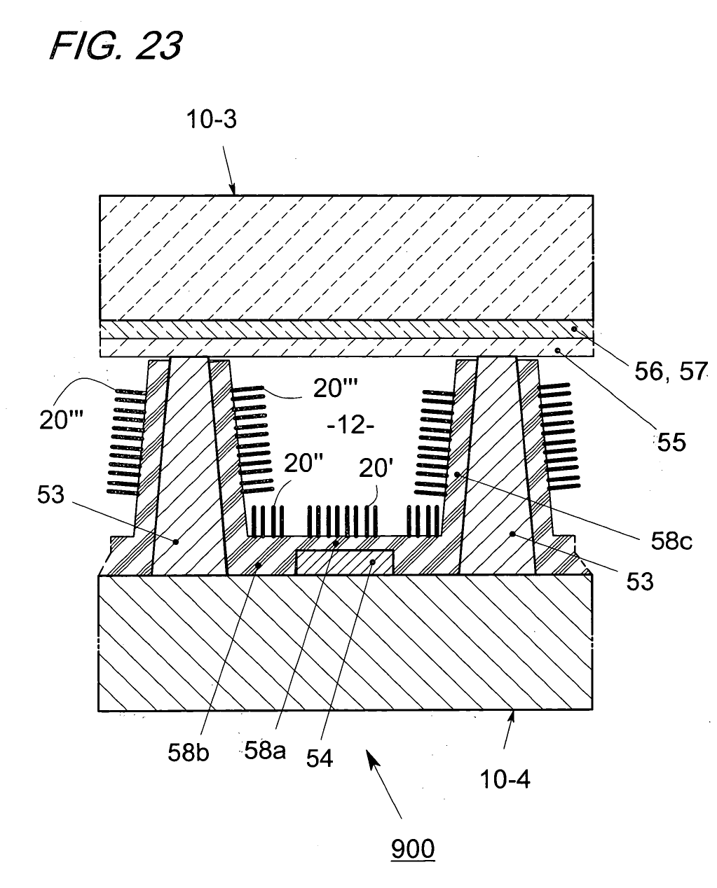

FIG. 23 is a schematic partial enlarged cross sectional view along the line XXIII-XXIII (the line 23-23) of FIG. 22;

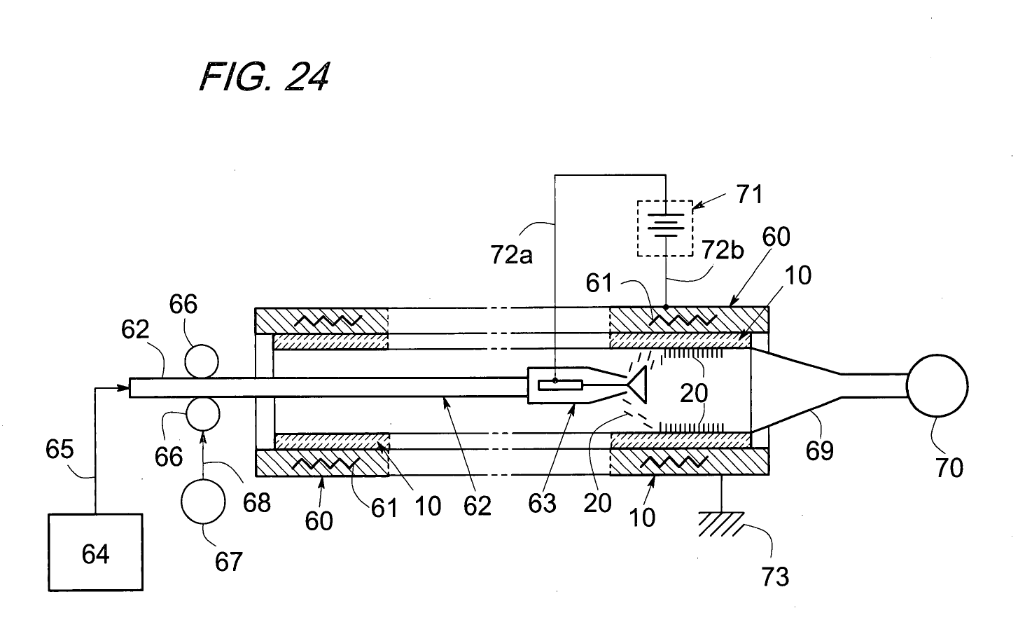

FIG. 24 is a schematic elevational view showing a method and apparatus according to a fourteenth embodiment for manufacturing the tubular fluorescent lamps;

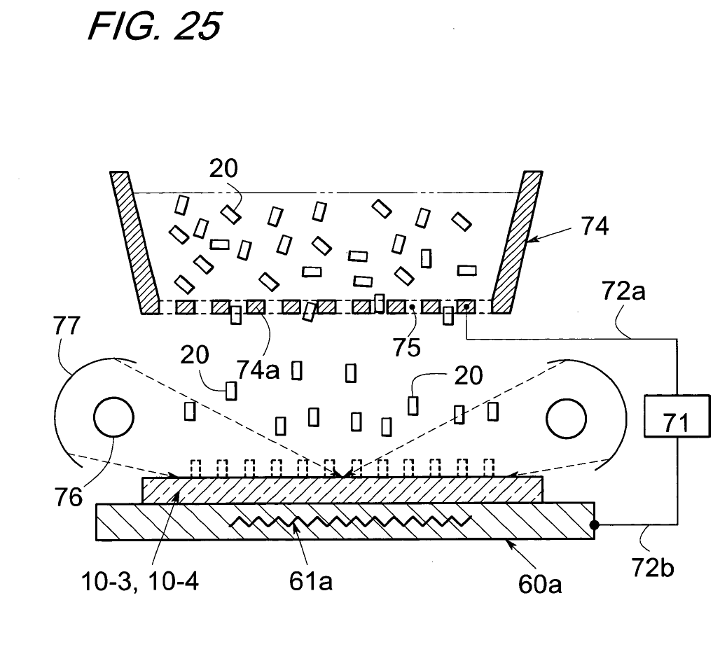

FIG. 25 is a schematic cross sectional view showing a method and apparatus according to a fifteenth embodiment for manufacturing the flat fluorescent lamps, in which a “DOWN” system electrostatic process is applied;

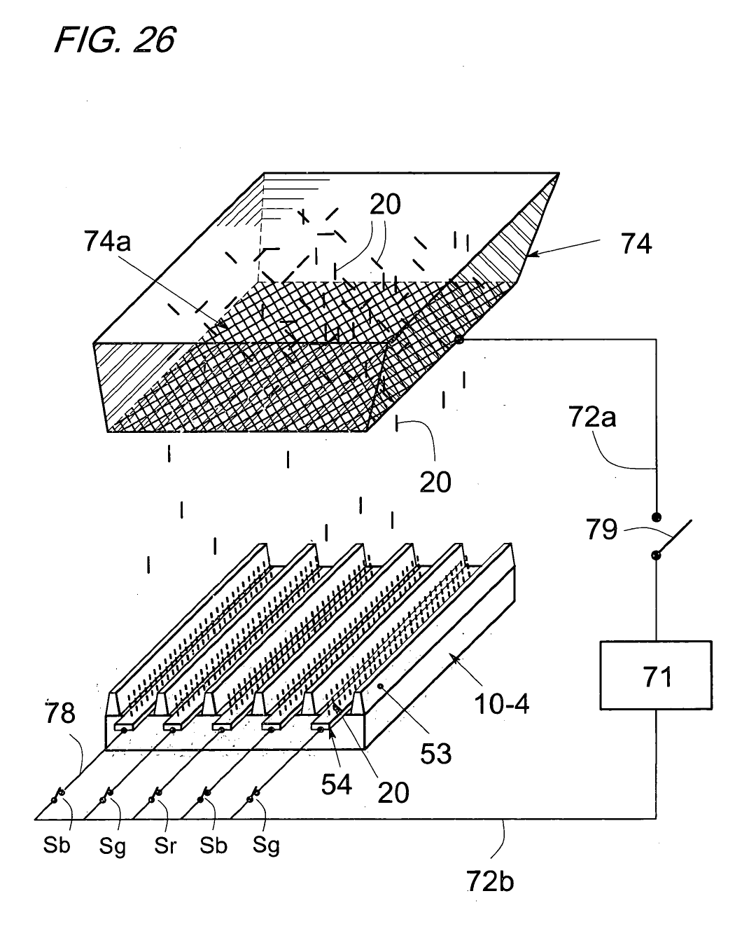

FIG. 26 is a schematic perspective view showing a method and apparatus according to a sixteenth embodiment for manufacturing the plasma display panel, in which a “DOWN” system electrostatic process is applied;

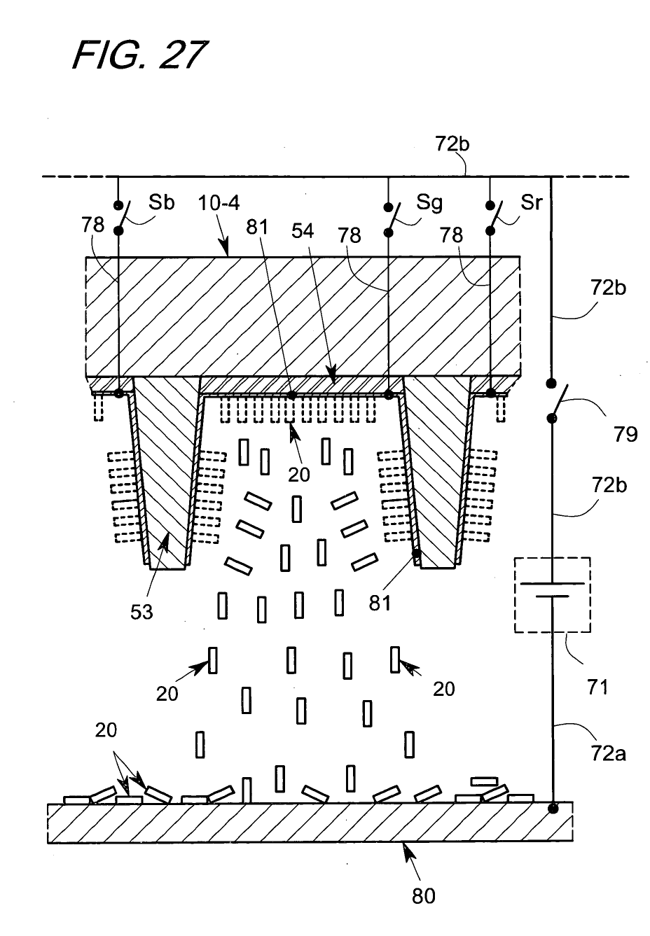

FIG. 27 is a schematic partial enlarged cross sectional view showing a method and apparatus according to a seventeenth embodiment for manufacturing a plasma display panel, in which a “UP” system electrostatic process is applied;

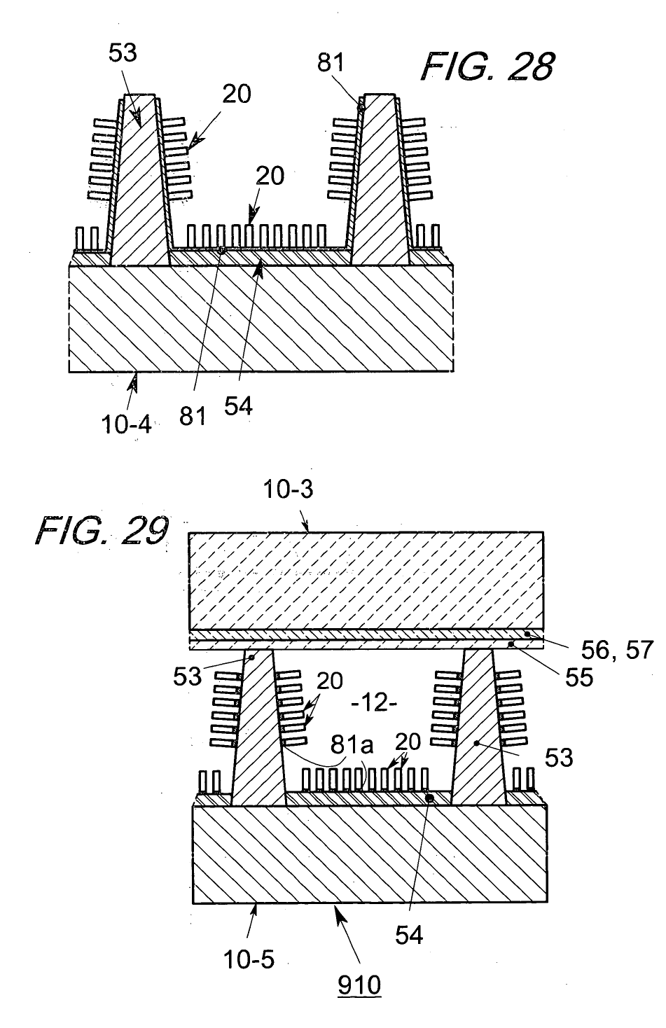

FIG. 28 is a schematic partial enlarged cross sectional view showing the method and the apparatus according to the seventeenth embodiment, in which the fluorescent fibers 20 are flocked to fix on the rear substrate 10-4;

FIG. 29 is a schematic partial enlarged cross sectional view showing a main portion of a plasma display panel 910 manufactured according to the seventeenth embodiment;

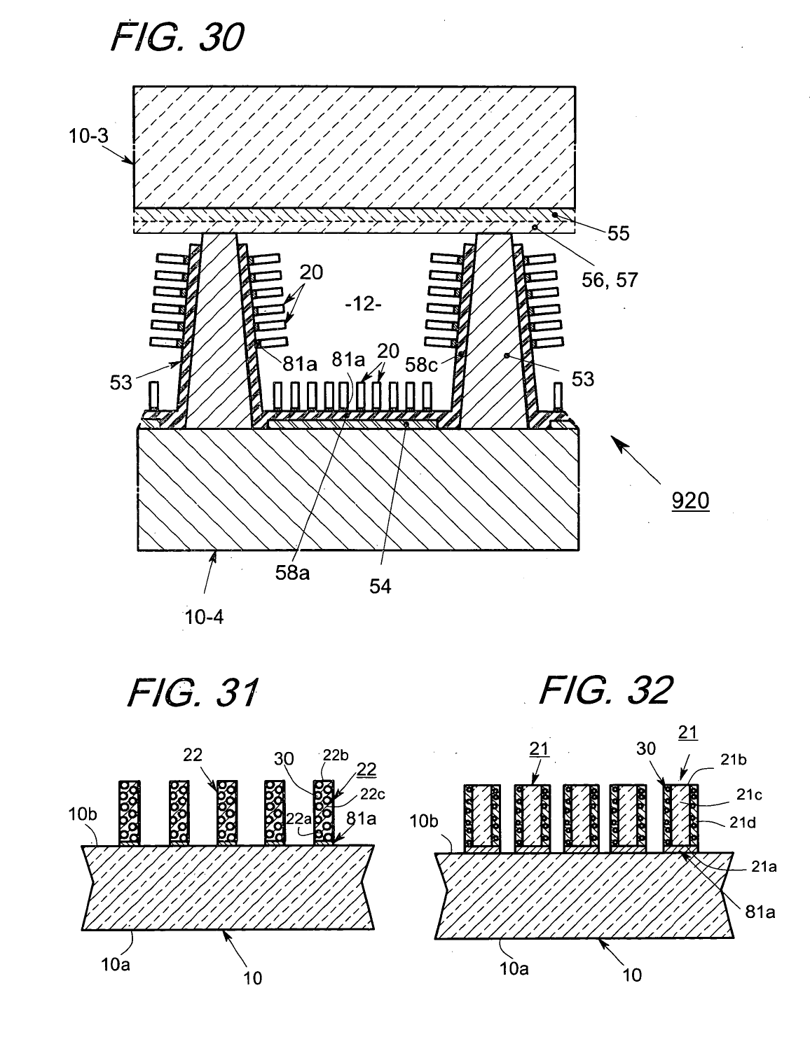

FIG. 30 is a schematic enlarged partial cross sectional view showing a major portion of a plasma display panel 920 according to an eighteenth embodiment;

FIG. 31 is a schematic enlarged cross sectional view showing a single core tubular fluorescent lamp (a portion surrounded with a circle “PA” of FIG. 1) according to a nineteenth embodiment;

FIG. 32 is a schematic enlarged cross sectional view a core-clad tubular fluorescent lamp (a portion surrounded with a circle “PA” of FIG. 1) according to a twentieth embodiment;

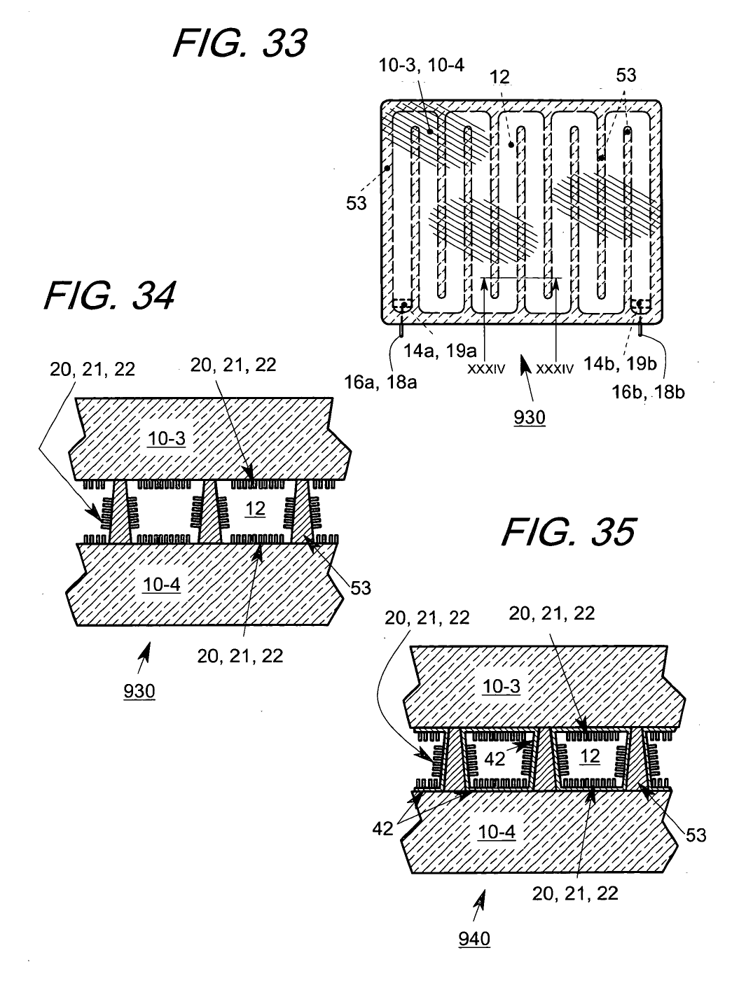

FIG. 33 is a schematic top view showing a flat fluorescent lamp 930 according to a twenty first embodiment; FIG. 34 is a schematic cross sectional view taken along the line XXXIII-XXXIII of FIG. 32 showing a flat fluorescent lamp 930 of the twenty first embodiment;

FIG. 35 is a schematic cross sectional view taken along the line XXXIII-XXXIII of FIG. 32 showing a flat fluorescent lamp 940 according to a twenty second embodiment;

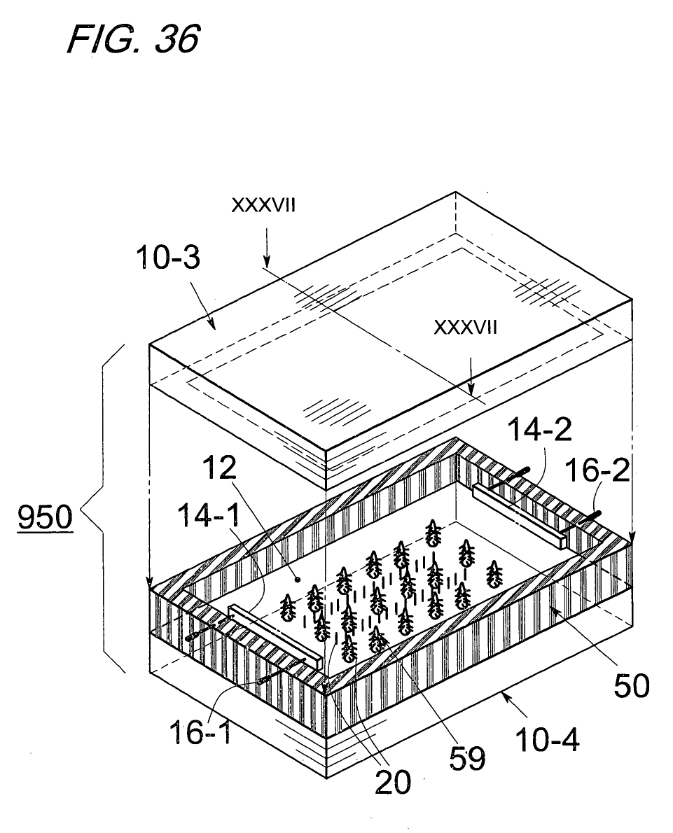

FIG. 36 is a schematic exploded perspective view showing a flat fluorescent lamp 950 according to a twenty third embodiment;

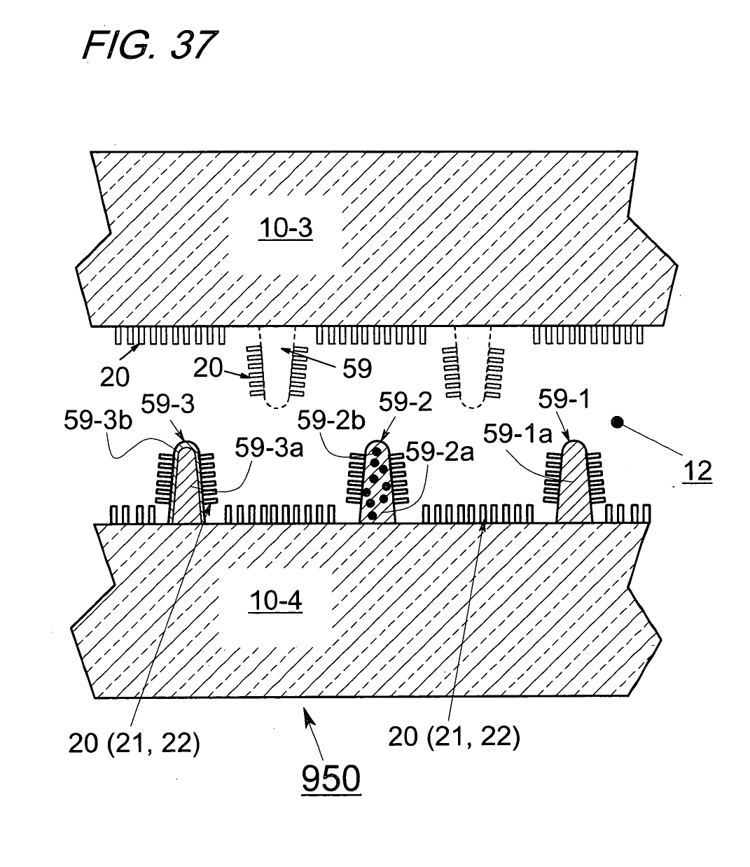

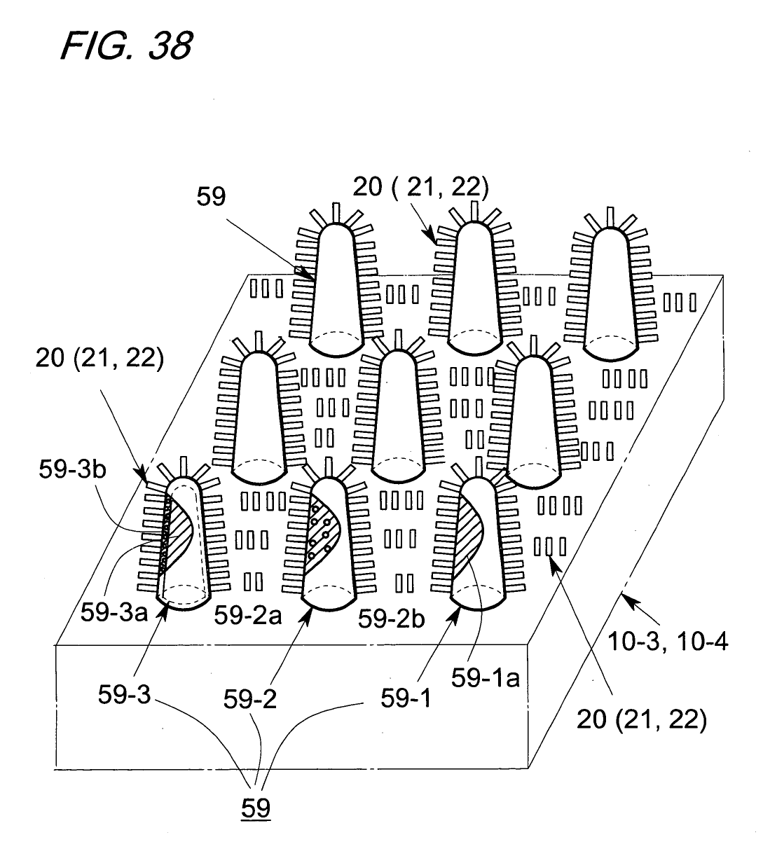

FIG. 37 is a schematic cross sectional view taken along the line XXXIIII-XXXIIII of FIG. 36; FIG. 38 is a schematic enlarged, partial, perspective view showing a major portion of a flat fluorescent lamp according to the twenty third embodiment; and,

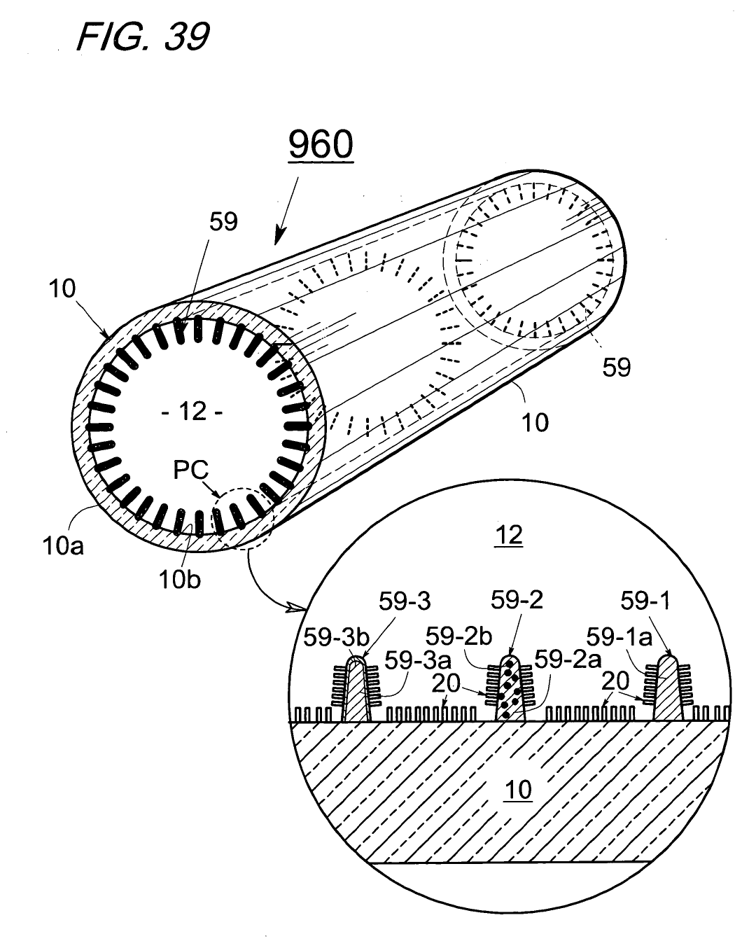

FIG. 39 is a schematic perspective view showing a glass tube portion of the tubular fluorescent lamp 960 according to the twenty fourth embodiment, in which a portion “PC” surrounded with a circle is drawn as an enlarged cross sectional view in the same FIG. 39.

### REFERENCE NUMERALS

Major reference numerals or characters are listed as follows, in which a like or similar element is designated by the same reference numeral or character, wherein:
10, 10-1, 10-2; glass tube or glass bulb (i.e. envelope),
10a, 10b; surface or wall (of the glass tube),
10-3, 10-4; substrate or glass plate,
12, 12a, 12b; discharge space,
14a, 14b; filament, filament electrode or hot cathode (i.e. electrode),
14-1, 14-2; electrode,
19a, 19b; cold cathode (i.e. electrode),
20, 20′, 20″, 20′″, 20-1, 20-2, 20′-1, 20′-2, 20′-3, 21, 22, 23, 24; fluorescent fiber or fluorescent optical fiber,
21c, 23c, 24c, 24e; core (of fluorescent fiber or fluorescent optical fiber),
21d, 23d, 24d, 24f; clad (of fluorescent fiber or fluorescent optical fiber),
22a; fixed end (of fluorescent fiber or fluorescent optical fiber),
22b, 22c; fee end (of fluorescent fiber or fluorescent optical fiber),
30, 30a, 30b, 30c, 30d, 30e, 30f; phosphor or phosphor particle,
40, 40-1, 40-2, 40a, 40b, 40c; glass film or glass binder film,
42, 58a, 58b, 58c; fluorescent (phosphor) film, fluorescent glass film or phosphor containing glass film,
50; sealant, flame-like sealant or spacer,
52, 52a, 53; barrier wall, partition wall or separator,
54, 56; stripe electrode,
55; dielectric film,
59, 59-1, 59-2, 59-3; protrusion (projection) or finger-like protrusion,
59-1a, 59-2a, 59-3a; core-like member (of protrusion),
59-3b; clad-like member (of protrusion),
59-2b; phosphor particle (of protrusion),
60, 75; through-hole,
81a; dot or point shaped electro-conductive film,
100, 200, 300, 400, 500, 800, 960; tubular fluorescent lamp,
600, 700, 930, 940, 950; flat fluorescent lamp, and
900, 910, 920; plasma display panel.

### DETAILED DESCRIPTION OF THE INVENTION

### Embodiments of the Invention

The several preferred embodiments of the present invention are described in detail hereinafter with reference to the drawings (the several views of the drawing) attached herewith. Like or similar element (part or portion) is designated by the same reference numeral or character throughout all figures, in which the elements are not necessarily shown to scale.

The discharge fluorescent apparatus of the present invention is accomplished by an analogy of a small intestine in a human body, in which the small intestine has villus/villi or microscopic, finger-like or fiber-like protrusions on an inner wall thereof in order to give a massive surface area.

The discharge fluorescent apparatus of the present invention may have a plurality of fluorescent fibers, a plurality of fluorescent protrusions or at least one barrier wall on an inner wall of an envelope of the discharge fluorescent apparatus in order to obtain a massive surface area similar or equivalent to the surface area of the villus/villi in the small intestine. Therefore, the discharge fluorescent apparatus of the present invention is a kind of the bionics or a creative imitation of the small intestine in the human body.

### FIRST EMBODIMENT

Referring to FIG. 1 to FIG. 4, a first embodiment is described as follows. FIG. 1 is a schematic partial cross sectional view showing a fluorescent lamp that is an example of a discharge fluorescent apparatus, FIG. 2 is a schematic enlarged cross sectional view showing a portion “PA” surrounded with a circle of FIG. 1, FIG. 3 is a schematic enlarged cross sectional view along the line III-III of FIG. 1 and FIG. 4 is a schematic perspective view showing a major portion of the fluorescent lamp.

In FIG. 1 through FIG. 4, a straight, tubular fluorescent lamp (discharge fluorescent apparatus) 100 is briefly composed of a straight, tubular glass tube (envelope) 10, dischargeable gas sealed in a discharge space 12 of the glass tube 10, electrodes 14a and 14b positioned at inner ends of the glass tube or bulb (envelope) 10 and a plurality of fluorescent fibers 20 fixed on an inner surface of the glass tube or bulb 10. The electrodes 14a and 14b may be composed of filaments or hot cathodes coated with an electron emission material.

The dischargeable gas is composed of an inert gas or rare gas such as Argon (Ar), Xenon (Xe), Helium (He), Neon (Ne), Krypton (Kr) or a mixture thereof and a small amount of mercury (Hg).

The tubular fluorescent lamp 100 is further composed of stems 13a and 13b to seal opposed ends of the glass tube 10 and to mount the electrodes 14a and 14b, bases 15a and 15b positioned in the ends of the glass tube 10 and base pins 16a and 16b that project outside from the bases 15a and 15b and electric wires 17a and 17b that connect the electrodes 14a and 14b and the base pins 16a and 16b.

In the conventional tubular fluorescent lamp, a phosphor film (fluorescent film) is coated almost entirely on an inner surface (inner wall) of the tubular glass tube (envelope) 10.

In this embodiment of the present invention, a plurality of fluorescent fibers (phosphor containing fibers or phosphor carrying fibers) 20 is disposed entirely or partially on the inner surface (inner wall) of the tubular glass tube (envelope) 10 in such a manner that the fluorescent fibers 20 stand on the inner surface of the tubular glass tube 10, wherein each of the fluorescent fibers 20 is composed of a fiber and a fluorescent or phosphor material to contain therein/thereon.

Optionally, the fluorescent or phosphor film (40 and 30e) (see e.g. FIG. 11) may be coated on the inner surface of the tubular glass tube 10, in addition to the fluorescent fibers 20 that are disposed on the tubular glass tube 10.

When the filament electrodes 14a and 14b are preliminarily heated by feeding a preliminary electric current thereto, hot electrons generated at the filament electrodes 14a and 14b enter an inside of the tubular glass tube 10.

In this condition, when a sufficient AC voltage is applied between the electrodes 14a and 14b, that electrons are alternately moved to the electrodes 14a and 14b to initiate a discharge.

The electrons moving between the electrodes 14a and 14b strike to mercury atoms contained inside the tubular glass tube 10 to generate vacuum ultraviolet rays (V-UV) having a peak wavelength of 254 nanometer (nm) and 185 nm.

The fluorescent fibers 20 or a phosphor material contained in the fluorescent fibers 20 are excited upon irradiation of the V-UV so that visible light rays generate and the visible light rays exit from the tubular glass tube 10.

Materials as the phosphor particles or particulate phosphor used in this invention may be conventional three wavelength region emitting phosphors, typically composed of (1) glue emitting phosphors with the peak wavelength of about 450 nm, (2) green emitting phosphors with the peak wavelength of about 540 nm and (3) red emitting phosphors with the peak wavelength of about 610 nm.

The green emitting phosphors (1) may be selected from chemical compositions:
3(Ba, Mg) O, 8Al₂O: Eu;
(Sr, Ca, Ba) 10(PO₄) 6Cl₂: Eu;
(Sr, Ca, Ba, Mg) 5(PO₄) 3Cl: Eu;
Ba, Mg, Al₁₄O₂₃: Eu₂;
CaWO₄: Pb; and
Y₂SiO₅: Ce.

The green emitting phosphors (2) may be selected from chemical compositions:
(La, Ce)(P, B)O₄: Tb;
LaPO₄: Ce, Tb;
BaAl₁₂O₁₉: Mn;
YBO₃: Tb; and
Zn₂SiO₄: Mn.

The red emitting phosphors (3) may be selected from chemical compositions:
Y₂O₃: Eu;
(Y, Gd)₂O₃: Eu;
Y₂SiO₅: Eu;
YBO₃: Eu;
(Y, Gd) BO₃: Eu;
Gd BO₃: Eu; and
ScBO₃: Eu.

Conventional white color emitting phosphors such as Ca10 (PO4)6FCl: Sb, Mn may substitute for the 3 wavelength region emitting phosphors described above.

The three wavelength region emitting phosphors and the white color emitting phosphors are commercially available from manufacturers such as Toshiba materials Co., Ltd., Japan and Nichia Corporation, Japan.

Three kinds of the fluorescent fibers 20 having each kind of the 3 wavelength region emitting phosphors may be used in the present invention, in which the different fluorescent fibers 20 may be composed of optical fibers containing the different kind of the 3 wavelength region emitting phosphors therein/thereon.

Alternatively, the fluorescent fibers 20 may be composed of the optical fibers containing a mixture of the 3 kind of the 3 wavelength region emitting phosphors therein/thereon.

Alternatively, the fluorescent fibers 20 may be composed of the optical fibers containing the white color emitting phosphors.

Other phosphor materials for use in the present invention are phosphor glasses or fluorescence glasses capable of exhibiting fluorescence in the visible region by ultraviolet excitation.

These phosphor glasses or fluorescence glasses may be fluoro-phosphate fluorescent glass and oxide fluorescent glass.

The fluoro-phosphate fluorescent glass is disclosed in the patent documents such as Patent document No. 4 (Japanese Patent Laid-Open No. 8-133780), Patent document No. 5 (U.S. Pat. No. 5,635,109) that corresponds to the Patent document No. 4, Patent document No. 6 (Japanese Patent Laid-Open No. 9-202642) and Patent document No. 7 (U.S. Pat. No. 5,755,998) that corresponds to the Patent document No. 6.

A chemical composition of the fluoro-phosphate fluorescent glass is at least, phosphorus (P), oxygen (O) and fluorine (F), as glass constituting components, and divalent europium, as a fluorescent agent.

The oxide fluorescent glass is disclosed in the patent documents such as Patent document No. 8 (Japanese Patent Laid-Open No. 10-167755) and Patent document No. 9 (U.S. Pat. No. 5,961,883) that corresponds to the Patent document No. 8.

A chemical composition of the oxide fluorescent glass is at least, silicon (Si), boron (B) and oxygen (O), and further containing terbium (Tb) or europium (Eu) as a fluorescent agent.

The fluorescent glasses described above are commercially available from SUMITA OPTICAL GLASS, INC. Japan, as a fluorescence glass “LUMILUS” (brand name), in which Blue fluorescence glass is LUMILUS-B (product name) Green fluorescence glass is LUMILUS-G9 (product name) and Red fluorescence glass is LUMILUS-R7 (product name), that are quoted from a catalogue on web homepage of SUMITA OPTICAL GLASS, INC.

The Blue fluorescence glass (LUMILUS-B) has main fluorescence wavelength: 405 nm and excitation wavelength range: 200-400 nm, the Green fluorescence glass (LUMILUS-G9) has main fluorescence wavelength: 540 nm and excitation wavelength range: 200-390 nm and the Red fluorescence glass (LUMILUS-R7) has main fluorescence wavelength: 610 nm and excitation wavelength range: 200-420 nm.

The fluorescent fiber 20 of the present invention may be made from the fluorescent glass in such a manner that each kind of the fluorescent glass (B, G and R) is crushed to be small fluorescent particles and the fluorescent particles (B, G and R) are separately carried on separate optical fibers, three kind of the fluorescent particles (B, G and R) are mixed together and a mixture of the fluorescent particles (B, G and R) is carried on the same optical fibers.

The fluorescent fiber 20 of the present invention may be made from the fluorescent glass in such a manner that the fluorescent glass itself may be elongated to be a fiber by similar manufacturing process to get conventional optical fibers for use in a telecommunication, illumination or lighting purpose.

As shown in FIG. 2, each of the fluorescent fibers 20 may be composed of a substantially transparent elongated member having a predetermined length, a pair of ends (terminals) 20a and 20b, and a plurality of phosphor particles 30 contained in/on the elongated member, in which one end 20a is a fixed end and another end 20b is a fee end.

The glass tube (tubular glass bulb) 10 may be composed of an outer surface (outer wall) 10a, an inner surface (inner wall) 10b, a predetermined thickness and a predetermined length extended to an axial direction of the glass tube 10.

The fluorescent fibers 20 may be supported on the inner surface 10b of the glass tube 10 at the fixed end 20a of the fluorescent fibers 20 so as to be securely fixed by e. g. fusing or melting.

The fluorescent fibers 20 may be stand together on the inner surface 10b and elongate substantially straight from the inner surface 10b toward a center axis of the glass tube 10.

A substantially soft glass tube may be used for the glass tube 10, made of e.g. general soda lime glass that is transparent to all visible light and absorbs most ultraviolet rays.

The fluorescent fiber 20 may be a fiber-like member, column-like member, cylindrical member, filament-like member, needle-like member, rod-like member, whisker-like member or protruded member that contains a phosphor or fluorescent material therein/thereon, in which the fluorescent fiber 20 may generally have a circular or oval shape in cross section.

First Embodiment-(A): Core-Clad Fluorescent Optical Fiber

As shown in FIG. 5A and FIG. 5B, the fluorescent fiber 21 having a core-clad structure is composed of the core 21c having a transparent light conducting elongated member permeable (i.e. transmissive, conductive or transparent) to visible and “V-UV” light with a fixed end 21a and a free end 21b and the clad 21d including a phosphor or fluorescent material disposed therein, in which the clad 21d may be disposed entirely or partially on a side surface of the core 21c.

The clad 21d may be composed of a transparent light conducting glass film permeable (i.e. transmissive, conductive or transparent) to visible and “V-UV” light and a plurality of phosphor or fluorescent particles 30 dispersed in the glass film. Alternatively, the clad 21d may be composed of a sintered fluorescent or phosphor film.

Vacuum ultra violet rays “V-UV” radiated from a dischargeable gas enter from the clad 22d to the core 21c and/or from the free end 21b to the core 21c.

At this time, the phosphor or phosphor particles 30 generate or emit visible light “VL” upon excitation by “V-UV”, in which the visible light is non-directional scattering or diffusing light.

Some volume of the visible light “VL” introduced from the clad 21d into the core 21c transmits within the core 21c.

Materials of Core and Clad

Silica glass or boric, silicic acid glass may be preferably used for material of the core 21c, because such material has an excellent permeability or transparency to vacuum ultraviolet rays (V-UV) as well as visible light.

In the silica glass, there are a synthetic silica glass chemically synthesized and a fused quartz produced by melting natural silica powders, both of which are preferably used for material of the core 21c.

The clad 21d may be preferably composed of a transparent inorganic binder having V-UV and visible light permeability similar to the core 21c and one kind or more kinds of the phosphor particles 30 with three wavelength range (B, G or R) that are dispersed in the clad 21d.

As material of the inorganic binder, for example, the low melting point glass frit or glass powder having an excellent light transparency and a low melting point (low softening temperature) can be used, in which the glass frit or glass powder is made in such a manner that the low melting point glass is finely crushed.

The low melting point glass frit or glass powder may have the chemical composition of PbO—B₂O₃—SiO₂, B₂O₃—PbO, SiO₂—B₂O₃—PbO, PbO-SiO₂, P₂O₅—SnO, P₂O₅—SnO—B₂O₃, etc.

The glass powder or frit may be used in a liquid state of glass paste or glass powder dispersion liquid, in which the glass paste or glass powder dispersion liquid is composed of the glass powder or frit, resin for dispersion and solvent, and all of them are mixed together.

As the resin for dispersion, such resin can be used as ethyl-cellulose, nitro-cellulose, methyl- cellulose, acetyl-cellulose, acetyl-ethyl-cellulose, cellulose-propionate, hydroxyl-propyl-cellulose, butyl-cellulose, benzyl-cellulose, acrylic resin. As the solvent, inorganic liquid of terpineol, isoamyl acetate, etc. can be used.

Further, phosphor containing glass paste may be made so that the glass paste or glass powder dispersion liquid is mixed with the multiple phosphor or fluorescent particles.

The clad 21d may be formed entirely or partially on a side surface of the core 21c in such a manner that the phosphor containing glass paste is at first coated on the core 21c composed of transparent core glass e.g. silica glass having melting point higher than that of the glass powder in the phosphor containing glass paste.

Then, after drying of the coating the core 21c coated with the phosphor containing glass paste is fired by application of sufficient range of temperature less than the melting point of the core glass, so that the organic component of the resin and the solvent are volatilized or burned out and the glass component of the phosphor containing glass paste is sintered on the core 21c.

In that way, a glass film to contain the phosphor or fluorescent particles dispersed therein are made on the core 21c, in which the glass film to contain the phosphor or fluorescent particles acts as the clad 21d.

The grass powder or frit and/or the glass paste are commercially available from the manufactures such as ASAHI GLASS COMPANY, LTD., Japan and CORNING CORPORATION, U.S.A.

Alternatively, a phosphor sintered clad to act as the clad 21d may be formed on the high melting point glass core 21c of e.g. silica glass in such a manner that the phosphor particles 30 are mixed with an organic component composed of the resin and the solvent so as to make a liquid state mixture (phosphor paste) to exclude the glass powder.

Then, the phosphor paste is coated on the glass core 21c and after drying of the coating the core 21c coated with the phosphor paste without glass is fired by application of sufficient range of temperature less than the melting point of the glass core 21, so that the organic component of the resin and the solvent are volatilized or burned out and the phosphor is sintered on the core 21c to make the sintered phosphor film to act as the clad 21d.

The phosphor paste described above may be composed of a plurality of the phosphor or fluorescent particles 30, the solvent and the resin as binder, and all of them are mixed together, in which the resin may be ethyl-cellulose, nitro-cellulose, methyl-cellulose, acetyl-cellulose, acetyl-ethyl-cellulose, cellulose-propionate, hydroxyl-propyl-cellulose, butyl-cellulose, benzyl-cellulose, acrylic resin and the solvent or inorganic liquid may be terpineol, isoamyl acetate, etc.

Refractive Index of Core and Clad of Fluorescent Optical Fiber

As shown in FIG. 5A and FIG. 5B, the refractive index no of the organic binder for use in the clad 21d may be lower than the refractive index n₂ of the core 21c.

In this case, as shown in FIG. 5B, the fluorescent optical fiber 21 acts as a non-leaky or normal optical fiber, in which ultraviolet rays “V-UV” radiated from a dischargeable gas within the discharge space 12 (see FIG. 1 and FIG. 2) introduced directly to the clad 21d excites the phosphor particles 30 so that visible scattering light “VL” is emitted from the clad 21d.

Some volume of the visible scattering light “VL” is introduced into the core 21c to transmit within the core 21c and exits from the fixed end 21a thereof to go out from the transparent glass tube 10 (see FIG. 1 to FIG. 4).

Other some volume of the visible scattering light “VL” exits from the clad 21d to go out from the transparent glass tube 10 without entering the core 21c.

The refractive index n₁ of the organic binder for use in the clad 21d may be higher than the refractive index n₂of the core 21c.

In this case, the fluorescent optical fiber 21 acts as a leaky optical fiber, in which the ultraviolet rays “V-UV” radiated from the dischargeable gas in the discharge space 12 (see FIG. 1 and FIG. 2) introduced into the core 21c from the free end 21b thereof leaks to the fluorescent clad 21d so as to emit the visible scattering light “VL” therefrom upon excitation of the ultraviolet rays “V-UV”.

Some volume of the visible scattering light “VL” is introduced into the core 21c to transmit within the core 21c and exits from the fixed end 21a thereof to go out from the transparent glass tube 10 (see FIG. 1 to FIG. 4).

Other some volume of the visible scattering light “VL” exits from the clad 21d to go out from the transparent glass tube 10 without entering the core 21c.

Stepped Index Fluorescent Optical Fiber

A stepped index fluorescent fiber may be used as the fluorescent fiber 21 for the present invention.

In the stepped index fluorescent fiber 21, a refractive index of the core 21c is set more than the refractive index of the clad 21d, similarly to general stepped index optical fibers used in e.g. optical communication.

The stepped index fluorescent fiber 21 may be composed of the core 21c with a first refractive index and the clad 21d with a second refractive index less than the first refractive index and the phosphor or fluorescent particles 30 dispersed in the clad 21d.

In the stepped index fluorescent fiber 21, the core 21c may be made from the pure silica glass with a high first refractive index and the clad 21c may be made from the silica glass inorganic binder and a refractive index control material as an additive to obtain a second refractive index lower than the first refractive index, in which fluorine (F) or boron (B) is desirably used for the additive to reduce the refractive index of the clad 21d.

In the stepped index fluorescent fiber 21, most of the visible light “VL” introduced into the core 21c advances within the core 21c to a direction of the fixed end 21a to repeat reflection one ore more times at an interface between the core 21c and the clad 21d based on the principle of total internal reflection (TTR) and the visible light “VL” exits from the fixed end 21a so as to go out through the glass tube 10.

Other some volume of the visible light “VL” exits from the clad 21d after once entering the core 21c. Still other some volume of the visible light “VL” exits directly from the clad 21d without entering the core 21c.

In this way, most of the visible light “VL” emitting from the clad 21d and exiting from the fluorescent fibers 21 goes out from the glass tube 10 (transparent substrate) to support and fix the fluorescent fibers 21.

Further, a transparent and UV permeable (i.e. transmissive, conductive or transparent) second clad excluding phosphor (not shown in FIG. 5A and FIG. 5B) may be disposed on the clad 21d.

The refractive index of the second clad is lower than the refractive index of the clad 21d, so that when the visible light emitting from the phosphor 30 in the clad 21d is introduced into the core 21c, more volume of the visible light can be transmitted within the core 21c and captured therein based on the principle of total internal reflection (TTR) without leaking the clad 21d so as to exit from the fixed end 21a and to go out through the glass tube 10.

Further, a third clad excluding the phosphors, having UV and visible light permeability may be disposed between the core 21d and the clad 21d including the phosphors 30 therein, and the core 31c, the third clad and the clad 21d may be set to decrease in that order in the refractive index.

In that case, some volume of the visible scattering light without directivity emitted from the clad 21d including the phosphors 30 is introduced into the core 21c through the third clad and the light is effectively captured or trapped within the core 21c based on the principle of total internal reflection (TFR) so as to transmit to the fixed end 21c and go out through the glass tube (transparent substrate) 10. The rest volume of the visible light goes out directly through the glass tube (transparent substrate) 10.

To the contrary, in the core-clad fluorescent fiber 21, a leaky fluorescent fiber may be used in the present invention, in which the leaky fluorescent fiber may be composed of the core 21c with a first refractive index and the clad 21d with a second refractive index higher than the first refractive index and the phosphor or fluorescent particles 30 dispersed in the clad 21d. In the leaky fluorescent fiber, the V-UV rays introduced or entered from the free end 21b of the fluorescent fiber 21 into the core 21c easily exit from a side surface thereof to excite the fluorescent clad 21d covered by the core 21c so that the fluorescent clad 21d can emit visible light, in which the fluorescent clad 21d can be excited by the V-UV entered from a surface of the fluorescent clad 21d and also by the V-UV entered from the core 21c through the free end 21b.

Aspect Ratio of Fluorescent Optical Fiber

When the ratio of a length “l” of an axis direction of core 21c to a diameter “d” of core 21c is defined as the aspect ratio (=1/d) herein, the fluorescent optical fibers 21 change in the number that can be disposed on the inner wall 10a of the glass tube 10 in proportion to the value of the aspect ratio.

If the aspect ratio (=1/d) of the fluorescent optical fibers 21 is set to large value, the entire surface area of the clads 21d in the total fluorescent optical fibers 21 becomes large, therefore the total area of the phosphor or fluorescent films (fluorescent clads) 21d becomes large, in which the films (clads) 21d are disposed on the side surface of the cores 21c.

The aspect ratio of the cores may be set to about 1 to about 100 and it may be set practically about 2 to 50.

First Embodiment-(B): Single Core Fluorescent Optical Fiber

As shown in FIG. 6A and FIG. 6B, the fluorescent optical fiber 22 having the single core structure is composed of the core 22c having a transparent light conducting elongated member with a fixed end 22a and a free end 22b and a plurality of the phosphor or fluorescent particles 30 dispersed in the core 22c.

As shown in FIG. 6A and FIG. 6B, the fluorescent fiber 22 may be composed of a single core structure having the transparent optical core to contain the phosphor or fluorescent material therein.

FIG. 6A is a schematic enlarged perspective view showing the fluorescent fiber 22 having the core structure.

FIG. 6B is a schematic enlarged perspective view showing a principle of the fluorescent fiber 22 of FIG. 6A, in which optical paths of light are shown,

As shown in FIG. 6B, vacuum ultra violet rays “V-UV” radiated from a dischargeable gas in the discharge space 12 (see e.g. FIG. 1A) enter from the free end 22b and from the side surface of the fluorescent core 22c to contain the phosphor or phosphor particles 30 therein.

At this time, the phosphor or phosphor particles 30 generate or emit visible light “VL” upon excitation with “V-UV”, in which the visible scattering light “VL” is non-directional, scattering or diffusing light.

Most volume of the visible scattering light “VL” generated within the core 22c advances toward the fixed end 22a thereof to reflect one or more times at an interface between the side surface of the core 22c and the dischargeable gas having refractive index lower than that of the core 22c.

Other some of the visible scattering light “VL” exits from the side surface of the core 22c directly or on the way to advancing toward the fixed end 22a.

The visible scattering light “VL” exited from the fixed end 22a and the surface of the core 22c goes out through the glass tube (transparent substrate) 10.

Further, an additional clad (not shown in FIG. 6A and FIG. 6B) may be disposed on the surface of the fluorescent core 22c, in which the additional clad is transmissible to ultraviolet rays, excludes phosphor materials and has a refractive index lower than that of the fluorescent core 22c.

In this case, most of the visible light “VL” emitted from the fluorescent core 22c is captured therein based on the principle of total internal reflection (TTR) and transmits to the fixed end 22a to exit therefrom.

The rest of the visible light “VL” leaks from the side surface of the core 22c to exit therefrom.

The fluorescent fiber/fibers 22 may be formed in such a manner that one or more kinds of the phosphor particles 30 with three wavelength range (B, G and R phosphor) are mixed with the glass particles (glass powder) such as SiO₂ or B₂O₃ to get a mixture.

Then, the mixture is heated to a temperature range more than the softening temperature or melting point of the glass powder so as to soften or melt.

Next, the mixture softened or melted with high temperature is extruded from a nozzle with small size of hole/holes similar to the diameter of the core 22c and after cooling long fluorescent fiber/fibers are winded on reel/reels.

The long fluorescent fiber/fibers each having a substantially circular cross section are cut to short fluorescent fibers 22, each having a suitable average length with an aspect ratio (a ratio of the length to the diameter) of e.g. about 1 to 100, preferably about 2 to 50.

The fluorescence glass “LUMILUS” (brand name) such as “LUMILUS-B”, “LUMILUS-G9” and/or “LUMILUS-R7” mentioned above may be used for a master batch material to make the fluorescent particles 30, in such a manner that the master batch material composed of the fluorescence glass “LUMILUS” (brand name) is finely crushed and to screened to get the fluorescent particles 30 with a similar average size.

The fluorescent fiber/fibers 22 may be formed in such a manner that one or more kinds of the phosphor particles 30 composed of the “LUMILUS-B”, “LUMILUS-G9” and/or “LUMILUS-R7” with three wavelength range (B, G and R fluorescence) are mixed with the glass particles (glass powder) such as SiO₂, B₂O₃ to get a mixture, the mixture then is heated to a temperature range more than the softening temperature or melting point of the glass powder so as to soften or melt.

The mixture with high temperature is extruded from the nozzle with small size of hole/holes similar to the diameter of the core 22c and after cooling long fluorescent fiber/fibers are winded on reel/reels.

The long fluorescent fiber/fibers are cut to short fluorescent fibers 22, each having suitable average length with the aspect ratio of e.g. about 1 to 100, preferably about 2 to 50.

As the fluorescent optical fiber 20 used for the present invention, two kinds of the fluorescent optical fibers 21 and 22 having the core-clad structure and the single core structure respectively are described above referring to FIG. 5A and FIG. 6A.

However, the fluorescent optical fiber 21 are not limited to the fluorescent optical fibers 21 and 22 and the fluorescent optical fiber 20 used for the present invention, for example, may be the fluorescent optical fiber with core-clad structure as shown in FIG. 7 and FIG. 8.

First Embodiment-(C): Dual Clads Fluorescent Optical Fiber

FIG. 7 is a schematic enlarged cross sectional view showing another fluorescent optical fiber 23 that is a modification of the first embodiment-(A).

As shown in FIG. 7, a fluorescent optical fiber 23 may be composed of a core 23c and a fluorescent clad 23d to be covered thereon, the core 23c may contain a first fluorescent or phosphor material therein to emit a first color light with Blue (B), Green (G) or Red (R), while the clad 23d may contain a second and/or a third fluorescent phosphor materials therein to emit the second and/or the third color light with B, G or R. The first, second and the third fluorescent and phosphor materials may be three kinds of plural fluorescent or phosphor particles 30a, 30b and 30c to emit B, G or R color light that are dispersed in the core 23c and the clad 23d.

First Embodiment-(D): Triple Clads Fluorescent Optical Fiber

FIG. 8 is a schematic enlarged cross sectional view showing still another fluorescent optical fiber 24 that is another modification of the first embodiment-(A).

As shown in FIG. 8, a fluorescent optical fiber 24 may be composed of a core 24c, a first fluorescent clads 24d to be covered thereon, a second and a third the clads 24e and 24f to be covered on the first fluorescent clads 24d, in which the clads 24d, 24e and 24f form a laminate on the core 24c.

In FIG. 8, the core 24c is composed of an elongated transparent core or optical fiber core without fluorescent or phosphor material and each of the clads 24d, 24e and 24f is composed of a transparent glass film and plural fluorescent or phosphor particles 30a, 30b and 30c to emit different color light with B, G or R, or composed of three kinds of fluorescent glass films such as the “LUMILUS-B”, “LUMILUS-G9” and/or “LUMILUS-R7” with three wavelength range (B, G, R fluorescence) as described above.

The fluorescent or phosphor containing clads 24d, 24e and 24f emit color light B, G and R non-directionally when exited by the “V-UV”.

When a refractive index of the core 24c is set more than the refractive index of the clads 24d, 24e and/or 24f, some volume of the color light enters the core 24c to be captured within the core 24c based on “TTR” so as to transmit therein toward the fixed end, three color light B, G and R are mixed together in the core 24c to make white light and the white light exits from the core 24c to go out from the glass tube 10 (see e.g. FIG. 1).

The rest volume of the light emitted within the clads 24d, 24e and 24f exits directly outside of the fluorescent fiber 24 to go out from the glass tube 10.

When a refractive index of the core 24c is set less than the refractive index of the clads 24d, 24e and/or 24f, the “V-UV” entered into the core 24c leaks therefrom to excite the clads 24d, 24e and 24f.

Some volume of the color light B, G, R from the clads 24d, 24e and 24f enters the core 24c and/or the laminate composed of the clads 24d, 24e and 24f and another some volume of the color light B, G, R exits from the fluorescent fiber 24.

The “V-UV” entered into the clads 24d, 24e and 24f from the side surfaces thereof excites the clads 24d, 24e and 24f to emit color light B, G, R and some volume of the color light B, G, R from the clads 24d, 24e and 24f enters the core 24c and/or the laminate composed of the clads 24d, 24e and 24f and another some volume of the color light B, G, R exits from the fluorescent optical fiber 24.

Since the clads 24f is surrounded by the gas 12 (see e.g. FIG. 1) having higher refractive index than that of the clad 24f, the color light B, G, R within the fluorescent optical fiber 24 is be captured therein based on “TTR” so as to transmit therein toward the fixed end, three color light B, G and R are mixed together in the core 24c to make white light and the white light exits from the core 24c to go out from the glass tube 10 (see e.g. FIG. 1).

The rest volume of the light emitted within the clads 24d exits directly outside of the fluorescent fiber 24 to go out from the glass tube 10.

Then, after cooling to room temperature the fluorescent optical fibers 20 (e.g. 21, 22, 23 and 24) are permanently fixed at the fixed ends 20a (e.g. 21a, 22a) on the inner surface 10b of the glass tube (transparent substrate) 10 so as to stand together.

As the heating means, a gas burner, electric heater, laser beam, dielectric heater or high frequency heater may be used.

Further, the fluorescent optical fibers 20 (e.g. 21, 22, 23 and 24) may be disposed on the inner surface 10b of the glass tube 10 by an electrostatic process.

The electrostatic process may be performed in such a manner that a first electrostatic charge with e.g. positive charge is given to the fluorescent optical fibers 20 and/or a second electrostatic charge with e.g. negative charge opposed to the first electrostatic charge is given to the inner surface 10b of the glass tube 10 by applying a high DC voltage from a high DC voltage power supply.

he fluorescent optical fibers 20 are electrostatically attached or flocked on the inner surface 10b by an electrostatic attraction and at least the inner surface 10b is heated temporarily to sufficient temperature range by the any heating means.

Thereby, the fluorescent optical fibers 20 (e.g. 21, 22, 23 and 24) are permanently fixed at the fixed ends 20a (e.g. 21a, 22a) on the inner surface 10b of the glass tube (transparent substrate) 10 so as to stand together thereon. If an electrostatic process e.g. an electrostatic flocking is applied for disposing the fluorescent fibers 20 on the surface of the glass tube 10 (envelope, substrate), many numbers of the fluorescent fibers can be arranged on the surface in high density and substantially perpendicularly to the surface without entangling to one another.

That is to say, a method for disposing the fluorescent fibers 20 (e.g. 21, 22, 23 and 24) on the substrate 10 e.g. the glass tube, comprises the steps of: a first step of giving an electric charge to the fluorescent fibers 20 and/or the substrate 10; a second step of adhering tentatively the fluorescent fibers 20 on the substrate 10 by an electrostatic attraction; and a third step of applying sufficient heat to the substrate 10 and/or the fluorescent fibers 20 up to a softening temperature or a melting point of the substrate 10 and/or the fluorescent fibers 20, thereby after cooling, to fix and stand together permanently the fluorescent fibers 20 on the substrate 10.

Another method for disposing plural fluorescent fibers 20 (e.g. 21, 22, 23 and 24) on a glass tube 10, may comprise the steps of: a first step of positioning a first electrode in an inner space of the glass tube 10 and positioning a second electrode in an outside of the glass tube 10; a second step of supplying the plural fluorescent fibers 20 into the inner space of the glass tube 10; a third step of applying a high DC voltage between the first and the second electrodes electrostatically so as to fly and adhere tentatively the fluorescent fibers 20 on an inner surface of the glass tube 10; and a fourth step of applying sufficient heat to the glass tube 10 and/or the fluorescent fibers 20 up to a softening temperature or a melting point of the glass tube 10 and/or the fluorescent fibers 20, thereby after cooling, to fix and stand together permanently the fluorescent fibers 20 on the glass tube 10.

In this method, the third step of applying a high DC voltage and the fourth step of applying sufficient heat may be carried out at the same time.

When, three different kinds of the fluorescent fibers 20 to emit different color light Blue, Green or Red are disposed to arrange adjacently on the inner surface 10b of the glass tube 20, persons can observe white color mixed with the three colors from the outer surface 10a of the glass tube 10.

The present invention may be applicable to the fluorescent lamps having any curved shapes as well as the straight shapes mentioned hereinbefore/hereinafter such as “U”, “O”, “W”, “L”, “C”, spiral shape and zigzag shape that bend the straight glass tube 10 to the curbed shapes.

### SECOND EMBODIMENT

Referring to FIG. 9 and FIG. 10, a second embodiment of the present invention is described hereinafter.

In the description of the second embodiment, the description common with the first aspect of the embodiment may be omitted for simplifying an explanation.

FIG. 9 is a schematic cross sectional view showing a discharge fluorescent apparatus 200 according to the second embodiment of the present invention and FIG. 10 is a partial enlarged cross sectional view of a portion surrounded by a circle “PB” of FIG. 9.

In FIG. 9 and FIG. 10, a straight tubular fluorescent lamp (discharge fluorescent apparatus) 200 is briefly composed of a straight tubular glass tube (envelope) 10, the discharge-able gas sealed in the discharge space 12 of the glass tube 10, electrodes 14a and 14b positioned at inner ends of the glass tube 10 and a plurality of fluorescent fibers 20 fixed on an inner surface of the glass tube 10.

The discharge-able gas is composed of an inert gas such as Argon (Ar), Xenon (Xe), Helium (He), Neon (Ne), or a mixture thereof and a small amount of mercury (Hg).

The electrodes 14a and 14b may be composed of filaments or hot cathodes coated with an electron emission material.

The tubular fluorescent lamp 200 is further composed of stems 13a and 13b to seal opposed ends of the glass 10 and to mount the electrodes 14a and 14b, bases 15a and 15b positioned in the ends of the glass tube 10 and base pins 16a and 16b that project outside from the bases 15a and 15b and electric wires 17a and 17b that connect the electrodes 14a and 14b and base pins 16a and 16b.

The tubular fluorescent lamp 200 of the second embodiment is further composed of an inorganic binder film (glass film, inorganic binder film) 40 that differ from the first embodiment.

The inorganic binder film 40 is disposed between the fluorescent fibers 20 and 22 and the glass tube 10, so that the fluorescent fibers 20 and 22 are fixed on the inner surface of the 10b of the glass tube 10 at fixed ends 22a of the fluorescent fibers 20 and 22 through the inorganic binder film 40.

As material of the inorganic binder film 40, a conventional low melting point glass may be used, in which chemical compositions of the low melting point glass may be, for example, a PbO system glass that contains PbO—B₂O₃, PbO—B₂O₃—SiO₂, PbO—B₂O₃—ZnO, PbO—B₂O —ZnO—SiO₂ or PbO—SiO₂ as main components.

As shown in FIG. 10, each of the fluorescent fibers 22 may be composed of a transparent or light conducting core 22c having a length, a fixed end 22a and a free end 22b and plural phosphor particles or fluorescent agents 30 dispersed therein.

The fluorescent fibers 22 are fixed at each fixed end 22 thereof onto an exposed surface of the glass binder film 40 that is formed on the inner surface (inner wall) 10a of the glass tube (envelope or substrate) 10.

As shown in FIG. 9, at the time of lighting, the filament electrodes 14a and 14b are heated by feeding an electric current so as to emit thermal electrons (thermo-electrons, hot electrons) within the glass tube (envelope) 10.

At this time, AC voltage is applied between the electrodes 14a and 14b so that the thermal electrons move alternately therebetween to initiate discharge.

The electrons to move between the electrodes 14a and 14b strike the discharge gas 12 and Hg atoms and to generate vacuum ultraviolet rays “V-UV” having peak wavelength 254 nm and 185 nm.

The fluorescent fibers 22 emit visible light upon excitation of the vacuum ultraviolet rays “V-UV” to exit from the glass tube 10.

As the particulate phosphor (phosphor particles) 30, the three wavelength range phosphors, the three wavelength range fluorescent glass or the white color emitting phosphors may be used described above.

### THIRD EMBODIMENT

Referring to FIG. 9 and FIG. 11, a third embodiment of the present invention is described hereinafter, in which the third embodiment is a modification of the second embodiment. FIG. 11 is a partial enlarged cross sectional view of a portion surrounded by a circle “PB” of FIG. 9.

In the description of the third embodiment, the description common with the embodiments mentioned above may be omitted for simplifying an explanation.

As fluorescent fibers 20 used for the third embodiment, the similar fluorescent fiber 22 used in the second embodiment may be used that is composed of a single core structure having an optical core to contain phosphor particles 30d dispersed therein, a fixed end 22a and a free end 22b.

As shown in FIG. 9 and FIG. 11, a plurality of the fluorescent fibers 22 may be fixed on an exposed surface of a fluorescent glass film 40 composed of a low melting point glass film to contain plural phosphor particles 30e dispersed therein, in which the fluorescent glass film 40 is formed on an outer surface 10b of the glass tube (envelope, substrate) 10.

As the phosphor particles 30e, three wavelength range emitting phosphors mixed together or white color light emitting phosphors may be contained within the fluorescent glass film 40 so as to exit white visible light through the glass tube 10.

### FORTH EMBODIMENT

Referring to FIG. 9 and FIG. 12, a fourth embodiment of the present invention is described hereinafter, in which the fourth embodiment is a modification of the third embodiment. FIG. 12 is a partial enlarged cross sectional view of a portion surrounded by a circle “PB” of FIG. 9.

In the description of the fourth embodiment, the description common with the embodiments mentioned above may be omitted for simplifying an explanation.

As shown in FIG. 12 (and FIG. 5), each of plural fluorescent fibers 21 used for the fourth embodiment may be composed of a core-clad structured fluorescent fiber having a transparent glass core 21c to exclude any phosphor materials and a fluorescent clad 21d entirely or partially covered on a side surface of the core 21c, a fixed end 21a and a free end 21b, in which the fluorescent clad 21d may be composed of a transparent glass film 21d to contain phosphor particles 30 dispersed therein.

Further, each of the fluorescent fibers 21 may have a fluorescent film shown in FIG. 12 similar to the fluorescent clad 21d on the free end 21b.

The fluorescent fibers 21 may be fixed and installed to stand together on an exposed surface of a glass film 40 composed of a low melting point glass film, in which the glass film 40 is formed on an outer surface 10b of the glass tube (envelope, substrate) 10.

### FIFTH EMBODIMENT

Referring to FIG. 13 (and FIG. 9), a fifth embodiment of the present invention is described hereinafter, in which the fifth embodiment is a modification of the fourth embodiment.

FIG. 13 is a partial enlarged cross sectional view of a portion surrounded by a circle “PB” of FIG. 9.

In the description of the fifth embodiment, the description common with the embodiments mentioned above may be omitted for simplifying an explanation.

As shown in FIG. 13 (and FIG. 5), each of plural fluorescent fibers 21 used for the fifth embodiment may be composed of a core-clad structured fluorescent fiber having a transparent glass core 21c to exclude any phosphor materials and a fluorescent clad 21d entirely or partially covered on a side surface of the core 21c, a fixed end 21a and a free end 21b.

The fluorescent clad 21d may be composed of a transparent glass film 21d to contain phosphor particles 30 dispersed therein.

Further, each of the fluorescent fibers 21 may have a fluorescent film shown in FIG. 12 similar to the fluorescent clad 21d on the free end 21b.

In the fifth embodiment, the plural fluorescent fibers 21 are fixed on an inner surface 10b of a glass tube (envelope, substrate) 10 through a fluorescent film 40 that are interposed between the inner surface 10b and the plural fluorescent fibers 21 (the fixed end 21a).

The fluorescent film 40 formed on the inner surface 10b of the glass tube 10 may be composed of a glass film to contain plural phosphor particles 30f dispersed therein, in which the glass film may be composed of low melting point glass to act as a binder to connect the fixed end 21a of the fluorescent fibers 21 and the fluorescent film 40.

### SIXTH EMBODIMENT

Referring to FIG. 14 (and FIG. 9), a sixth embodiment of the present invention is described hereinafter, in which the sixth embodiment is a modification of the fifth embodiment. FIG. 14 is a partial enlarged cross sectional view of a portion surrounded by a circle “PB” of FIG. 9.

In the description of the sixth embodiment, the description common with the embodiments mentioned above may be omitted for simplifying an explanation.

As shown in FIG. 14 (and FIG. 5), each of plural fluorescent fibers 21 used for the sixth embodiment may be composed of a core-clad structured fluorescent fiber having a transparent glass core 21c to exclude any phosphor materials and a fluorescent clad 21d entirely or partially covered on a side surface of the core 21c, a fixed end 21a and a free end 21b.

The fluorescent clad 21d may be composed of a transparent glass film 21d to contain phosphor particles 30 dispersed therein.

Further, each of the fluorescent fibers 21 may have a fluorescent film shown in FIG. 12 similar to the fluorescent clad 21d on the free end 21b.

In the fifth embodiment, the plural fluorescent fibers 21 are fixed on an inner surface 10b of a glass tube (envelope, substrate) 10 through a transparent glass film 40 that are interposed between the inner surface 10b and the plural fluorescent fibers 21 (the fixed end 21a).

The fluorescent fibers 21 may be fixed and installed to stand together on an exposed surface of a glass film 40 composed of a low melting point glass film, in which the glass film 40 is formed on an outer surface 10b of the glass tube (envelope, substrate) 10.

As shown in FIG. 14, in the sixth embodiment, the fluorescent fibers 21 may be formed on the glass tube 10 via the glass film 40, in which a method of forming the fluorescent fibers 21 may comprise the steps of: a first stet of preparing a plurality of optical fibers 21c, each having a single core structure and a length of predetermined average size and preparing a glass tube (envelope) 10 having a transparent glass film disposed on an inner surface thereof; a second step of fixing the optical fibers 21c to stand together onto the transparent glass film; a third step of applying a mixture to contain phosphor particles and a low melting point glass particles onto the optical fibers 21c; and a fourth step of heating the mixture more than a melting point of the glass particles, thereby after cooling fluorescent clad 21d is formed on surfaces of the optical fibers 21c.

In this way, it is noted that the fluorescent fibers 21 may be formed on the glass tube 10 via the glass film 40, at the same time, a fluorescent film 42 may be formed on the glass film 40 and fluorescent films are formed on the free ends 21b of the fluorescent fibers 21.

Since the fluorescent lamp of the sixth embodiment has enhanced total areas composed of the fluorescent clad 21b on side surfaces and free ends of the cores 21c and the fluorescent film 40, the fluorescent lamp can emit visible light having high brightness or luminance.

In the sixth embodiment, the glass film 40 may be omitted as shown in FIG. 1 and FIG. 2 and in this case the optical fibers (cores) 21c with the single core structure are directly fixed on the glass tube (envelope) 10 by melting the optical cores 21c and/or the glass tube (envelope) 10.

Then, the fluorescent clads 21d, the fluorescent film 42 and the fluorescent film on the free end 21b are formed on the fluorescent core 21c, on the glass tube 10 and on the free end 21b simultaneously as explained above.

The fluorescent lamps 100 and 200 as shown in e.g. FIG. 1 and FIG. 2 are hot cathode fluorescent lamps having the filaments 14a and 14b as electron emitting electrodes.

However, it is matter of course that the present invention can be applied to cold cathode fluorescent lamps having the cold cathodes as well, as shown in FIG. 15 through FIG. 17.

### SEVENTH ENBODIMENT

Referring to FIG. 15, a seventh embodiment of the present invention is described. FIG. 15 is a schematic cross sectional view showing a cold cathode fluorescent lamp 300 according to the seventh embodiment.

In FIG. 15, a cold cathode type straight tubular fluorescent lamp (discharge fluorescent apparatus) 300 is briefly composed of a straight tubular glass tube (envelope) 10, a discharge-able gas sealed in a discharge space 12 of the glass tube 10, electrodes 19a and 19b positioned at inner ends of the glass tube 10 and a plurality of fluorescent fibers 20 fixed on an inner surface of the glass tube 10.

The discharge-able gas is composed of an inert gas such as Argon (Ar), Xenon (Xe), Helium (He), Neon (Ne), or a mixture thereof and a small amount of mercury (Hg).

Each of the electrodes 19a and 19b may be composed of cold cathode having a hollow cylindrical metallic cap or sleeve and an electron emission material disposed therein.

The tubular fluorescent lamp 300 is further composed of lead wires or lead pins 18a and 18b that are positioned near ends of the glass tube (glass tube) 10, each one end of the lead wires or lead pins 18a and 18b is connected with the cold cathode type electrodes 19a and 19b within the glass tube 10 and each another end of the lead wires or lead pins 18a and 18b is extended outside therefrom so as to connect to an electric power supply.

The fluorescent fibers 20 used in the seventh embodiment may be composed of the core-clad composite type fluorescent fibers 21, 23 or 24 as shown in such as FIG. 5A, FIG. 7, FIG. 8, or the single core structure type fluorescent fibers 22 as shown in such as FIG. 6A, FIG. 10, FIG. 11.

When a comparatively high voltage is applied between the opposed electrodes 19a and 19b, electrons are emitted from the electrodes 19a and 19b within the glass tube 10 to initiate a discharge, so that the electrons to move between the electrodes 19a and 19b strike the discharge gas 12 and Hg atoms to generate vacuum ultraviolet rays “V-UV” having peak wavelength 254 nm and 185 nm.

The fluorescent fibers 20 emit visible light upon excitation of the vacuum ultraviolet rays “V-UV” to exit from the glass tube 10.

### EIGHTH EMBODIMENT

Referring to FIG. 16, an eighth embodiment of the present invention is described.

FIG. 16 is a schematic cross sectional view showing a dual tube fluorescent lamp 400 with cold cathodes according to the eight embodiment.

In FIG. 16, a dual tube fluorescent lamp (discharge fluorescent apparatus) 400 may be briefly composed of an outer straight glass tube 10-1 having a soda glass with visible light permeability, an inner straight glass tube 10-2 having a silica glass with “V-UV” and visible light permeability disposed in an interior of the outer glass tube 10-1 with a gap between the outer and the inner glass tubes 10-1 and 10-2, discharge-able gas sealed in a discharge space 12 of the inner straight glass tube 10-2, cold cathode type opposed electrodes 19a and 19b and a plurality of first and second fluorescent fibers 20-1 and 20-2 disposed substantially on an outer and an inner surfaces of the inner glass tube 10-2.

The first fluorescent fibers 20-1 may be fixed on a first glass film 40-1 disposed on an outer surface of the inner glass tube 10-2 and the second fluorescent fibers 20-2 may be fixed on a second glass film 40-2 disposed on an inner surface of the inner glass tube 10-2, so that the first and the second fluorescent fibers 20-1 and 20-2 are fixed respectively on the first and the second glass films 40-1 and 40-2 at each fixed end of the fluorescent fibers 20-1 and 20-2 so as to stand together.

The discharge-able gas is composed of inert gas such as Argon (Ar), Xenon (Xe), Helium (He), Neon (Ne), or a mixture thereof and a small amount of mercury (Hg).

Each of the cold cathode type opposed electrodes 19a and 19b may be composed of cold cathode having a hollow cylindrical metallic cap or sleeve and an electron emission material disposed therein, in which the opposed electrodes 19a and 19b are positioned near opposite ends of the inner glass tube 10-2. Dual lead wires or lead pins 18a and 18b extend from the electrodes 19a within the inner glass tube 10-2 to outside of the inner glass tube 10-2 for connecting with a power supply.

When a comparatively high voltage is applied between the opposed electrodes 19a and 19b, electrons are emitted from the electrodes 19a and 19b within the inner glass tube 10-2 to initiate a discharge, so that the electrons to move between the electrodes 19a and 19b strike the discharge gas 12 and Hg atoms to generate vacuum ultraviolet rays “V-UV” having peak wavelength 254 nm and 185 nm.

The vacuum ultraviolet rays “V-UV” generated from the discharge-able gas within the inner glass tube 10-2 radiate the second fluorescent fibers 20-2 on the inner surface of the inner glass tube 10-2 and the vacuum ultraviolet rays “V-UV” also radiate the first fluorescent fibers 20-1 on the outer surface of the inner glass tube 10-2 through the inner glass tube 10-2 with “V-UV” permeability.

Therefore, the first and the second fluorescent fibers 20-1 and 20-2 emit visible light upon excitation of the vacuum ultraviolet rays “V-UV” and the visible light exits from the outer glass tube 10-1.

In the eighth embodiment, the glass films 40-1 and/or 40-2 may be removed in such a manner that the fluorescent fibers 20-1 and 20-2 may be directly fixed on the inner and/or outer surfaces of the inner tube 10-2 by melting of the fluorescent fibers 20-1 and 20-2 and/or the inner tube 10-2 when manufactured.

In the eighth embodiment, the gap between the outer glass tube 10-1 and the inner glass tube 10-2 may be filled with inner gas having thermal conductivity higher or lower than that of air or the inert gas 12 within the inner glass tube 10-2.

As the glass tube 20-2 having ultraviolet and visible light permeability, transparent silica glass tubes may be preferably used, in which the transparent silica glass tubes for fluorescent lamp use are commercially available, for example, from Shin-Etsu Quartz Products Co., Ltd., Japan such as SUP-F300 (product number of that company) and SUP-F310 (product number of that company).

### NINTH EMBODIMENT

Referring to FIG. 17, a ninth embodiment of the present invention is described hereinafter.

FIG. 17 is a schematic cross sectional view showing a dual tube fluorescent lamp 500 according to the ninth embodiment.

The ninth embodiment of the present invention is a modification of the eighth embodiment of the present invention as mentioned above.

In FIG. 17 a dual tube fluorescent lamp (discharge fluorescent apparatus) 500 may be briefly composed of an outer straight glass tube 10-1 having a soda glass with visible light permeability, an inner straight glass tube 10-2 having a silica glass with “V-UV” and visible light permeability disposed in an interior of the outer glass tube 10-1 with a gap between the outer and the inner glass tubes 10-1 and 10-2, discharge-able gas sealed in a discharge space 12 of the inner straight glass tube 10-2, cold cathode type opposed electrodes 19a and 19b and a plurality of first and second fluorescent fibers 20-1 and 20-2 disposed substantially on the outer glass tube 10-1 and the inner glass tube 10-2.

The discharge-able gas is composed of inert gas such as Argon (Ar), Xenon (Xe), Helium (He), Neon (Ne), or a mixture thereof and a small amount of mercury (Hg).

The first fluorescent fibers 20-1 may be fixed on a first glass film 40-1 disposed on an inner surface of the outer glass tube 10-1 and the second fluorescent fibers 20-2 may be fixed on a second glass film 40-2 disposed on an inner surface of the inner glass tube 10-2, so that the first and the second fluorescent fibers 20-1 and 20-2 are fixed respectively on the first and the second glass films 40-1 and 40-2 at each fixed end of the fluorescent fibers 20-1 and 20-2 so as to stand together.

Each of the cold cathode type opposed electrodes 19a and 19b may be composed of cold cathode having a hollow cylindrical metallic cap or sleeve and an electron emission material disposed therein, in which the opposed electrodes 19a and 19b are positioned near opposite ends of the inner glass tube 10-2.

Dual lead wires or lead pins 18a and 18b extend from the electrodes 19a within the inner glass tube 10-2 to outside of the inner glass tube 10-2 for connecting with a power supply.

When a comparatively high voltage is applied between the opposed electrodes 19a and 19b, electrons are emitted from the electrodes 19a and 19b within the inner glass tube 10-2 to initiate a discharge, so that the electrons to move between the electrodes 19a and 19b strike the discharge gas 12 and Hg atoms to generate vacuum ultraviolet rays “V-UV” having peak wavelength 254 nm and 185 nm.

The vacuum ultraviolet rays “V-UV” generated from the discharge-able gas within the inner glass tube 10-2 radiate the second fluorescent fibers 20-2 on the inner surface of the inner glass tube 10-2 and the vacuum ultraviolet rays “V-UV” also radiate the first fluorescent fibers 20-1 on the inner surface of the outer glass tube 10-1 through the inner glass tube 10-2 with “V-UV” permeability.

Therefore, the first and the second fluorescent fibers 20-1 and 20-2 emit visible light upon excitation of the vacuum ultraviolet rays “V-UV” and the visible light exits from the outer glass tube 10-1.

In the ninth embodiment, the glass films 40-1 and/or 40-2 may be removed in such a manner that the fluorescent fibers 20-1 and 20-2 may be directly fixed on the inner and/or outer surfaces of the inner tube 10-2 by melting of the fluorescent fibers 20-1 and 20-2 and/or the inner tube 10-2 when manufactured.

In the ninth embodiment, the gap between the outer glass tube 10-1 and the inner glass tube 10-2 may be filled with inner gas having thermal conductivity higher or lower than that of air or the inert gas 12 within the inner glass tube 10-2.

### TENTH EMBODIMENT

Referring to FIG. 18, a tenth embodiment of the present invention is described hereinafter.

FIG. 18 is a schematic exploded perspective view showing a flat fluorescent lamp 600 according to the tenth embodiment.

In FIG. 18, a flat fluorescent lamp (discharge fluorescent apparatus) 600 may be briefly composed of a substantially rectangular and substantially flat front glass plate 10-3, a substantially rectangular and substantially flat rear glass plate 10-4 disposed to oppose to each other, having a substantially rectangular discharge space 12 therebetween, dual electrodes 14-1 and 14-2 opposed to each other and a plurality of fluorescent fibers 20 disposed on an inner surface of the front glass plate 10-3.

Other fluorescent fibers (not shown in FIG. 18) similar to the fluorescent fibers 20 may be additionally disposed on an inner surface of the rear glass plate 10-4.

In addition to the fluorescent fibers 20, conventional fluorescent film/films to contain phosphor material therein may be disposed on the inner surface/surfaces of the front and/or rear glass plates 10-3 and 10-4.

The front glass plate 10-3 has visible light permeability, while the rear glass plate 10-4 may have visible light permeability or visible light reflectivity.

A substantially rectangular flame-like or ring-like sealing member 50 such as sealing glass may be disposed between the front glass plate 10-3 and the rear glass plate 10-4 with the space 12 therebetween, so that the front glass plate 10-3, the rear glass plate 10-4 and the sealing member 50 constitute an envelope to contain inert gas in the space 12 surrounded in air-tight state by the glass plates 10-3 and 10-4 and the sealing member 50.

The electrodes 14-1 and 14-2 may be thermal or hot cathodes or cold cathodes and electrically conductive lead pins 16-1 and 16-2 are connected to the electrodes 14-1 and 14-2 at each one end of the lead pins 16-1 and 16-2 within the space 12 and the lead pins 16-1 and 16-2 extend to outside from the envelope for connecting an electric power supply.

When a comparatively high voltage is applied between the opposed electrodes 14a and 14b through the lead pins 16-1 and 16-2, electrons are emitted from the electrodes 14a and 14b within the gas space 12 to initiate a discharge, so that the electrons to move between the electrodes 14a and 14b strike the discharge-able gas in the discharge space 12 and Hg atoms to generate vacuum ultraviolet rays “V-UV” having peak wavelength 254 nm and 185 nm.

The vacuum ultraviolet rays “V-UV” generated from the discharge-able gas radiate the fluorescent fibers 20 on the inner surface of the front glass plate 10-3 and/or the rear glass plate 10-4.

Therefore, the fluorescent fibers 20 emit visible light upon excitation of the vacuum ultraviolet rays “V-UV” and the visible light exits from the front glass plate 10-3 and/or the rear glass plate 10-4.

The flat fluorescent lamps 600 according to the tenth embodiment of the present invention are suitably used for such as flat lighting sources, flat illuminators and lighting (backlight or front light) of non-emissive displays typically liquid crystal displays (LCDs).

### ELEVENTH EMBODIMENT

Referring to FIG. 19 and FIG. 20, an eleventh embodiment of the present invention is described hereinafter.

FIG. 19 is a schematic top view showing a flat fluorescent lamp 700 according to the eleventh embodiment. FIG. 20 is a schematic enlarged cross sectional view taken along the line X-X of FIG. 19.

The flat fluorescent lamp 700 of the eleventh embodiment is a modification of the flat fluorescent lamp 600 of the tenth embodiment.

In FIG. 19 and FIG. 20, a flat fluorescent lamp (discharge fluorescent apparatus) 700 may be briefly composed of a substantially rectangular and substantially flat front glass plate 10-3, a substantially rectangular and substantially flat rear glass plate 10-3 disposed to oppose to each other, having a substantially rectangular discharge space 12 therebetween, dual electrodes 14a or 19a opposed to each other and a plurality of fluorescent fibers 20 disposed on an inner surface of the front glass plate 10-3.

Sealing members (sealants) 52a and 52b such as glass may be partially disposed between the front glass plate 10-3 and the rear glass plate 10-4.

The sealing member 52a having a predetermined thickness seals a peripheral portion of the first and second glass plates 10-3 and 10-4 at the inner surfaces thereof in a substantially rectangular flame-like or ring-like manner and also the sealing member 52b forms a continuously elongated partition (partition wall) having comb-like, inter-digital, zigzag shape between the glass plates 10-3 and 10-4 so that a continuously elongated gas passageway (gas space) 12 having a meandering or zigzag channel is produced.

Electrodes (14a or 19a) and (14b or 19b) opposed to each other are disposed at opposed ends of the elongated gas passageway 12, in which the electrodes (14a or 19a) and (14b or 19b) may be cold cathodes or thermal cathodes.

Lead pins (16a or 18a) and (16b or 18b) are connected to the electrodes (14a or 19a) and (14b or 19b) at each one end of the lead pins (16a or 18a) and (16b or 18b), and the lead pins (16a or 18a) and (16b or 18b) are exposed to outside at each another end thereof for connecting to a power supply.

In FIG. 20, the fluorescent fibers 20 disposed on an inner surface of the front glass plate 10-3, however other fluorescent fibers (not shown in FIG. 20) similar to the fluorescent fibers 20 may be additionally disposed on an inner surface of the rear glass plate 10-4.

Further, conventional fluorescent film/films (not shown in FIG. 20) may be disposed on the inner surface/surfaces of the front and/or rear glass plates 10-3 and/or 10-4 in addition to the fluorescent fibers 20 and the fluorescent fibers on the rear glass plate 10-4.

Moreover, glass film/films (not shown in FIG. 20) preferably composed of low melting point glass to exclude or include phosphor material may be disposed on the inner surface/surfaces of the front and/or rear glass plates 10-3 and/or 10-4.

When a comparatively high voltage is applied between the opposed electrodes (14a or 19a) and (14b or 19b) through the lead pins (16a or 18a) and (16b or 18b), electrons are emitted from the electrodes (14a or 19a) and (14b or 19b) within the elongated gas passageway 12 to initiate a discharge, so that the electrons to move between the electrodes (14a or 19a) and (14b or 19b) strike the discharge-able gas in the elongated gas passageway (discharge space) 12 and Hg atoms to generate vacuum ultraviolet rays “V-UV” having peak wavelength 254 nm and 185 nm.

The vacuum ultraviolet rays “V-UV” generated from the discharge-able gas radiate the fluorescent fibers 20 on the inner surface of the front glass plate 10-3 and/or the rear glass plate 10-4.

Therefore, the fluorescent fibers 20 emit visible light upon excitation of the vacuum ultraviolet rays “V-UV” and the visible light exits from the front glass plate 10-3 and/or the rear glass plate 10-4.

The flat fluorescent lamps 700 according to the eleventh embodiment of the present invention are suitably used for such as flat lighting sources, flat illuminators and lighting (backlight or front light) of non-emissive displays typically liquid crystal displays (LCDs).

### TWELFTH EMBODIMENT

Referring to FIG. 21, a twelfth embodiment of the present invention is described below.

FIG. 21 is a schematic cross sectional view showing a cold cathode dual tubes fluorescent lamp according to the twelfth embodiment.

This twelfth embodiment is a modification of the ninth and tenth embodiments described above referring to FIG. 16 and FIG. 17.

As shown in FIG. 21, a dual tube fluorescent lamp (discharge fluorescent apparatus) 900 may be briefly composed of an outer straight glass tube 10-1 having a soda glass with visible light permeability, an inner straight glass tube 10-2 having a silica glass with “V-UV” and visible light permeability disposed in an interior of the outer glass tube 10-1 with a gap between the outer and the inner glass tubes 10-1 and 10-2, discharge-able gas sealed in a discharge space 12 of the inner straight glass tube 10-2, cold cathode type opposed electrodes 19a and 19b and a plurality of first, second and third fluorescent fibers 20′-1, 20′-2 and 20′-3.

The first fluorescent fibers 20′-1 may be disposed substantially on an inner surface of the outer glass tube 10-1, the second fluorescent fibers 20′-2 are disposed substantially on an outer surface of the inner glass tube 10-2 and the third fluorescent fibers 20′-3 are disposed substantially on an inner surface of the inner glass tube 10-2.

Further, the first fluorescent fibers 20′-1 may be fixed on a first glass film 40a coated on the outer glass tube 10-1, the second fluorescent fibers 20′-2 may be fixed on a second glass film 40b coated on the inner glass tube 10-2 and the third fluorescent fibers 20′-3 may be fixed on a third glass film 40c coated on the inner glass tube 10-2.

The first, second and glass films 40a, 40b and 40c may be composed of low melting point glass to act as a binder of the fluorescent fibers 20′-1, 20′-2 and 20′-3.

The first, second and glass films 40a, 40b and 40c may contain a fluorescent or phosphor material disposed therein.

The first, second and glass films 40a, 40b and 40c may be disposed partially on the surfaces 40a, 40b and 40c on the glass tubes 10-1 and 10-2 in an island manner so as to isolate together

In this twelfth embodiment, different from the seven and the eighth embodiments, the inner glass tube 10-2 may be provided with a plurality of through-holes 60 having plural gas ways from a first gas space 12a to a second gas space 12b between the inner tube 10-2 and the outer tube 10-2 for allowing gas to pass through.

Within the first and second spaces 12a and 12b, such discharge-able gas may be contains an inert gas e.g. Argon (Ar), Xenon (Xe), Helium (He), Neon (Ne) or a mixture thereof and a small amount of mercury (Hg).

Each of the electrodes 19a and 19b may be composed of cold cathode having a hollow cylindrical metallic cap or sleeve and an electron emission material disposed therein.

Lead wires or lead pins 18a and 18b may be positioned near ends of the glass tubes (glass tube s) 10-1 and 10-2, each one end of the lead wires or lead pins 18a and 18b is connected with the cold cathode type electrodes 19a and 19b within the glass tube 10-1 and 10-2 and each another end of the lead wires or lead pins 18a and 18b is extended outside therefrom so as to connect to an electric power supply.

When a comparatively high voltage is applied between the opposed electrodes 19a and 19b, electrons are emitted from the electrodes 19a and 19b within the inner glass tube 10-2 to initiate a discharge, so that the electrons to move between the electrodes 19a and 19b strike the discharge gas within the first and second gas space 12a and 12b and Hg atoms to generate vacuum ultraviolet rays “V-UV” having peak wavelength 254 nm and 185 nm.

The vacuum ultraviolet rays “V-UV” generated from the discharge-able gas within the first and second discharge spaces 12a and 12b radiate the first and second fluorescent fibers 20′-1 and 20′-2 existing in the first gas space 12a and the vacuum ultraviolet rays “V-UV” also radiate the third fluorescent fibers 20′-3 existing in the second gas space 12b through the inner glass tube 10-2 with “V-UV” permeability and/or through the through-holes 60 of the inner glass tube 10-2.

Therefore, the first, second and third fluorescent fibers 20′-1, 20′-2 and 20′-3 emit visible light upon excitation of the vacuum ultraviolet rays “V-UV” and the visible light exits from the outer glass tube 10-1.

In the twelfth embodiment, the glass films 40a, 40b and/or 40c may be removed in such a manner that the fluorescent fibers 20′-1, 20′-2 and 20′-3 may be directly fixed on the inner and/or outer surfaces of the inner and/or outer tubes 10-2 and/or 10-1 by melting of the fluorescent fibers 20-1 and 20-2 and/or the inner and/or outer tubes 10-2 and/or 10-1 when manufactured.

In the twelfth embodiment, since the fluorescent lamp 800 is provided with the dual gas spaces 12a and 12b to contain discharge-able gas therein to emit “V-UV”, conventional economical glass tubes e.g. soda glass tubes having high visible light transparency and low UV transparency may be used as the inner and outer glass tubes 10-1 and 10-2.

### THIRTEENTH EMBODIMENT

Referring to FIG. 22 and FIG. 23, a thirteenth embodiment of the present invention is described below.

The thirteenth embodiment is an example of some types of plasma display panels, in which a surface discharge type AC activated Plasma Display Panel (PDP) having three electrodes is described as an example of PDPs.

However, the present invention is not limited thereto and the present invention is applicable to other types of PDPs, such as other AC activated or DC activated PDPs.

FIG. 22 is a schematic exploded perspective view showing the surface discharge AC activated plasma display panel.

FIG. 23 is a schematic partial enlarged cross sectional view along the line XIII-XXIII (the line 23-23) of FIG. 22.

As shown in FIG. 22 and FIG. 23, a surface discharge type AC activated Plasma Display Panel (PDP) 900 may be composed of a substantially rectangular front substrate 10-3 having visible light transparency, a substantially rectangular rear substrate 10-4, in which the front and second substrate 10-3 and 10-4 may be made of glass plate.

A plurality of barrier walls (partition walls, barrier ribs, separators) 53 may be formed on the rear substrate 10-4, the barrier walls 53 each may have a substantially trapezoidal shape in cross section and a linear or stripe pattern and the barrier walls 53 may be arranged in parallel to one anther so as to define a plurality of discharge cells 12 having linear or stripe patterns.

Further, a plurality of address electrodes (data electrodes) 54 having stripe patterns may be formed on the rear substrate 10-4, in which the address electrodes 54 are arranged in parallel along each of the discharge cells 12 having a linear or stripe pattern and between the adjacent dual barrier walls 53.

The address electrodes 54 may be formed on the rear substrate 10-4 in such a manner that electrically conductive paste to include highly conductive metal powders such as Ag, Cu and/or Ni may be selectively coated by e.g. a screen printing process in a stripe pattern on the rear substrate 10-4, then, the conductive paste having stripe patterns coated on the rear substrate 10-4 are fired or sintered to fix permanently thereon.

As shown in FIG. 23, in the discharge cells 12, a first fluorescent or phosphor film 53a may desirably be formed on the address electrodes 54 and/or a second fluorescent or phosphor film 53b may desirably be formed on the barrier walls 53.

The first and second fluorescent or phosphor films 53a and 53b may be composed of phosphor sintered films or phosphor contained glass films having a glass binder and plural phosphor particles contained therein.

As shown in FIG. 23, in the discharge cells 12, a plurality of first fluorescent fibers 20′ may be disposed substantially on the address electrodes 54, in which the first fluorescent fibers 20′ may be fixed directly on the address electrodes 54 or indirectly through the phosphor films 58a thereon so as to stand together.

Further, in the discharge cells 12, a plurality of second fluorescent fibers 20″ may be disposed substantially on inner surfaces of the rear substrate 10-4 in areas where the address electrodes 54 is not formed, in which the second fluorescent fibers 20″ may be fixed directly on the rear substrate 10-4 or indirectly through the phosphor films 58b thereon so as to stand together.

Moreover, in the discharge cells 12, a plurality of third fluorescent fibers 20′″ may be disposed substantially on the barrier walls 53, in which the third fluorescent fibers 20′″ may be fixed directly on the barrier walls 53 or indirectly through the phosphor films 58b thereon so as to stand together. Dec. 27, 2004

Indication electrodes (display electrodes) each may be composed of a pair of a scanning electrode 56 and a sustain electrode 57.

The scanning electrodes 56 and the sustain electrodes 57 may be arranged alternately and parallel to one another on the front substrate 10-3 to extend to a direction that is perpendicular to the address electrodes 54.

The scanning electrodes 56 and the sustain electrodes 57 may be substantially transparent electrically conductive films having linear or stripe patterns.

The scanning electrodes 56 and the sustain electrodes 57 having the stripe patterns may be formed on the front substrate 10-3 by following methods.

One method may be composed of the steps of: preparing a substantially transparent conductive material such as SnO2 to include Indium as additive or ITO (Indium Tin Oxide); forming the conductive material entirely on the front substrate 10-3 by evaporating or sputtering the conductive material onto the front substrate 10-3 to obtain a substantially transparent conductive film; and patterning the conductive film by a photo-lithography process, thereby the conductive film has parallel stripe patterns isolated to one another to keep a predetermined distance.

Another method may be composed of the steps of: preparing the substantially transparent conductive material (e.g. the ITO) and a mask pattern having openings with parallel stripe patterns; and forming substantially transparent conductive films selectively on the front substrate 10-3 by evaporating or sputtering the conductive material onto the front substrate 10-3 through the mask pattern, thereby the conductive film has parallel stripe patterns isolated to one another to keep a predetermined distance.

A substantially transparent dielectric film 55 may be formed on the front substrate 10-3 to cover the scanning electrodes 56 and the sustain electrodes 57.

The scanning electrodes 56 and the sustain electrodes 57 may act as a surface discharge holding means to hold a surface discharge that is an electric discharge of a surface direction of the transparent dielectric film 55.

It is desirable to form a transparent protection layer (not shown in FIG. 22 and FIG. 23) entirely on the transparent dielectric layer 55.

As shown in FIG. 22, fluorescent optical fibers 20(B) including a blue phosphor material, fluorescent optical fibers 20(G) including a green phosphor material and fluorescent optical fibers 20(R) including a red phosphor material may be disposed alternately on the discharge cells 12 separated by the barrier walls 53.

The barrier walls 53 having stripe patterns may be disposed on the rear substrate 10-4 to extend parallel to one another to a direction perpendicular to a lengthwise direction of the scanning electrodes 56 and the sustain electrodes 57 so as to sandwich the address electrodes 20, 20(G), 20(Y) and 20(R).

The barrier walls 53 prevents each of the discharge cells 12 to emit each of three colors from color mixture, in which each of the fluorescent fibers 20(B), 20(B) and 20(B), emits each of three colors Blue, Green and Red in each of the discharge cells 12.

Further, the barrier walls 53 act as to keep a discharge gap between the front substrate 10-3 and the rear substrate 10-4.

Referring to FIG. 22 and FIG. 23, the front substrate 10-3 and the rear substrate 10-4 are sealed and bonded together through the barrier walls 53 in such a manner that the stripe-shaped indication electrode (the scanning electrode 56 and the sustain electrode 57) on the front substrate 10-3 faces the stripe-shaped address electrode 54 on the rear substrate 10-4, in which the address electrode 54 is perpendicular to the indication electrode 56 and 57.

The inner gas such as Helium (He)—Xenon (Xe) and Neon (Ne)—Xenon is sealed in the discharge space (discharge gas cell) 12 formed between the front substrate 10-3 and the rear substrate 10-4.

In the plasma display panel (PDP) 900, each of electrical lead wires (not shown in FIG. 22 and FIG. 23) leads out each one end of the address electrode 54 and the indication electrode 56 and 57.

When AC voltage is selectively applied to the electrical lead wires, a discharge generates selectively within the discharge gas cell 12 between the address electrode 54 and the indication electrode 56 and 57.

At this time, vacuum ultraviolet rays (V-UV) are radiated from the inert gas and the fluorescent fibers 20, 20(B), 20(G) and 20(R) within the discharge gas cell 12 emit visible light upon excitation of the V-UV, so that the visible light exits from the transparent front substrate 10-3 to display visible information.

Further, as shown in FIG. 23, the phosphor films 58a, 58b and 58c within the discharge gas cell 12 emit visible light upon excitation of the V-UV.

Driving means for driving the PDP, for example, may be as follows.

A common electric potential is applied to the plural sustain electrodes 56 connected together in plural lines.

A first pulse voltage is applied to the sustain electrodes 56 independently every each line by a sustain electrode driving circuit to write in an electric charge at the every each line.

An image signal pulse voltage (second pulse voltage) is applied to the address electrode 54 by an address electrode driving circuit, in which the second pulse voltage is superimposed with the first pulse voltage to select an electric discharge or a non-electric discharge of each pixel

As a result, the V-UV is selectively radiated by a plasma electric discharge to occur in the discharge cell 12 corresponding to a cross point with the address electrode 54 so that the V-UV excites one kind of the fluorescent fibers 20(B), 20(G) and 20(R) and phosphor films 58a, 58b and 58c and one visible color light selected from three colors (Blue, Green and Red) is emitted therefrom.

### FOURTEENTH EMBODIMENT

A fourteenth embodiment shows a method and an apparatus for manufacturing the straight (linear) fluorescent lamp e.g. 100 and 200, by which the fluorescent fibers 20 are electrostatically disposed to be adhered and fixed on the glass tube 10.

The other straight fluorescent lamps 200, 300, 400, 500 and 800 may be manufactured in the same or similar manner, in which the fluorescent fibers 20-1, 20-2 and 20-3 are disposed on the glass tubes 10-1 and 10-2

Referring to FIG. 24, a method and an apparatus for disposing the fluorescent fibers 20 on the glass tube 10 according to a fourteenth embodiment is mentioned below

FIG. 24 is a schematic elevational view showing the method and the apparatus according to the fourteenth embodiment.

As shown in FIG. 24, an electro-conductive hollow metal cylinder 60 having an inside diameter more slightly than an outer diameter of a cylindrical glass tube 10 is prepared and the cylindrical glass tube 10 is inserted within the hollow metal pipe 60.

At this time, an electro-conductive fluid such as an electrolytic solution or an electro-conductive grease is desirably interposed in minute distance between an outer surface of the glass tube 10 and an inside of the hollow metal cylinder 60.

Heating means 61 such as an electric heater may be provided within or outside the hollow metal cylinder 60.

One end of the hollow metal pipe 62 may be provided with an electrostatic nozzle 63 and another end of the hollow metal pipe 62 may be connected with a supply device 64 to contain the fluorescent fibers 20 and to supply the fluorescent fibers 20 into the hollow metal pipe 62 through a flexible tube 65 to communicate the supply device 64 and the another end of the hollow metal pipe 62.

The hollow pipe 62 and the electrostatic spout nozzle 63 are inserted in a direction of an approximately central axis of the glass tube 10.

A pair of drive rollers 66 is disposed at the another end of the hollow pipe 62, the drive rollers 66 rotate reversibly depending on a reversible rotation of a driving motor 67 through a transmission means 68, so that the hollow pipe 62 and the electrostatic spout nozzle 63 move from side to side along an axial direction of the glass tube 10.

As the electrostatic spout nozzle 63, all around spout nozzle may be preferably used since the all around spout nozzle can spout out the fluorescent fibers 20 onto an inner surface of the glass tube all around.

A suction pipe 69 may be composed of a tape shaped hollow pipe having a horn like first end and a second end, in which the horn like first end is temporarily connected to the one end of the glass tube 10 in an air-tight state and the second end is connected to a suction device 70 such as an air suction fan and an air suction pump 70.

The air suction pump 70 may be used for giving a negative pressure in an interior of the glass tube 10 to feed the fluorescent fibers 20 into the glass tube 10 from the supply device 64 housed in the fluorescent fibers 20 through the hollow flexible tube 65 and the hollow pipe 62.

Further, a compressed air supply device (not shown in FIG. 64) may be preferably provided relative to the supply device 64 for feeding the fluorescent fibers 20 to the electrostatic spout nozzle 63.

The electrostatic spout nozzle 63 may be connected to one end of a first electro-conductive lead wire 72a and another end of a first electro-conductive lead wire 72a may be connected to a positive pole of a high voltage DC power supply 71, one end of a second electro-conductive lead wire 72b may be connected to a negative pole of the high voltage DC power supply 71 and a negative pole of the high voltage DC power supply 71 may be connected to the electro-conductive hollow cylinder 60 at another end of a second electro-conductive lead wire 72b.

Therefore, a high DC voltage is applied between the electrostatic spout nozzle 63 and the electro-conductive hollow cylinder 60.

The hollow pipe 62 with the electrostatic spout nozzle 63 is inserted into the glass tube 10 to the one end of the glass tube 10 and is moved to another end of the glass tube 10 at a predetermined speed by reversible rotation of the driving roller 66.

At this time, if the fluorescent fibers 20 within the supply device 64 is supplied to the electrostatic spout nozzle 63 through the hollow pipe 62, an electrostatic charge is given to the fluorescent fibers 20 by e.g. corona discharge in the electrostatic spout nozzle 63 having a high DC potential and the fluorescent fibers 20 with the electrostatic charge are subject to spout out from the he electrostatic spout nozzle 63 to the inner surface of the glass tube 10.

When the glass tube 10 is heated by the heating means 61 to rise a temperature of the glass tube 10, an electrical resistance of the glass tube 10 becomes low so that an electrical potential of the inner surface of the glass tube 10 approaches the electrical potential of the conductive metal cylinder 60.

The fluorescent fibers 20 are charged with e.g. positive charge by the electrostatic spout nozzle 63 with a high positive electric potential, since the high DC voltage is applied between the electrostatic spout nozzle 63 and the conductive metal cylinder 60 by the power supply 71.

And the fluorescent fibers 20 charged with e.g. positive charge are spouted from the electrostatic spout nozzle 63 toward the inner surface of the glass tube 10 with a negative electric potential so as to attach or adhere electrostatically onto the inner surface of the glass tube 10 so that the fluorescent fibers 20 are stand together and flocked densely on the inner surface of the glass tube 10.

Since plural fluorescent optical fiber 20 are charged with the same polarity, e.g. positive polarity, the fluorescent optical fibers 20 can be arranged on the inner surface of the glass tube 10 so as to stand together substantially vertically and/or substantially parallel without entangling to one another by an electrostatic repulsion between the fluorescent optical fibers 20.

When the conductive metal cylinder 60 is preliminarily heated by the heating means 61, the glass tube 10 and/or the fluorescent fibers 10 disposed on the glass tube 10 rise in that temperature.

If that temperature is raised over a softening temperature or a melting point of the glass tube 10 and/or the fluorescent fibers 10, the fluorescent fibers 10 are bonded by fusion at fixed ends thereof on the inner surface of the glass tube 10.

After cooling the fluorescent fibers 10 to a room temperature, the fluorescent optical fibers 20 can be fixed permanently on the inner surface of the glass tube 10 so as to stand together substantially vertically and/or substantially parallel without entangling to one another.

The fluorescent optical fibers 20 may be disposed on the glass tube 10 through a glass film 40 (refer to e.g. FIG. 10 and FIG. 12) or a fluorescent glass film 40 and (30e or 30f) (refer to e.g. FIG. 11 and FIG. 13) that is preliminarily disposed on the inner surface of the glass tube 10.

The glass film 40 may be composed of a transparent glass made from a low melting point transparent glass powder or frit having the melting point or a softening temperature less than that of the fluorescent optical fibers 20.

The fluorescent glass film 40 and (30e or 30f) may be composed of the transparent glass 40 mentioned above and plural phosphor particles 30e or 30f dispersed therein.

A glass paste may be used for forming the glass film 40, in which the glass paste is composed of inorganic liquid and the glass powder or frit to contain therein.

A fluorescent glass paste may be used for forming the fluorescent glass film 40 and (30e or 30f), in which the fluorescent glass paste is composed of inorganic liquid, the transparent glass powder or frit and phosphor particles to contain therein.

The glass film 40 or the fluorescent glass film 40 and (30e or 30f) may be formed on the inner surface of the glass tube 10 by heating the glass tube 10 to a temperature more than the melting point or the softening temperature of the glass powder or frit.

The fluorescent optical fibers 20 adhered electrostatically on the glass film 40 or the fluorescent glass film 40 and (30e or 30f) by the electrostatic process mentioned above may be permanently fixed on the glass film 40 or the 40 and (30e or 30f) at the fixed ends of the fluorescent optical fibers 20 by heating the glass film 40 or the fluorescent glass film 40 and (30e or 30f) to that softening temperature or the melting point.

If the glass paste or the fluorescent glass paste is used for forming the glass film 40 or the fluorescent glass film 40 and (30e or 30f) on the glass tube 10, the fluorescent fibers 20 may be adhered electrostatically on the inner surface of the glass tube 10, after the glass paste or the fluorescent glass paste is coated on the inner surface of the glass tube 10 to form a glass paste film or a fluorescent glass paste film thereon.

Then, the glass paste film or the fluorescent glass paste film is heated more than the melting point or the softening temperature of the glass contained therein so that the glass paste film or the fluorescent glass paste changes to the glass film 40 or the fluorescent glass film 40 and (30e or 30f) and at the same time, the fluorescent optical fibers 20 can be bonded thereon and after cooling to a room temperature the glass film 40 or the fluorescent glass film 40 and (30e or 30f) are permanently formed on the glass tube 10 and the fluorescent optical fibers 20 are permanently fixed on the glass film 40 or the fluorescent glass film 40 and (30e or 30f).

If the fluorescent fibers 20 are disposed electrostatically on the glass paste film or the fluorescent glass paste film before drying, the fluorescent fibers 20 can be tentatively adhered well so as to anchor therein at the fixed ends 20a thereof, because the glass paste film or the fluorescent glass paste film is still in a liquid state having viscosity as same as an uncured adhesive or glue in a liquid state before hardening.

Next, the glass paste film or the fluorescent glass paste film changes to the glass film or the fluorescent glass paste film when the glass paste film or the fluorescent glass paste film is heated to a fused temperature e.g. 300-600 degree C. of the glass powder or frit contained therein and after cooling the fluorescent fibers 20 are fixed permanently on the inner surface of the glass tube 10 through the glass film or the fluorescent glass paste film.

### FIFTEENTH EMBODIMENT

A fifteenth embodiment shows a method and an apparatus for manufacturing the flat (planer) fluorescent lamp (flat panel like fluorescent lamp) e.g. 600 and 700, by which the fluorescent fibers 20 are electrostatically disposed to be adhered and fixed on substrate/substrates.

In the fifteenth embodiment, the electrostatic flocking process is applied to adhere the fluorescent fibers 20 onto substrate/substrates of the flat (planer) fluorescent lamp e.g. 600 and 700 as shown in FIG. 18 to FIG. 20, in which the electrostatic flocking process itself is a known technology in a textile industry where short fibers or flocks for textile use are flocked typically on the textile by that process.

Referring to FIG. 25, a method and an apparatus for disposing the fluorescent fibers 20 on the substrate 10-3 or 10-4 according to a fifteenth embodiment are mentioned below, in which a “DOWN” system electrostatic process is applied.

FIG. 25 is a schematic cross sectional view showing the method and the apparatus according to the fifteenth embodiment.

At first, a substantially rectangular flat substrate (a front substrate 10-3 or a rear substrate 10-3) composed of a glass plate may be mounted on a flat electro-conductive metal plate 60a.

At this time, an electro-conductive liquid film (not shown in FIG. 25) may be preferably interposed between the flat substrate 10-3 or 10-3 and the flat electro-conductive metal plate 60a to obtain a well electric contact therebetween, in which the electro-conductive liquid film may be electrolytic solution or electro-conductive grease.

Any heating means 61 e.g. an electric heater may be disposed inside or outside the electro-conductive metal plate 60a.

Further or instead, another heating means, e.g. at least one infrared lamp 76 with a reflector 77 may be disposed to radiate infrared rays to the flat substrate 10-3 or 10-3.

A hopper or an accommodation box 74 may be composed of a box having an upper opening 74b to encase the fluorescent optical fibers 20 therefrom into the box and an electro-conductive bottom 74a to have plural trough-holes 75.

The fluorescent optical fibers 20 may be supplied from the trough-holes 74b of the electro-conductive bottom 74a downwardly to the substrate 10-3 or 10-4.

A vibrator (not shown in FIG. 25) may be provided to give a mechanical vibration to the hopper 74 to promote a dropping of the fluorescent fibers 20 from the hopper 74.

One end of an electro-conductive lead wire 72a is connected to the electro-conductive bottom 74a of the hopper 74, another end of the electro-conductive lead wire 72a is connected to one pole of a high voltage DC power supply 71 and another pole of the high voltage DC power supply 71 is connected to the electro-conductive metal plate 60a through another electro-conductive lead wire 72b

The hopper 74 may be disposed at a position upper than the substrate 10-3 or 10-4 so as to face therewith to keep a predetermined distance.

When a high DC voltage is applied from the high voltage DC power supply 71 between the electro-conductive bottom 74a with the through-hole 75 and the electro-conductive metal plate 60a, an electrostatic charge is given to the fluorescent fibers 20 at the time of passing the through-hole 75 of the electro-conductive bottom 74a from an interior of the hopper 74 and the fluorescent fibers 20 are dropped toward the substrate 10-3 or 10-4 by a gravity and an electrostatic attraction power.

When the substrate 10-3 or 10-4 having a high electrical resistance in a room temperature is heated by the heating means 61a and/or 76 to a sufficient temperature e.g. 300□, the electrical resistance of the substrate 10-3 or 10-4 temporally becomes low substantially to be electro-conductive.

Therefore, the fluorescence fibers 20 having the electrostatic charge e.g. plus charge given at the electro-conductive bottom 74a can be electrostatically disposed on an upper surface of the substrate 10-3 or 10-4 so that the fluorescence fibers 20 are adhered to stand densely together on the upper surface substantially perpendicularly to the upper surface.

If a temperature of the substrate (glass plate) 10-3 or 10-4 is raised to a melting point or a softening temperature (e.g. 300-600 degree C.) of the substrate 10-3 or 10-4 and/or the fluorescent fibers with glass 20 by the heating means 61a and/or the 76, the fluorescent fibers 20 adhered electrostatically on the substrate 10-3 or 10-4 are fused at the fixed ends thereof on the surface of the substrate 10-3 or 10-4 and after cooling to a room temperature the fluorescent fibers 20 can be permanently fixed on the substrate 10-3 or 10-4.

A glass film or a fluorescent glass film (not shown in FIG. 25) to include a glass material may be preliminarily formed on the substrate 10-3 or 10-4, in which the glass material may have a low melting point or low softening temperature that is lower than that of the substrate 10-3 or 10-4 and/or the fluorescent fibers 20.

If the glass film or the fluorescent glass film are disposed on the substrate 10-3 or 10-4 and the temperature thereof is raised to the low melting point or low softening temperature, the glass film or the fluorescent glass film are softened or fused so as permanently to fix the fluorescent fibers 20 on the glass film 58a and 58b after cooling to a room temperature.

### SIXTEENTH EMBODIMENT

A sixteenth embodiment shows a method and an apparatus for manufacturing the plasma display panel 900 as shown in FIG. 22 and FIG. 23.

Referring to FIG. 26 (also see FIG. 22 and FIG. 23), the method and the apparatus for disposing the fluorescent fibers 20 on the rear substrate 10-4 according to a sixteenth embodiment are mentioned below, in which a “DOWN” system electrostatic process is applied.

FIG. 26 is a schematic perspective view showing the method and the apparatus according to the sixteenth embodiment.

Referring to FIG. 26, the barrier walls 53 with stripe patterns and the address electrodes 54 with stripe patterns are formed on the inner surface of the rear substrate 10-4, in which the address electrodes 54 are disposed between the adjacent barrier walls 53 to be arranged parallel to and along the barrier walls 53.

Further, as shown in FIG. 23, the fluorescent glass film 58a and 58b may be formed on the surface of the rear substrate 10-4 to cover the address electrodes 54 and the fluorescent glass film 58c may be formed on the surface of the barrier walls 53, in which the fluorescent glass film 58a, 58b and 53c include phosphor material and fluorescent fibers 20 are flocked to fix on the fluorescent glass film 58a, 58b and 53c.

A hopper or an accommodation box 74 may be composed of a box having an upper opening to encase the fluorescent optical fibers 20 therefrom into the box and an electro-conductive bottom 74a to have plural trough-holes such as a metal mesh to supply the fluorescent optical fibers 20 downwardly therefrom toward the rear substrate 10-4.

A vibrator (not shown in FIG. 26) may be provided to vibrate the hopper 74 for helping the fluorescent optical fibers 20 to drop.

One pole of a high DC voltage power supply 71 is connected to the electro-conductive bottom 74a through an electric lead wire 72a and a power switch 79 and another pole of the high DC voltage power supply 71 is connected to plural lead wires 78 elongated from the address electrodes 54 through a lead wire 72b, in which each of plural selective switches “Sb”, “Sg” and “Sr” is inserted in each of the lead wires 78 in series.

The hopper 74 may be disposed at an upper position far from the rear substrate 10-4 so as to keep a predetermined distance.

Heating means (not shown in FIG. 26) may be provided to heat the rear substrate 10-4.

When a high DC voltage is applied from the high voltage DC power supply 71 between the electro-conductive bottom 74a with the through-hole and the address electrodes 54, an electrostatic charge is given to the fluorescent fibers 20 at the time of passing the through-hole of the electro-conductive bottom 74a from an interior of the hopper 74 and the fluorescent fibers 20 are dropped toward the rear substrate 10-4 by an electrostatic attraction power in addition to a gravity.

Therefore, the fluorescence fibers 20 having the electrostatic charge e.g. plus charge given at the electro-conductive bottom 74a can be electrostatically disposed on the address electrodes 54 on the rear substrate 10-4 so that the fluorescence fibers 20 are adhered to stand densely together on the address electrodes 54 substantially perpendicularly to the upper surface.

If a temperature of the rear substrate (glass plate) 10-4 is raised to a melting point or a softening temperature of the fluorescent fibers with glass 20 by the heating means, the fluorescent fibers 20 adhered electrostatically on the address electrodes 54 are fused at the fixed ends thereof on the address electrodes 54 and after cooling to a room temperature the fluorescent fibers 20 can be permanently fixed on the substrate 10-4 through the address electrodes 54.

As shown in FIG. 23, the glass film 58a and 58b with/without phosphor material may be formed on the surface of the rear substrate 10-4 to cover the address electrodes 54, in which the glass material of the glass film 58a and 58b have a melting point or softening temperature lower than the melting point or softening temperature of the rear substrate 10-4.

In this case, when a temperature of the rear substrate (glass plate) 10-4 is raised to the softening point or the softening temperature (e.g. 300-600 degree C.) of the glass film 58a and 58b with/without phosphor material by the heating means, the glass film 58a and 58b are softened or fused so as permanently to fix the fluorescent fibers 20 on the glass film 58a and 58b after cooling.

Referring to FIG. 26 and FIG. 22, an electrostatic flocking process may be carried out alternately three times using each of three kinds of the fluorescent fibers 20 or (20(B), 20(G) and 20(R)) having three color phosphors (blue B, green G and red R), in order to disposing the fluorescent fibers 20 in each of the electric discharge cells 12 corresponding to each of the three color B, G and R, in which three kinds of the hoppers 74 each accommodating the fluorescent fibers 20 or (20(B), 20(G) and 20(R)) having each of the three color phosphors B, G and R may be alternately used.

In this case, the selective switches “Sb”, “Sg” and “Sr” within the lead wires 78 each connecting to the address electrodes 54 can be used for changing the electrostatic flocking process.

At first, the first hopper 74 to accommodate the fluorescent fibers with blue phosphor is used.

When the power switch 79 and the selective switch Sb are closed, and the selective switches “Sg” and “Sr” are opened, a high DC voltage from the high DC voltage power supply 71 is applied between the conductive bottom 74a of the first hopper 74 and the address electrodes 54 corresponding to the blue discharge cells 12.

Therefore, the blue fluorescent fibers 20(B) can be flocked on the address electrodes 54 corresponding to the blue discharge cells 12.

Next, the second hopper 74 to accommodate the fluorescent fibers with green phosphor is used.

Similarly to above, when the power switch 79 and the selective switch “Sg” are closed, and the selective switches “Sb” and “Sr” are opened, a high DC voltage from the high DC voltage power supply 71 is applied between the conductive bottom 74a of the second hopper 74 and the address electrodes 54 corresponding to the green discharge cells 12.

Therefore, the green fluorescent fibers 20(G) can be flocked on the address electrodes 54 corresponding to the green discharge cells 12.

Finally, the third hopper 74 to accommodate the fluorescent fibers with red phosphor is used.

Similarly to above, when the power switch 79 and the selective switch “Sr” are closed, and the selective switches “Sb” and “Sg” are opened, a high DC voltage from the high DC voltage power supply 71 is applied between the conductive bottom 74a of the third hopper 74 and the address electrodes 54 corresponding to the red discharge cells 12.

Therefore, the red fluorescent fibers 20(R) can be flocked on the address electrodes 54 corresponding to the red discharge cells 12.

In that way, all the fluorescent fibers 20(B), 20(G) and 20(R) can be flocked onto the address electrodes 54 corresponding to each of the B, G and R discharge cells 12

During the electrostatic flocking process, it is desirable to prevent the fluorescent fibers 20 from direct dropping on the address electrodes 54 not corresponding thereto.

For this purpose, three kinds of pattern masks, each having a striped pattern opening corresponding to the related discharge cells may be alternately disposed adjacent to and facing the rear substrate 10-4 in order to mask the no related discharge cells.

Alternatively, a reverse electric DC potential may be applied alternately on the non-selected address electrodes 54.

### SEVENTEENTH ENVODIMENT

A seventeenth embodiment shows another method and another apparatus for manufacturing a plasma display panel.

Referring to FIG. 27, FIG. 28 and FIG. 29, the method and the apparatus for disposing the fluorescent fibers 20 on the rear substrate 10-4 according to a seventeenth embodiment are mentioned below.

FIG. 27 is a schematic partial enlarged cross sectional view showing the method and the apparatus according to the seventeenth embodiment, in which a “UP” system electrostatic process is applied.

FIG. 28 is a schematic partial enlarged cross sectional view showing the method and the apparatus according to the seventeenth embodiment, in which the fluorescent fibers 20 are flocked to fix on the rear substrate 10-4.

FIG. 29 is a schematic partial enlarged cross sectional view showing a main portion of a plasma display panel manufactured according to the seventeenth embodiment.

Referring to FIG. 27 and FIG. 28, an electrostatic process and apparatus according to the seventeenth embodiment is explained.

Plural barrier walls 53 with stripe patterns and plural address electrodes 54 with stripe patterns are formed on an inner surface of a rear substrate 10-4, in which the address electrodes 54 are disposed between the adjacent barrier walls 53 to be arranged parallel to and along the barrier walls 53.

In the seventeenth embodiment, an electro-conductive metallic film 81 is preliminarily disposed entirely on a first surface of the address electrodes 54 and on each second surface of the barrier walls 53 except each bottom and top thereof, in which the electro-conductive metallic film 81 on the first surface extends to the electro-conductive metallic film 81 on the second surface to connect electrically together.

The electro-conductive metallic film 81 may be composed of the metallic film having an excellent electric conductivity such as cupper (Cu), aluminum (Al), nickel (Ni), tin or stannum (Sn), zinc (Zn), tin oxide (SnO2) and indium-tin oxide (ITO), in which Al, Ni, Sn, or Zn is a light reflective metal and SnO2 or ITO is a light transmissive metal oxide.

The electo-conductive metallic film 81 is acting as one electrode used for the electrostatic flocking process.

A metallic electrode panel 80 is prepared for acting as another electrode used for the electrostatic flocking process.

Plural fluorescent fibers 20 are disposed on the metallic electrode panel 80.

A vibrator (not shown in FIG. 22) may be prepared to connect mechanically with the metallic electrode panel 80 to help a jumping of the fluorescent fibers 20 at the time of flocking the fluorescent fibers 20 to the electo-conductive metallic film 81 on the rear substrate 10-4.

One pole e.g. plus pole of a high voltage DC power supply 71 is electrically connected to the electo-conductive metallic film 81 on the rear substrate 10-4 through an electro-conductive lead wire 72b and an electro-conductive lead wire 78.

Another pole e.g. minus pole of a high voltage DC power supply 71 is electrically connected to the electo-conductive metallic plate 80 through an electro-conductive lead wire 72a.

As shown in FIG. 27 (similarly shown in FIG. 22), selective switches “Sb”, “Sg” and “Sr” are inserted in-between the electro-conductive lead wire 78, in which each of the selective switches “Sib”, “Sg” and “Sr” is corresponding to each of discharge cells for blue (B), green (G) and red (R) colors, so that each of the fluorescent fibers having B, G and R color phosphors can be alternately flocked in the each of discharge cells for B, G and R colors.

The rear substrate 10-4 is disposed at an upper position far from the metallic electrode panel 80 as to keep a predetermined distance therebetween, so that the rear substrate 10-4 faces the address electrodes 54 on the rear substrate 10-4.

Heating means (not shown in FIG. 27) may be provided to heat the rear substrate 10-4.

[When the power switch 79 is closed or “ON”, a high DC voltage is applied from the high voltage DC power supply 71 between the electo-conductive metallic film 81 of the rear substrate 10-4 and the electo-conductive metallic electrode plate 80.

At this time, an electrostatic charge e.g. negative charge is given to the fluorescent fibers 20 since the fluorescent fibers 20 contact with the electo-conductive metallic electrode plate 80.

Therefore, the fluorescent fibers 20 are ascended toward the rear substrate 10-4 by an electrostatic attraction power.

The electo-conductive metallic electrode plate 80 may be porous plate having plural through-holes (not shown in FIG. 27) to pass therebetween, so that air can be sent from a rear surface of the electrode plate 80 to a front surface thereof to give an upward air stream to the fluorescent fibers 20.

The fluorescent fibers 20 having e.g. the negative charge jump up toward the rear substrate 10-4, so that the fluorescent fibers 20 are tentatively adhered electrostatically on the electo-conductive metallic film 81 to act as a reverse electrode (e.g. positive electrode) to stand together thereon substantially perpendicularly thereto.

If a temperature of the rear substrate (glass plate) 10-4 is raised to a melting point or a softening temperature of the fluorescent fibers with glass 20 by the heating means, the fluorescent fibers 20 adhered electrostatically on the electo-conductive metallic film 81 are fused at the fixed ends thereof on the address electrodes 54 and on the barrier walls 81 and after cooling to a room temperature the fluorescent fibers 20 can be fixed on the electo-conductive metallic film 81 on the address electrodes 54 and on the barrier walls 81.

An electrostatic flocking process may be carried out alternately three times using each of three kinds of the fluorescent fibers 20 or (20(B), 20(G) and 20(R)) having three color phosphors (blue B, green G and red R), in order to disposing the fluorescent fibers 20 in each of the electric discharge cells 12 corresponding to each of the three color B, G and R, in which three kinds of the fluorescent fibers 20 or (20(B), 20(G) and 20(R)) are alternately placed on the electo-conductive metallic electrode plate 80.

In this case, the selective switches “Sb”, “Sg” and “Sr” within the lead wires 78 each connecting to the electro-conductive metallic film 81 can be used for changing the electrostatic flocking process.

At first, the fluorescent fibers 20 with blue phosphor are placed on the electo-conductive metallic electrode plate 80.

When the power switch 79 and the selective switch “Sb” are closed, and the selective switches “Sg” and “Sr” are opened, a high DC voltage from the high DC voltage power supply 71 is applied between the electo-conductive metallic electrode plate 80 and the electo-conductive metallic film 81 corresponding to the blue discharge cells 12.

Therefore, the blue fluorescent fibers 20(B) can be flocked on the electo-conductive metallic film 81 corresponding to the blue discharge cells 12.

Next, the fluorescent fibers 20 with green phosphor are placed on the electo-conductive metallic electrode plate 80.

Similarly to above, when the power switch 79 and the selective switch “Sg” are closed, and the selective switches “Sb” and “Sr” are opened, a high DC voltage from the high DC voltage power supply 71 is applied between the electo-conductive metallic electrode plate 80 and the electro-conductive metallic film 81 corresponding to the green discharge cells 12. Therefore, the green fluorescent fibers 20(G) can be flocked on the electo-conductive metallic film 81 corresponding to the green discharge cells 12.

Next, the fluorescent fibers 20 with red phosphor are placed on the electo-conductive metallic electrode plate 80.

Similarly to above, when the power switch 79 and the selective switch “Sr” are closed, and the selective switches “Sb” and “Sg” are opened, a high DC voltage from the high DC voltage power supply 71 is applied between the electo-conductive metallic electrode plate 80 and the electo-conductive metallic film 81 corresponding to the red discharge cells 12.

Therefore, the red fluorescent fibers 20(R) can be flocked on the address electrodes 54 corresponding to the red discharge cells 12.

In that way, all the fluorescent fibers 20(B), 20(G) and 20(R) can be flocked onto the electo-conductive metallic film 81 corresponding to each of the B, G and R discharge cells 12

In the seventeenth embodiment, since the “UP” system electrostatic flocking process is applied, the fluorescent fibers 20(B), 20(G) or 20(R) do not adhere on the un-selected electro-conductive metallic film 81 at each time of the electrostatic flocking process due to gravity of the un-selected fluorescent fibers 20(B), 20(G) or 20(R).

Then, the electro-conductive metallic film 81 is deleted except portions where the fluorescent fibers 20(B), 20(G) and 20(R) are flocked, in such a conventional etching process that a conventional etching liquid such as NaOH or KOH to dissolve the electro-conductive metallic film 81 is supplied into the discharge cells 12.

At this time, the electro-conductive metallic film 81 is selectively dissolved except the portions (positions of the fixed ends of the fluorescent fibers 20) where the fluorescent fibers 20 are flocked, because the fluorescent fibers 20 are acting as an etching resist against the etching liquid.

Consequently, the electro-conductive metallic film 81 remains as plural dot-like (or point-like) electro-conductive metallic films having island patterns at the fixed ends of the fluorescent fibers 20.

Since the dot-like electro-conductive metallic films are electrically isolated to one another, an existence of the dot-like electro-conductive metallic films does not give any bad influence to discharge of the plasma display panel.

As shown in FIG. 29, a surface discharge plasma display panel 910 is briefly composed of a substantially rectangular, visible light permeable (i.e. transmissive, conductive or transparent) front glass substrate 10-3 for indication use, a substantially rectangular rear glass substrate 10-3, plural barrier walls 53 having stripe patterns arranged parallel on the rear glass substrate 10-3 in which the plural barrier walls 53 define plural discharge cells 12.

Further, the plasma display panel 910 is composed of plural address electrodes (data electrodes) 54 having stripe patterns arranged parallel along and between the adjacent barrier walls 53 on the rear glass substrate 10-3 and plural fluorescent fibers 20 disposed within the discharge cells 12 on the address electrodes 54 and on major surfaces of the barrier walls 53, in which the fluorescent fibers 20 are fixed on the address electrodes 54 and the barrier walls 53 so as to stand together.

Plural dot-like (or point-like) electro-conductive films 81a, each is formed between each fixed end of the fluorescent fibers 20 and surfaces of the address electrodes 54 and between the each fixed end of the fluorescent fibers 20 and the major surfaces of the barrier walls 53.

Still further, the plasma display panel 910 is composed of plural indication electrodes 56 and 57 (i.e. plural scanning electrodes 56 and plural sustain electrodes 57) and a dielectric film 55 formed on the scanning electrodes 56 and the sustain electrodes 57 in which the scanning electrodes 56 and the sustain electrodes 57 are formed on the front glass substrate 10-3 to be arranged alternately and parallel to one another.

The front glass substrate 10-3 and the rear glass substrate 10-4 are bonded together and sealed in such a manner that the indication electrodes 56 and 57 having the stripe patterns face the address electrodes 54 having the stripe patterns to each other so as to be perpendicularly to each other.

Dischargeable inert gas is filled in the discharge cells 12 between the front glass substrate 10-3 and the rear glass substrate 10-4.

As the dot-like (or point-like) electro-conductive metallic films 81a mentioned above, the light reflective metallic films such as Al, Ni, Sn and Zn are preferably used, because the dot-like (or point-like) electro-conductive metallic films 81 a positioned on the fixed ends of the fluorescent optical fibers 20 redirect light emitting from the fluorescent optical fibers 20 and advancing to the fixed end thereof and allow the light to exit from the free end thereof to the front glass substrate 10-3.

Therefore, in this case, the plasma display panel 910 has an advantage that the light emitting from the fluorescent optical fibers 20 can be efficiently used to exit from the front glass substrate 10-3.

### EIGHTEENTH EMBODIMENT

Referring to FIG. 30, an eighteenth embodiment of the present invention is described bellow.

FIG. 30 is a schematic enlarged partial cross sectional view showing a major portion of a plasma display panel 920 according to the eighteenth embodiment.

The plasma display panel 920 of the eighteenth embodiment is a modification of the plasma display panel 910 of the seventeenth embodiment mentioned above, in which the plasma display panel 920 is further provided with a first fluorescent film 58a and/or a second fluorescent film 58b.

As shown in FIG. 29, a surface discharge plasma display panel 920 is briefly composed of a substantially rectangular, visible light permeable (i.e. transmissive, conductive or transparent) front glass substrate 10-3 for indication use, a substantially rectangular rear glass substrate 10-3, plural barrier walls 53 having stripe patterns arranged parallel on the rear glass substrate 10-3 in which the plural barrier walls 53 define plural discharge cells 12.

Further, the plasma display panel 920 is composed of plural address electrodes (data electrodes) 54 having stripe patterns arranged parallel along and between the adjacent barrier walls 53 on the rear glass substrate 10-3.

Still another, in the eighteenth embodiment, the plasma display panel 920 is composed of the first fluorescent films 58a are formed on the address electrodes 54 and/or the second fluorescent films 58b are formed on major surfaces of the barrier walls 53, in which the first fluorescent films 58a and/or the second fluorescent films 58b may be composed of sintered phosphor films or phosphor containing glass films having a UV permeable (i.e. transmissive, conductive or transparent) glass binder film (transparent dielectric film) to contain plural phosphor particles dispersed therein.

Alternatively, the first fluorescent films 58a may be formed on a dielectric glass film (not shown in FIG. 30) that is formed on the address electrodes 54.

Still further, plural fluorescent fibers 20 may be disposed within the discharge cells 12 on the first fluorescent glass films 58a and/or on the second fluorescent glass films 58b by an electrostatic flocking process described above, in which the fluorescent fibers 20 are fixed on the first fluorescent glass films 58a and/or on the second fluorescent glass films 58b so as to stand together.

Plural dot-like (or point-like) electro-conductive films 81a, each is formed between each fixed end of the fluorescent fibers 20 and the first fluorescent glass films 58a and between the each fixed end of the fluorescent fibers 20 and the second fluorescent glass films 58b.

Still further, the plasma display panel 910 is composed of plural indication electrodes 56 and 57 (i.e. plural scanning electrodes 56 and plural sustain electrodes 57) and a dielectric film 55 formed on the scanning electrodes 56 and the sustain electrodes 57.

The scanning electrodes 56 and the sustain electrodes 57 are formed on the front glass substrate 10-3 to be arranged alternately and parallel to one another.

The front glass substrate 10-3 and the rear glass substrate 10-4 are bonded together and sealed in such a manner that the indication electrodes 56 and 57 having the stripe patterns face the address electrodes 54 having the stripe patterns to each other so as to be perpendicularly to each other.

Dischargeable inert gas is filled in the discharge cells 12 between the front glass substrate 10-3 and the rear glass substrate 10-4.

As the dot-like (or point-like) electro-conductive metallic films 81a mentioned above, the light reflective metallic films such as Al, Ni, Sn and Zn are preferably used, because the dot-like (or point-like) electro-conductive metallic films 81a positioned on the fixed ends of the fluorescent optical fibers 20 redirect light emitting from the fluorescent optical fibers 20 and advancing to the fixed end thereof and allow the light to exit from the free end thereof to the front glass substrate 10-3.

Therefore, in this case, the plasma display panel 920 has an advantage that the light emitting from the fluorescent optical fibers 20 can be efficiently used to exit from the front glass substrate 10-3.

Comparison of Surface Area of Fluorescent Film between the present invention and the related art

A first example is explained below in which a surface area of fluorescent films on the glass tube e.g. 10, 10-1, 10-2 used as an envelope of a fluorescent lamp having a circular ring shaped cross section as shown in e.g. FIG. 1, FIG. 9, FIG. 15, FIG. 16, FIG. 17 and FIG. 21 is compared with the surface area of the fluorescent films in the related art.

If a radius of an inner surface of the glass tube is “r₁”, a length of axial direction is “l₁” and an index of circumference (pi) is “π”, a total area “S₁” of the inner surface becomes S₁=(2 πr₁)×l₁.

Therefore, when the fluorescent film is formed on an entire area of the inner surface of the glass tube, a total area S₁ of the fluorescent film is S₁=(2 πr₁)×l₁ that is equal to the total area of the inner surface of the glass tube.

If one piece of the fluorescent fiber has a radius of a core “r₂” and a length of axial direction “l₂”, a total area “S₂” of a side surface of the fluorescent fiber becomes S₁=(2 πr₁)×l₁ and a cross sectional area “S₃” of the core becomes S₃=π(r₁)².

For example, if the glass tube has the radius “r₁” 14 mm and the length “l₁” of axial direction 580 mm and one piece of the fluorescent fiber has the radius “r₂” 0.5 mm and the length “l₂” of axial direction 5 mm in which an aspect ratio (i.e. the ratio of a diameter to the length) of the fluorescent fiber is a value “5”, the total area “S₁” of the conventional fluorescent film able to be formed on the inner surface of the glass tube becomes S₁=(2 πr₁)×l₁=about 50,993 mm², while the total area “S₂” of the fluorescent film of the embodiments able to be formed on the side surface of the fluorescent fiber becomes S₂=2 π r₂×l₂=about 15.7 mm² and the cross sectional area S₃ of the fluorescent fiber becomes S₃=π r²=about 0.785 mm².

Therefore, if the plural fluorescent fibers are fixed on a half of the total area S₁ of the inner surface of the glass tube, total numbers “N₁” capable of forming the fluorescent fibers becomes N₁=(S₁/S₃)×0.5=about 32,479 pieces and the total area S₄ capable of forming the fluorescent film on the cores of the total numbers of the fluorescent fibers becomes S₄=N₁×S₂=509,929 mm².

This value means that the total area of the fluorescent film on the fluorescent fibers increases about ten times larger than the total area of the fluorescent film directly coated on the inner surface of the glass tube.

Therefore, the novel fluorescent lamp of the present invention has an enhanced brightness or luminance due to a remarkably increased area of the fluorescent film, compared to the conventional fluorescent lamp.

A second example is explained below in which a surface area of fluorescent films on the flat substrate e.g. 10-3, 10-4 of the flat fluorescent lamp or the plasma display panel as shown in e.g. FIG. 18, FIG. 19 and FIG. 22 is compared with the surface area of the fluorescent films in the related art.

For example, if a total effective area “S₅” of the flat substrate e.g. 10-3, 10-4 is a size equal to a paper size “A4” having a height “D” 297 mm and a width “W” 210 mm, the total effective area becomes S₅=D×W=62,370 mm².

Further, for example, if one piece of the fluorescent fiber has a length “l₂” 0.5 mm and a radius “r₂” 0.05 mm in which an aspect ratio (the ratio of the length “l₂” to a diameter “2 r₂” is “5”, a total area “S₂” of a side surface of the fluorescent fiber becomes S₂=(2 πr₂)×l₂=0.157 mm² and a cross sectional area “S₃” of the core becomes S₃=π(r₂)²=about 0.00785 mm².

Therefore, if the plural fluorescent fibers are fixed on a quarter of the total effective area S₅ of the inner surface of the substrate, total numbers “N₂” capable of forming the fluorescent fibers becomes N₂=(S₅/S₃)×0.25=about 1,986,305 pieces and the total area S₆ capable of forming the fluorescent film on the cores of the total numbers of the fluorescent fibers becomes S₆=N₂×S₂=about 311,849 mm².

This value means that the total area of the fluorescent film on the fluorescent fibers increases about five times larger than the total area of the fluorescent film directly coated on the inner effective surface of the substrate.

Therefore, the novel flat fluorescent lamp or the novel plasma display panel of the present invention has an enhanced brightness or luminance due to a remarkably increased area of the fluorescent film, compared to the conventional flat fluorescent lamp or the conventional plasma display panel.

As described in the above various embodiments, the novel discharge fluorescent apparatus of the present invention can have an enhanced brightness or luminance due to a remarkably increased area of the fluorescent film, compared to the conventional discharge fluorescent apparatus, since the fluorescent fibers or the fluorescent fibers are disposed on the glass tube or the substrate of the discharge fluorescent apparatus such as the fluorescent lamp and the plasma display panel preferably by the electrostatic process.

The discharge fluorescent apparatus of the present invention enables to emit visible light having a higher brightness from the same area size of an emitting/indication surface as the conventional discharge fluorescent apparatus.

The discharge fluorescent apparatus of the present invention enables to emit visible light having a higher brightness under substantially the same conditions such as an emitting/indication surface, a size, power consumption, an operation voltage and operation frequencies as the conventional discharge fluorescent apparatus.

Therefore, if the discharge fluorescent apparatus of the present invention is set to have substantially the same brightness as the conventional discharge fluorescent apparatus, it is possible to propose the discharge fluorescent apparatus having a smaller size and/or a stronger brightness than the conventional discharge fluorescent apparatus.

The discharge fluorescent apparatus of the present invention may be driven by the pulse or high frequency power supply inverted by e.g. an inverter as well as by the commercial power supply.

### NINTEENTH EMBODIMENT

Referring to FIG. 31, a nineteenth embodiment is described below, in which the nineteenth embodiment is a modification of the first embodiment described above.

FIG. 31 is a schematic enlarged cross sectional view showing a portion surrounded with a circle “PA” of FIG. 1.

As shown in FIG. 31, FIG. 1, FIG. 6A and FIG. 6A, a straight, tubular fluorescent lamp (discharge fluorescent apparatus) may be briefly composed of a straight, tubular glass tube (envelope) 10, dischargeable gas sealed in a discharge space 12 of the glass tube 10, electrodes 14a and 14b positioned at inner ends of the glass tube or bulb (envelope) 10 and a plurality of single core structured fluorescent optical fibers 22 (or 20) each having a UV and visible light transmissive elongated optical core (protrusion) 22c, a fixed end 22a, a free end 22b and plural phosphor particles 30 dispersed in the core 22c.

This composition of the nineteenth embodiment is similar to the composition of the first embodiment (see FIG. 6A and FIG. 6A).

The straight, tubular fluorescent lamp of the nineteenth embodiment different from the straight, tubular fluorescent lamp 100 of the first embodiment is further composed of dot shaped or point shaped electro-conductive films 81a, each of the dot or point shaped electro-conductive films 81a being interposed between an inner surface 10b of the straight, tubular glass tube 10 and the fixed end 22a of each of the single core structured optical fluorescent fibers 22, in which the electro-conductive films 81a are shown in FIG. 29 and FIG. 30.

In this embodiment, a visible light permeable (i.e. transmissive, conductive or transparent) metal oxide film such as In-Tin Oxide (ITO) is preferably used as each of the dot-like or point-like electro-conductive films 81a, so that the visible light to emit from the phosphors 30 and transmit within the core i.e. fluorescent optical fiber 20 can exit from the fixed end 22a to go out through the glass tube 10.

### TWENTY EMBODIMENT

Referring to FIG. 32, a twenty embodiment is described below, in which the twenty embodiment is another modification of the first embodiment described above.

FIG. 32 is a schematic enlarged cross sectional view showing a portion surrounded with a circle “PA” of FIG. 1.

As shown in FIG. 32, FIG. 1, FIG. 5A and FIG. 5B, a straight, tubular fluorescent lamp (discharge fluorescent apparatus) 100 may be briefly composed of a straight, tubular glass tube (envelope) 10, dischargeable gas sealed in a discharge space 12 of the glass tube 10, electrodes 14a and 14b positioned at inner ends of the glass tube or bulb (envelope) 10 and a plurality of core-clad structured fluorescent optical fibers 21 (or 20) each having a UV, visible light transmissive elongated optical core (protrusion) 21c, a fixed end 21a, a free end 21b, a UV, visible light transmissive clad 21d covered on the core 21c and plural phosphor particles 30 dispersed in the clad 21d.

This composition of the twenty embodiment is similar to the composition of the first embodiment (see FIG. 5A and FIG. 5B).

The straight, tubular fluorescent lamp of the twenty embodiment different from the straight, tubular fluorescent lamp 100 of the first embodiment is further composed of dot shaped or point shaped electro-conductive films 81a, each of the dot shaped or point shaped electro-conductive films 81a being interposed between an inner surface 10b of the straight, tubular glass tube 10 and the fixed end 22a of each of the core-clad structured fluorescent optical fibers 21 (or 20), in which the electro-conductive films 81a are shown in FIG. 29 and FIG. 30.

In this embodiment, a visible light permeable (i.e. transmissive, conductive or transparent) metal oxide film such as In-Tin Oxide (ITO) is preferably used as each of the dot-like or point-like electro-conductive films 81a, so that the visible light to emit from the phosphors 30 in the clad 21d and transmit within the core 21c can exit from the fixed end 21a to go out through the glass tube 10.

### TWENTY FIRST EMBODIMENT

Referring to FIG. 33 and FIG. 34, a twenty first embodiment is described below.

FIG. 33 is a schematic top view showing a flat fluorescent lamp 930 according to a twenty first embodiment and FIG. 34 is a schematic enlarged cross sectional view taken away along the line XXXIII-XXXIII of FIG. 33.

As shown in FIG. 33 and FIG. 34, a flat fluorescent lamp (discharge fluorescent apparatus) 930 may be briefly composed of a front substrate 10-3 having a substantially rectangular and substantially flat, front glass plate and a rear substrate 10-4 having a substantially rectangular and substantially flat, rear glass plate opposed to each other, a discharge space 12 therebetween, dual electrodes 14a or 19a opposed to each other within the discharge space 12, a plurality of fluorescent fibers 20 and a barrier wall 53.

The barrier wall (or partition wall, barrier rib, separator) 53 may have a substantially trapezoidal shape in cross section.

The barrier wall 53 may be composed of a glass sealant having a predetermined thickness, in which the barrier wall 53 may be partially formed on the rear substrate 10-4 and protrude or extend from the rear substrate 10-4 to the front substrate 10-3 so as to bond the front and second substrates 10-3 and 10-4 with the discharge space 12 therebetween having a meandering or zigzag channel.

The barrier wall 53 a peripheral portion of the front and second substrates 10-3 and 10-4 at the inner surfaces thereof in a substantially rectangular flame-like or ring-like manner and also the barrier wall 53 forms a continuously elongated partition (partition wall) having comb-like, inter-digital, zigzag shape between he front and second substrates 10-3 and 10-4 so that a continuously elongated gas passageway (gas space) 12 is produced.

The fluorescent fibers 20 may be disposed on a side surface of the barrier wall 53, the front substrate 10-3 and the rear substrate 10-4, thereby the flat fluorescent lamp 930 exhibits a very bright luminance, in which the fluorescent fibers 20 are composed of the core-clad structured fluorescent fibers 21 shown in FIG. 5A and/or the single core structured fluorescent fibers 22 shown in FIG. 6A.

The barrier wall 53 may be composed of a light-conductive glass to transmit light therethrough or a light reflecting (or scattering) glass to reflect (or scatter) light.

Electrodes (14a or 19a) and (14b or 19b) opposed to each other are disposed at opposed ends of the elongated gas passageway 12, in which the electrodes (14a or 19a) and (14b or 19b) may be cold cathodes or thermal cathodes.

Lead pins (16a or 18a) and (16b or 18b) are connected to the electrodes (14a or 19a) and (14b or 19b) at each one end of the lead pins (16a or 18a) and (16b or 18b), and the lead pins (16a or 18a) and (16b or 18b) are exposed to outside at each another end thereof for connecting to a power supply.

### TWENTY SECOND EMBODIMENT

Referring to FIG. 35 and FIG. 33, a twenty second embodiment is described below, in which the twenty second embodiment is a modification of the twenty first embodiment.

FIG. 35 is a schematic top view showing a flat fluorescent lamp 940 according to a twenty second embodiment taken away along the line XXXIII-XXXIII (the line 33-33) of FIG. 33.

As shown in FIG. 35 and FIG. 33, a flat fluorescent lamp (discharge fluorescent apparatus) 940 may be briefly composed of a front substrate 10-3 having a substantially rectangular and substantially flat, front glass plate and a rear substrate 10-4 having a substantially rectangular and substantially flat, rear glass plate opposed to each other, a discharge space 12 therebetween, dual electrodes 14a or 19a opposed to each other within the discharge space 12, a plurality of fluorescent fibers 20 and a barrier wall 53.

As shown in FIG. 35, different from the twenty first embodiment, in the twenty second embodiment the flat fluorescent lamp 940 is further composed of fluorescent films 42 interposed between the fluorescent optical fibers 20, 21 or 22 and the front and second substrates 10-3 and 10-4 and between the fluorescent optical fibers 20, 21 or 22 and the barrier walls 53.

The fluorescent films 42 each may be selected from a sintered phosphor film and a phosphor containing glass film composed of a UV and visible light permeable (i.e. transmissive, conductive or transparent) transparent glass film and plural phosphor particles contained therein.

In this embodiment, the flat fluorescent lamp 940 exhibits a maximum luminance since the fluorescent optical fibers 20, 21 or 22 and the fluorescent films 42 are disposed within the discharge space 12 having an elongated dischargeable gas passageway (channel).

### TWENTY THIRD EMBODIMENT

Referring to FIG. 36, FIG. 37 and FIG. 38, a twenty third embodiment is described below, in which the twenty third embodiment is a modification of the tenth embodiment explained referring to FIG. 18.

FIG. 36 is a schematic exploded perspective view showing a flat fluorescent lamp according to the twenty third embodiment; FIG. 37 is a schematic enlarged cross sectional view taken along the line XXXVII-XXXVII (the line 37-37) of FIG. 36 and FIG. 38 is a schematic enlarged, partial, perspective and partially cross sectional view showing a major portion of the flat fluorescent lamp according to the twenty third embodiment.

As shown In FIG. 36 through FIG. 38, a flat fluorescent lamp (discharge fluorescent apparatus) 950 may be briefly composed of a substantially rectangular and substantially flat front glass plate 10-3, a substantially rectangular and substantially flat rear glass plate 10-4 disposed to oppose to each other, having a substantially rectangular discharge space 12 therebetween, dual electrodes 14-1 and 14-2 opposed to each other, a plurality of protrusions (projections) 59, 59-1, 59-2 and 59-3 disposed on inner surface/surfaces of the front and/or the rear glass plates 10-3 and/or 10-4 and a plurality of fluorescent fibers 20.

The protrusions (projections) 59 (59-1, 59-2 and 59-3) may have typically a small finger-like, column-like, rod-like, conical or cylindrical shape, the protrusions (projections) 59 elongate from the inner surface/surfaces of the front and/or the rear glass plates 10-3 and/or 10-4 within the discharge space 12 and the protrusions (projections) 59 are arranged on the glass plates 10-3 and/or 10-4 to isolate to one another in an island manner.

As shown in FIG. 37 to FIG. 39, the protrusions (projections) 59 may be selected from a first protrusions (projections) 59-1, a second protrusions (projections) 59-2, a third protrusions (projections) 59-3 and a combination thereof.

The first protrusions (projections) 59-1 are composed of transparent glass core-like member 59-1a.

The second fluorescent protrusions (projections) 59-2 each is composed of a transparent glass material 59-2a and plural phosphor particles 59-2b dispersed therein.

The third fluorescent protrusions (projections) 59-3 each is composed of transparent glass core 59-3a and a fluorescent clad film 59-3b to contain a phosphor material or to contain plural phosphor particles dispersed in a transparent glass film.

The protrusions (projections) 59 (59-1, 59-2 and 59-3) may be formed on the front and/or the rear glass plates 10-3 and/or 10-4 by means of typically a screen printing process to print the glass paste or the phosphor paste mentioned above selectively on the glass plates 10-3 and/or 10-4 using a print mask with patterned openings or a transfer process to transfer the glass paste or the phosphor paste patternized in a supporting member onto the glass plates 10-3 and/or 10-4.

Further, as shown in FIG. 37 and FIG. 38, the fluorescent fibers 20 (21 and 22) may be disposed on surfaces of the protrusions (projections) 59 (59-1, 59-2 and 59-3) as well as on the inner surface/surfaces of the front and/or the rear glass plates 10-3 and/or 10-4. If an electrostatic process e.g. an electrostatic flocking is used for disposing the fluorescent fibers 20 on each surface of the protrusions 59 as well as on the surface/surfaces of the glass plates (substrate, envelope) 10-3 and/or 10-4, many numbers of the fluorescent fibers 20 can be arranged on the surface in high density and substantially perpendicularly to the surface without entangling to one another, because the fluorescent fibers 20 with the same electrostatic repel one another by an electrostatic repulsion or by their electrostatic interactions.

The protrusions 59 (59-1, 59-2 and 59-3) having the fluorescent fibers 20 have similar structure to the villi (similar to the protrusions 59) having the microvilli (similar to fluorescent fibers 20) on the villi disposed on the small intestine in the human body, in which the protrusions with the fluorescent fibers thereon can obtain a massive surface area for receiving V-UV light and for emitting visible light, while the villi with the microvilli thereon can obtain the massive surface area for absorbing the nutrients in the food.

The front glass plate 10-3 has visible light permeability, while the rear glass plate 10-4 may have visible light permeability or visible light reflectivity.

A substantially rectangular flame-like or ring-like sealing member (sealant) 50 such as sealing glass may be disposed between the front glass plate 10-3 and the rear glass plate 10-4 with the space 12 therebetween, so that the front glass plate 10-3, the rear glass plate 10-4 and the sealing member 50 constitute an envelope to contain inert gas in the discharge space 12 surrounded in air-tight state by the glass plates 10-3 and 10-4 and the sealing member 50.

The electrodes 14-1 and 14-2 may be thermal or hot cathodes or cold cathodes and electrically conductive lead pins 16-1 and 16-2 are connected to the electrodes 14-1 and 14-2 at each one end of the lead pins 16-1 and 16-2 within the space 12 and the lead pins 16-1 and 16-2 extend to outside from the envelope for connecting an electric power supply.

When a comparatively high voltage is applied between the opposed electrodes 14a and 14b through the lead pins 16-1 and 16-2, electrons are emitted from the electrodes 14a and 14b within the gas space 12 to initiate a discharge.

The electrons to move between the electrodes 14a and 14b strike the discharge-able gas in the discharge space 12 and Hg atoms to generate vacuum ultraviolet rays “V-UV” having peak wavelength 254 nm and 185 nm.

The vacuum ultraviolet rays “V-UV” generated from the discharge-able gas radiate the fluorescent fibers 20 on the inner surface of the front glass plate 10-3 and/or the rear glass plate 10-4.

Therefore, the fluorescent fibers 20 emit visible light upon excitation of the vacuum ultraviolet rays “V-UV” and the visible light exits from the front glass plate 10-3 and/or the rear glass plate 10-4.

In this twenty third embodiment, the flat fluorescent lamp 950 can exhibit a massive luminance, because the flat fluorescent lamp 950 may be provided with the protrusions (projections) 59 (59-1, 59-2 and 59-3) to emit visible light therefrom or from the fluorescent fibers 20 (21 and/or 22) disposed thereon in addition to the fluorescent fibers 20 (21 and/or 22) disposed on the glass plates 10-3 and/or 10-4.

An additional fluorescent film (not shown in FIG. 36 to FIG. 38) may be disposed between the glass plate 10-3 or 10-4 and fixed ends of the fluorescent fibers 20 (21 and/or 22).

Dot-like or point-like conductive films (not shown in FIG. 36 to FIG. 38) may be disposed between the glass plate 10-3 or 10-4 and fixed ends of the fluorescent fibers 20 (21 and/or 22).

The protrusions (projections) 59, 59-1, 59-2 and/or 59-3 in the flat fluorescent lamp 950 shown in FIG. 36 to FIG. 37 may be disposed in the flat fluorescent lamps 930 and 940 having the barrier walls 53 as shown in FIG. 33, FIG. 34 and FIG. 35, in which the protrusions (projections) 59, 59-1, 59-2 and/or 59-3 are disposed on the substrates 10-3 and/or the 10-4 and the fluorescent fibers 20 are disposed on the barrier walls 53.

The flat fluorescent lamps 600, 700 and 900 can be suitably used for such as flat lighting sources, flat illuminators and lighting (backlight or front light) of non-emissive displays typically liquid crystal displays (Lids).

### TWENTY FOURTH EMBODIMENT

Referring to FIG. 39, a twenty fourth embodiment is described below, FIG. 39 is a schematic perspective view showing a glass tube portion of the tubular fluorescent lamp 960 according to the twenty fourth embodiment, in which a portion “PC” surrounded with a circle is drawn as an enlarged cross sectional view in the same FIG. 39.

As shown In FIG. 39 (and e.g. FIG. 1 to FIG. 6), a tubular fluorescent lamp 960 according to the twenty fourth embodiment is similar to the tubular fluorescent lamp 100 shown in FIG. 1 to FIG. 6 according to the first embodiment.

The straight, tubular fluorescent lamp (discharge fluorescent apparatus) 960 similarly to the tubular fluorescent lamp 100, is briefly composed of a straight, tubular glass tube (envelope) 10, dischargeable gas sealed in a discharge space 12 of the glass tube 10, electrodes 14a and 14b positioned at inner ends of the glass tube or bulb (envelope) 10 and a plurality of fluorescent fibers 20 fixed on an inner surface of the glass tube or bulb 10.

As shown In FIG. 39, in this embodiment, the tubular fluorescent lamp 960 is further composed of a plurality of a protrusions i.e. projections 59 (a first protrusions 59-1, a second protrusions 59-2 and/or a third protrusions 59-3) that differs from the tubular fluorescent lamp 100, disposed on an inner surface the glass tube 10 to elongated from the inner surface to the discharge space 12 to be arranged to isolate to one another in an island manner.

The protrusions 59, 59-1, 59-2 and 59-3 may have typically a small finger-like, column-like, rod-like, conical or cylindrical shape. The first protrusions 59-1 each is composed of a transparent glass core-like member 59-1a having no phosphor disposed therein/on thereon, therefore, the fluorescent phosphors 20 must be disposed on the core-like member 59-1 to emit visible light. The second fluorescent protrusions (projections) 59-2 each is composed of a transparent glass core-like member 59-2a and plural phosphor particles 59-2b dispersed therein. The third fluorescent protrusions (projections) 59-3 each is composed of a transparent glass core-like member 59-3a and a fluorescent clad film 59-3b to contain a phosphor material therein or to contain plural phosphor particles dispersed in a transparent glass clad film.

The first, second and/or third protrusions 59-1, 59-2 and/or 59-3 may have a sufficient surface area allow the fluorescent fibers 20 to be disposed on a surface thereof in order to get a massive surface area, at which receives vacuum ultraviolet rays (V-UV) generated by the dischargeable gas within the discharge space 12 and from which visible light is emitted.

The protrusions 59, 59-1, 59-2 and 59-3 may be formed on the inner surface of the glass tube 10 by means of typically a screen printing process to print the glass paste or the phosphor paste-mentioned above selectively on the glass tube 10 using a print mask with patterned openings or a transfer process to transfer the glass paste or the phosphor paste patternized in a supporting member onto the inner surface of the glass tube 10. Further, as shown in FIG. 39, the fluorescent fibers 20 may be disposed on the surfaces of the protrusions 59 (59-1, 59-2 and 59-3) as well as on the inner surface/surfaces of the inner surfaces of the glass tube 10.

In this embodiment, because the tubular fluorescent lamp 960 may have a structure composed of the glass tube 10 (a tubular wall) and the protrusions 59 (59-1, 59-2 and 59-3) having the fluorescent fibers 20 thereon, the tubular fluorescent lamp 960 can have a massive surface area for receiving V-UV light and for emitting visible light, that are a similar structure to a small intestine in the human body.

The small intestine also has a massive surface area for absorbing the nutrients in the food passed through therein, because the small intestine is composed of a substantially tubular wall (similar to the glass tube 10), villi (similar to the protrusions 59) having microvilli (similar to fluorescent fibers 20) disposed on the villi.

In the twenty fourth embodiment, the tubular fluorescent lamp 960 can exhibit a massive, huge luminance, because the tubular fluorescent lamp 960 may be provided with the protrusions 59 (59-1, 59-2 and 59-3) with or without the phosphor, the fluorescent fibers 20 disposed on the protrusions 59 and optionally the fluorescent fibers 20 disposed on the glass tube 10.

All the embodiments mentioned above are provided with the internal electrodes e.g. (14a and 14b), (19a and 19b) disposed inside the envelope e.g. 10, however external electrodes or a combination of an internal electrode and an external electrode may be applied to the present invention in stead of the internal electrodes.

An external electrode fluorescent lamp having the dual external electrodes in stead of the internal electrodes, for example, is disclosed in U.S. Pat. No. 5,889,366 issued on Mar. 30, 1999 and No. 5,760,541 issued on Jun. 2, 1998,

An external and internal electrode fluorescent lamp having the combination of the internal electrode and the external electrode in stead of the internal electrodes, for example, is disclosed in U.S. Pat. No. 6,727,649 issued on Apr. 27, 2004 and No. 5,889,366 issued on Mar. 30, 1999.

In the present invention, the electrodes may be eliminated if the dischargeable gas in the discharge space e.g. 12 is subjected to generate an electrical discharge or plasma by an application of a radio frequency (RF) of several MHz or a microwave frequency (MF) of 916 MHz and higher

An electrode-less discharge fluorescent lamp excluding the inner or outer electrodes, for example, is disclosed in U.S. Pat. No. 5,959,405 issued on Sep. 28, 1999 U.S. Pat. No. 5,621,266 issued on Apr. 15, 1997 and U.S. Pat. No. 4,005,330 issued on Jan. 25, 1977.

The discharge fluorescent apparatus in the various preferred embodiments of the present invention described hereinbefore such as the tubular fluorescent lamps 100, 200, 300, 400, 500 and 800, the flat or planer fluorescent lamps 600, 700, 930, 940 and 950 and the plasma display panels 900, 910 and 920 is invented by an analogy of a small intestine in a human body, in which the small intestine has villus/villi or microscopic, finger-like or fiber-like protrusions (projections) on an inner wall thereof in order to give a massive surface area.

Although there is a very far distance between the discharge fluorescent apparatus and the small intestine of the human body to each other, there may be similar points between the fluorescent optical fibers and the villus/villi in both shapes and both purposes to obtain the massive surface area.

The fluorescent fibers or the fluorescent optical fibers 20, 20′, 20″, 20′″, 20-1, 20-2, 21, 22, 23 and 24 and/or the protrusions (projections) 59 or barrier walls 53 in the embodiments of the present invention, may be seen as an analogue to the villus/villi or microscopic, finger-like or fiber-like protrusions on the inner wall in the small intestine in the shape or structure

The protrusions on the small intestine have massive surface areas in order to absorb nutrients or nurtures in the food passed through the small intestine, while the fluorescent fibers, the fluorescent optical fibers and/or the protrusions (projections) or barrier walls containing a phosphor thereon/therein in the discharge fluorescent apparatus of the present invention have similarly to the small intestine the massive surface areas in order to emit visible light from the phosphor when excited with ultraviolet rays generated by the dischargeable gas within the discharge space within the envelope.

It is noted that any elements or portions in the various embodiments disclosed hereinbefore may be combined voluntarily to make still other embodiments of the present invention.

Although illustrative embodiments of the present invention have been described referring to the accompanying drawings, it is to be understood that the present invention is not limited to those embodiments and that various changes, modifications or equivalents may be made in the present invention by those skilled in the art without departing from the spirit or the scope of the present invention and the appended claims.

What is claimed is:

1. A discharge fluorescent apparatus including fluorescent fibers, comprising:
an air-tight envelope having a substantially transparent member and an inner surface;
a discharge space to fill a dischargeable gas within the envelope;
a plurality of fluorescent fibers each containing a phosphor therein/thereon, each of the fluorescent fibers having a fixed end and a free end;
wherein each of the fluorescent fibers elongates directly or indirectly from the inner surface to the discharge space in such a manner that the fixed end is disposed to be fixed directly or indirectly on the inner surface and the free end is disposed within the discharge space;
wherein the fluorescent fibers are excited by ultraviolet rays generated in the discharge space to emit visible light, and the visible light exits through the substantially transparent member.

2. The discharge fluorescent apparatus including fluorescent fibers, according to claim 1:
wherein each of the fluorescent fibers comprises a single core structure composed of a core and the phosphor contained in the core; or
wherein each of the fluorescent fibers comprises a fluorescent optical fiber having a single core structure composed of a light-conductive core and the phosphor having a plurality of phosphor particles dispersed in the light-conductive core.

3. The discharge fluorescent apparatus including fluorescent fibers, according to claim 1:
wherein each of the fluorescent fibers comprises a core-clad structure having a core, at least one clad partially or entirely disposed on the core and the phosphor contained in the core and/or the at least one clad; or
wherein each of the fluorescent fibers comprises a fluorescent optical fiber composed of a light-conductive core and at least one light-conductive clad partially or entirely to cover the light-conductive core and the phosphor having a plurality of phosphor particles dispersed in the light-conductive core and/or the at least one light-conductive clad.

4. The discharge fluorescent apparatus including fluorescent fibers, according to claim 1:
wherein each of the fluorescent fibers comprises a fluorescent optical fiber having a light-conductive core, a light-conductive clad partially or entirely to cover the core and the phosphor having a plurality of phosphor particles dispersed in the core and/or the clad; and
wherein the fluorescent optical fibers form leaky fluorescent optical fibers in such a manner that a refractive index of the core is lower than the refractive index of the clad.

5. The discharge fluorescent apparatus including fluorescent fibers, according to claim 1:
wherein the fluorescent fibers each having and a length and a core with a diameter; and
wherein an aspect ratio defined as a value of the length to the diameter is set between 1 and 100.

6. The discharge fluorescent apparatus including fluorescent fibers, according to claim 1, further comprising:
at least one glass film containing a glass therein or at least one fluorescent glass film containing the glass and the phosphor therein;
wherein the glass film or the fluorescent glass film is interposed between the fixed end of each of the fluorescent fibers and the inner surface of the envelope; and
wherein the glass is composed of a low melting point glass to act as a binder to connect the fixed end and the inner surface.

7. The discharge fluorescent apparatus including fluorescent fibers, according to claim 1:
wherein the fluorescent fibers stand directly or indirectly on the inner surface of the envelope substantially vertically to the surface and/or substantially parallel to one another.

8. The discharge fluorescent apparatus including fluorescent fibers according to claim 1:
wherein the substantially transparent member comprises a glass material that is transparent to visible light and substantially non-transparent to ultraviolet rays to absorb most ultraviolet rays.

9. The discharge fluorescent apparatus including fluorescent fibers, according to claim 1, further comprising:
a plurality of the electro-conductive films directly or indirectly disposed on the inner surface of the envelope at different positions to one another; and
wherein the fixed end of each of the fluorescent fibers is disposed directly or indirectly on the electro-conductive films.
wherein the fluorescent fibers are disposed to be fixed directly or indirectly on the electro-conductive films at the fixed end of each of the fluorescent fibers.

10. The discharge fluorescent apparatus according to claim 1, further comprising:
a plurality of dot-like electro-conductive films or a plurality of dot-like non-electro-conductive films disposed on the inner surface of the envelope; and
wherein at least one of the fluorescent fibers is disposed on each of the dot-like electro-conductive films or the dot-like non-electro-conductive films.

11. The discharge fluorescent apparatus including fluorescent fibers, according to claim 1:
wherein the air-tight envelope comprises a dual envelope having a first envelope and a second envelope enclosed within the first envelope, and the second envelope with or without at least one gas-permeable through-hole;
wherein the discharge space having a first discharge space within the second envelope and a second discharge space between the first envelope and the second envelope; and
wherein the fluorescent fibers are disposed within the first discharge space and the second discharge space.

12. A discharge fluorescent apparatus including fluorescent fibers, comprising:
an air-tight envelope having an inner surface and a discharge space to fill a dischargeable gas therein;
a plurality of fluorescent fibers each containing a phosphor therein/thereon, each of the fluorescent fibers comprising a fixed end and a free end;
a plurality of protrusions including or excluding the phosphor therein/thereon, each of the protrusions having a shape having finger-like shape, column-like shape, rod-like shape, conical shape and/or cylindrical shape;
wherein the protrusions project or protrude directly or indirectly from the inner surface to the discharge space, to isolate to one another in an island manner; and
wherein the fluorescent fibers are disposed directly or indirectly on the protrusions in such a manner that the fixed end is disposed to be fixed directly or indirectly on the protrusions and the free end is disposed within the discharge space.

13. The discharge fluorescent apparatus including fluorescent fibers, according to claim 1:
wherein the air-tight envelope comprises a first substrate with a first inner surface and a second substrate a second inner surface opposed to the first substrate, having at least one discharge space disposed therebetween to fill a dischargeable gas therein; and
wherein the fluorescent fibers are disposed directly or indirectly on the first inner surface and/or the second inner surface.

14. A discharge fluorescent apparatus including fluorescent fibers, comprising:
an air-tight envelope having a first substrate, a second substrate opposed to each other and at least one discharge space to fill a dischargeable gas in the at least one discharge space;
at least one barrier wall disposed between the first substrate and the second substrate to elongate from the first substrate to the second substrate, the barrier wall containing a phosphor disposed therein/thereon;
a plurality of fluorescent fibers containing the phosphor disposed therein/thereon;
wherein the fluorescent fibers are disposed on at least one of the first substrate and the second substrate and/or disposed on the barrier wall.

15. The discharge fluorescent apparatus including fluorescent fibers, according to claim 1:
wherein a fluorescent film containing the phosphor therein is disposed directly or indirectly on the inner surface of the envelope;
wherein the fluorescent film is disposed at position except for where the fixed end of each of the fluorescent fibers is fixed on the fluorescent film.

16. The discharge fluorescent apparatus according to claim 12:
wherein the fluorescent fibers are disposed directly or indirectly on the inner surface of the envelope in such a manner that the fixed end is disposed to be fixed directly or indirectly on the inner surface and the free end is disposed within the discharge space.

17. The discharge fluorescent apparatus including fluorescent fibers, according to claim 1: wherein the fluorescent fibers stand directly or indirectly on the inner surface, in such a manner that the free end and a side surface of each of the fluorescent fibers receive ultraviolet rays generated in the discharge space.

18. The discharge fluorescent apparatus including fluorescent fibers, according to claim 14:
wherein each of the fluorescent fibers comprises a single core structure or a core-clad structure; and
wherein each of the fluorescent fibers having the single core structure is composed of a core and the phosphor contained in the core, or each of the fluorescent fibers having the core-clad structure is composed of a core, a clad partially or entirely on the core and the phosphor contained in the core and/or the clad.

19. The discharge fluorescent apparatus including fluorescent fibers, according to claim 14:
wherein the discharge fluorescent apparatus is a plasma display:
wherein the discharge space composed of a plurality of discharge cells; and
wherein a plurality of electrodes are directly or indirectly disposed on the first inner surface and/or the second inner surface.

20. The discharge fluorescent apparatus including fluorescent fibers, according to claim 13:
wherein the discharge fluorescent apparatus is a substantially flat fluorescent lamp; and
wherein a plurality of electrodes are disposed within the discharge space.
